(19) United States
(12) Patent Application Publication
(10) Pub. No.: US 2003/0058543 A1
(43) Pub. Date: Mar. 27, 2003

(54) Optically corrective lenses for a head-mounted computer display

(76) Inventors: James B. Sheedy, Walnut Creek, CA (US); Alfred P. Hildebrand, Palo Alto, CA (US); Donald P. Porter, San Jose, CA (US)

Correspondence Address: SILICON VALLEY INTELLECTUAL PROPERTY GROUP, P.O. BOX 721120, SAN JOSE, CA, 95172-1120, US

(21) Appl. No.: 09/792,382

(22) Filed: Feb. 21, 2001

(51) Int. Cl. G02B 27/14

(52) U.S. Cl. 359/630

(57) ABSTRACT

A microdisplay system is provided according to one embodiment of the present invention. The system includes headwear that is adapted for wearing on a head of a user. A display is coupled to the headwear. One or more corrective lenses are coupled to the headwear and positioned between the display panel and the head of the user. According to another embodiment of the present invention, a corrective lens device is provided for coupling to a microdisplay adapted for wearing near eyes of a user. The device includes a pair of corrective lenses that are spaced laterally and that each have an optical corrective prescription of the user. A mounting portion is operably coupled to the lenses for attaching the lenses to the microdisplay.

### FIELD OF THE INVENTION

The present invention relates to vision correction, and more particularly to a vision correction device for use with a microdisplay.

### BACKGROUND OF THE INVENTION

A continuing objective in the field of electronics is the miniaturization of electronic devices. Most electronic devices include an electronic display. As a result, the miniaturization of electronic displays is critical to the production of a wide variety of compact electronic devices. For example, as electronic devices such as personal digital assistants, cell phones, digital still cameras, DVD players and internet appliances become ever smaller and more portable, the demands on the electronic displays for these products must meet difficult and seemingly contradictory requirements. On the one hand, the displays must provide increasing amounts of high quality visual information, sometimes approaching that of a desktop monitor. Yet these displays must still be very compact and lightweight, consume little power, and be produced at low cost. Until recently, displays were not able to meet all of these requirements.

The purpose of an electronic display is to provide the eye with a visual image of certain information. This image may be provided by constructing an image plane composed of an array of picture elements (or pixels) which are independently controlled as to the color and intensity of the light emanating from each pixel. The electronic display is generally distinguished by the characteristic that an electronic signal is transmitted to each pixel to control the light characteristics which determine the pattern of light from the pixel array which forms the image.

Two examples of electronic displays are the cathode ray tube (CRT) and the active-matrix liquid crystal display (AMLCD). There are other electronic displays, but none are so well developed as the CRT and AMLCD which are used extensively in computer monitors, televisions, and electronic instrument panels. The CRT is an emissive display in which light is created through an electron beam exciting a phosphor which in turn emits light visible to the eye. Electric fields are used to scan the electron beam in a raster fashion over the array of pixels formed by the phosphors on the face plate of the electron tube. The intensity of the electron beam is varied in an analog (continuous) fashion as the beam is swept across the image plane, thus creating the pattern of light intensity which forms the visible image. In a color CRT, three electron beams are simultaneously scanned to independently excite three different color phosphors respectively which are grouped into a triad at each pixel location. However, the CRT is impractical for use in a microdisplay.

In contrast to the emissive type displays such as the CRT, an AMLCD display utilizes a lamp to uniformly illuminate the image plane which is formed by a thin layer of liquid crystal material laminated between two transparent conductive surfaces which are comprised of a pattern of individual capacitors to create the pixel array. The intensity of the illumination light transmitted through each pixel is controlled by the voltage across the capacitor, which is in turn controlled by an active transistor circuit connected to each pixel. This matrix of transistors (the active matrix) distinguish the AMLCD from the passive matrix liquid crystal devices which are strictly an array of conductors controlled by transistors external to the image area usually in the periphery of the matrix. The ability of each transistor to control the characteristics of just one pixel allows for the higher performance found in AMLCD displays in contrast to the passive arrays. However, a drawback of the AMLCD display is the high power consumption incident to the illumination.

While some electronic products which contain an electronic display have memory for storing the data which is to be displayed, some do not. For instance, a television must activate the CRT display in real time as the broadcast signal is received unless a VCR or similar storage medium is employed. In computers, data is transmitted and stored digitally. Moreover, in portable electronics devices, size and power constraints require the use of semiconductor memory which stores data only in digital format. In digital electronic products, it is typical that a display controller is incorporated to receive and store the bit mapped image to be displayed and then to transfer that data to the display in a series of image frames at a rate high enough to look smooth to the eye. The semiconductor memory storing the image bits is called the frame buffer, and the rate at which the data is refreshed on the display is called the frame rate.

It is an advantage in many applications to display large amounts of information requiring more and more resolution in the display. High resolution displays may contain hundreds of thousands of pixels. As an example, the Super VGA (SVGA) display resolution consists of 480,000 pixels. With a simple monochrome image and no grayscale, the frame storage is only equal to the approximately one-half megabit frame size. However, were the image to be full 24 bit depth color (i.e., 3 colors and 8 bits of grayscale per color), the frame storage would approach 12 megabits. At the frame rates which are common today for high performance displays, at least 60 frames per second and up to 85 frames per second, as many as one gigabits per second must be transferred from the frame buffer to the display. The state of semiconductor technology at present limits clock speeds to a level well below such transfer rates and parallel interfaces of 16 to 32 bit widths are typical in high performance displays.

It is a characteristic of analog displays that when the image data is stored in semiconductors, the digital information is converted to analog in a digital-to-analog converter (DAC) at the interface of the display. The digital representation of a pixel at the high standard of 8 bits of grayscale allows the creation of 256 separate shades per color (16 million distinct colors). In high performance displays, multiple DAC channels are required to provide the bandwidth of data transfer required.

In the particular case of miniaturization of high resolution electronic displays, there is an advantage to reducing the size of the pixels which comprise the display. The need for such small devices has led to the development of a category of miniature displays often described as microdisplays with pixel sizes as small as 10 microns or less. In order to achieve this pixel resolution, active matrix devices have been developed utilizing silicon wafer fabrication of CMOS devices as opposed to thin-film transistors fabricated on a glass or quartz substrate. Single crystal silicon design rules are many times smaller than poly-silicon resulting in transistor sizes to easily fit microdisplay geometries. With the exception of techniques to separate the single crystal transistors from the silicon substrate utilizing lift-off technology, CMOS based active matrix displays are inherently opaque, and therefore must be reflective rather than transmissive like the poly-silicon devices. Thin film transistor (TFT) based transmissive devices are also opaque as transistors and interconnection lines, and optical efficiencies are very low for high resolution TFT displays.

The pixel sizes of microdisplays are too small for the resulting image to be directly viewed by the unaided eye, but can be magnified through projection optics to create a real image on a screen or wall or through a magnifier to create a virtual image in space. In practice, pixel sizes are limited today by magnifier and illumination considerations to geometries which are larger than single crystal silicon transistors, and in particular, useful pixels are even larger than multi-transistor SRAM cells. This method can produce extremely compact, power efficient, and low cost displays that present high levels of information to the viewer, comparable to that of desktop computer monitors. Directly viewed displays cannot meet all of these requirements since a display that is viewed directly and has information content similar to a desktop (at least 640×480 viewable picture elements), must be as large as the displays typically found on ultra compact notebook computers (over 8″ diagonal). However, near-to-the-eye displays can be produced with very small overall dimensions by using a magnifying optical system to create a virtual image at some distance in front of the viewer. An illumination system may be provided as part of the optical system for devices such as liquid crystal displays where light is not generated by the material. These magnified images can appear to be as large as a desktop monitor even though the display dimensions are one or two inches across. Such small dimensions require that only a single electro-optic device be employed in the display. All of the image colors must be provided by this single device. (Larger systems, such as front projectors, can use multiple devices, one for each color.)

There are two methods commonly used to generate color using a single electro-optic device. In the first, each picture element (pixel) is divided into three or more sub-pixels and a color filter, typically red, green and blue, is placed in the light path from each sub-pixel. The eye merges these sub-pixels to create a color image. This method suffers from significant light loss in the color filters, requiring up to four times as much power to be supplied to the illumination system. The color filters also add significant additional cost to the display. The second method avoids the high power requirement and added cost of the sub-pixel/color filter method. Instead, a single pixel is used for red green and blue images in a sequential manner.

The pixel sizes are also small relative to the size of color filters used in TFT AMLCD displays to create color triads for each pixel. There is a significant advantage to creating color through the sequential use of the entire array to create an image specific to each of the three prime color components. Through the utilization of separate light emitting diodes (LEDs) of each prime color to illuminate the display, the diodes can be turned rapidly on and off to correspond to the particular color component being displayed by the array at that moment. This method of color creation is called field sequential color wherein each color field is sequentially illuminated by the appropriate diode. Because at least three different color field images need to be displayed at a rate faster than can be resolved by the eye, the field sequential color method at least triples the data transfer rate required as compared to a monochrome display.

A need exists for a microdisplay system which can overcome the various above-described limitations of prior art display systems and be able to produce a high resolution color image while having a low vertical height for non-immersive viewing.

Microdisplays are commonly worn on, or positioned close to, the eyes of the user. If the user requires optical correction (i.e., wears corrective lenses), the close proximity of the display may make it impossible or uncomfortable for the wearer to wear glasses while using the microdisplay.

A need exists for a way to correct a user's vision when the user is utilizing a microdisplay.

These and other advantages are provided by the display system of the present invention.

### SUMMARY OF THE INVENTION

A microdisplay system is provided according to one embodiment of the present invention. The system includes headwear that is adapted for wearing on a head of a user. Types of headwear includes eyeglass-like devices, goggles, helmets, visors, etc. A display is detachably or permanently coupled to the headwear. One or more corrective lenses are detachably or permanently coupled to the headwear and positioned between the display panel and the head of the user.

Preferably, the corrective lens carries an optical corrective prescription of the user. In one aspect of the present invention, a surrounding visual environment is visible to the user. Here, the corrective lens provides simultaneous refractive correction for the display and the surrounding visual environment. In another aspect of the present invention, the display is imaged at a distance from the eyes for enabling use of a refractive correction power of the user for a distance greater than the actual distance between the user and the display. In yet another aspect, the corrective lens provides different refractive corrections for viewing the display and for viewing the surrounding visual environment. One implementation of this uses a bifocal lens. In a further aspect of the present invention, two corrective lenses provide disparity-driven depth perception

In one embodiment of the present invention, the corrective lens is detachably coupled to the headwear. Preferably, two corrective lenses are provided and are separated such that the lenses substantially match the individual separation of the eyes of the user.

Preferably, the corrective lens corrects myopia, hyperopia, astigmatism, presbyopia, accommodative disfunction, and/or oculomotor imbalances. To do so, the corrective lens has a prescribed optical property such as spherical refractive power, cylindrical refractive power, near addition power, and/or prism refractive power.

In an embodiment of the present invention, the display has a vertical extent of less than about 40 mm which provides “look over” and “look under” capabilities as well as allows for integration of the display panel into more versatile and aesthetic headwear. Vertical extent as used here is taken with respect to the normal viewing angle of a user standing upright looking straight ahead.

According to an embodiment of the present invention, a corrective lens device is provided for coupling to a microdisplay adapted for wearing near eyes of a user. The device includes a pair of corrective lenses that are spaced laterally and that each have an optical corrective prescription of the user. A mounting portion is operably coupled to the lenses for detachably or permanently attaching the lenses to the microdisplay. Preferably, the lateral spacing of the corrective lenses substantially matches the individual separation of the eyes of the user.

In an embodiment of the present invention, the surrounding visual environment is visible to the user, and the corrective lenses provide simultaneous refractive correction for the display and the surrounding visual environment. Alternatively, the corrective lenses can provide different refractive corrections for viewing the display and for viewing the surrounding visual environment.

Preferably, the corrective lenses correct myopia, hyperopia, astigmatism, presbyopia, accommodative disfunction, and/or oculomotor imbalances. To do so, the corrective lenses have a prescribed optical property such as spherical refractive power, cylindrical refractive power, near addition power, and/or prism refractive power.

### BRIEF DESCRIPTION OF THE DRAWINGS

FIG. 1 depicts an illustrative microdisplay system according to a preferred embodiment of the present invention;

FIG. 2 is a top view of the illustrative embodiment of FIG. 1;

FIG. 3 is a perspective view of a corrective lens device according to an embodiment of the present invention;

FIG. 4 is a block diagram of a display system according to a preferred embodiment of the present invention;

FIG. 5 is a side cross sectional view of a Liquid Crystal Module (LCM);

FIG. 6 is a chart illustrating a timing of displaying color fields to a viewer;

FIG. 7 depicts four ways the orientation of a pixel array can be configured;

FIG. 8 is a grid illustrating an address relative to pixel position for a backplane;

FIG. 9 illustrates a configuration write and read transaction waveform;

FIG. 10 is a timing diagram depicting an exemplary waveform of a block transfer of two rows of six words each;

FIG. 11 is a timing diagram showing a demonstration of a waveform of a block read of 6 words;

FIG. 12 is a block diagram of a backplane integrated circuit according to one embodiment of the present invention;

FIG. 13 illustrates how patterns are loaded into an array with and without a rotate pattern bit set;

FIG. 14 shows pixel arrays that demonstrate how data is moved relative to scroll direction;

FIG. 15 is a block diagram that shows the system components of an embodiment of a microdisplay according to an embodiment of the present invention;

FIG. 16 is a flow chart showing how each byte of image data is processed through the palette, adjusted by the “grid”, and separated into individual bit planes;

FIG. 17 is a flow diagram depicting a process to convert 8-bit pixel data into pixels in a format amenable to the display system;

FIG. 18 is an illustration of an Analog Controller Chip (AIC);

FIG. 19 illustrates a transaction waveform during parallel write timing;

FIG. 20 illustrates a transaction waveform during parallel read timing;

FIG. 21 depicts an ITO voltage generation waveform;

FIG. 22 depicts an LED current generation waveform;

FIG. 23 illustrates an LED timing waveform where ito_rst=0;

FIG. 24 depicts a waveform for ITO and LED Timing with ito_rst=1; and

FIG. 25 is a block diagram of an analog controller according to an embodiment of the present invention

### DESCRIPTION OF THE PREFERRED EMBODIMENTS

### Microdisplay System

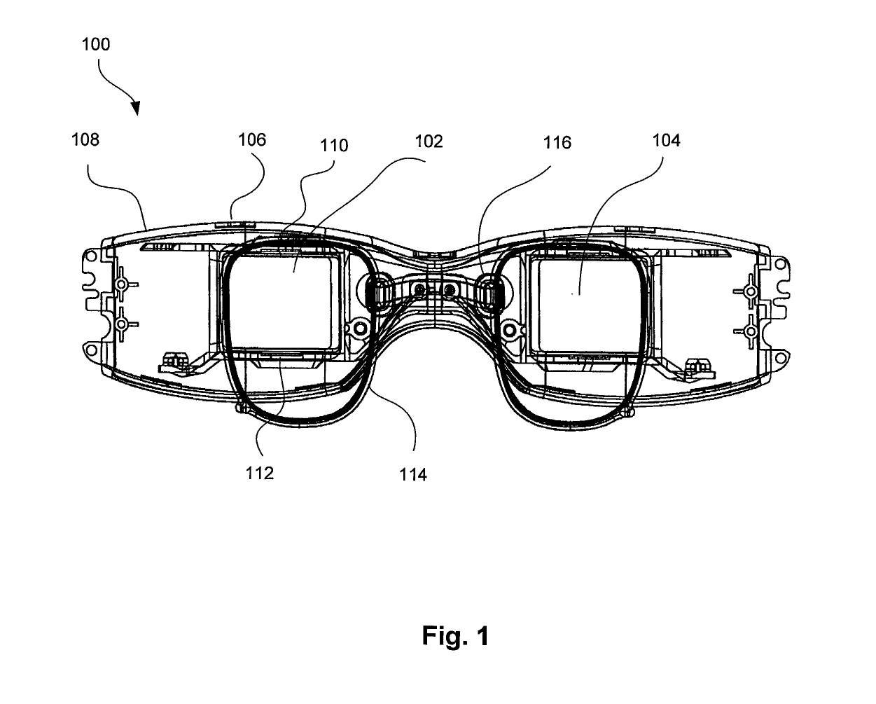

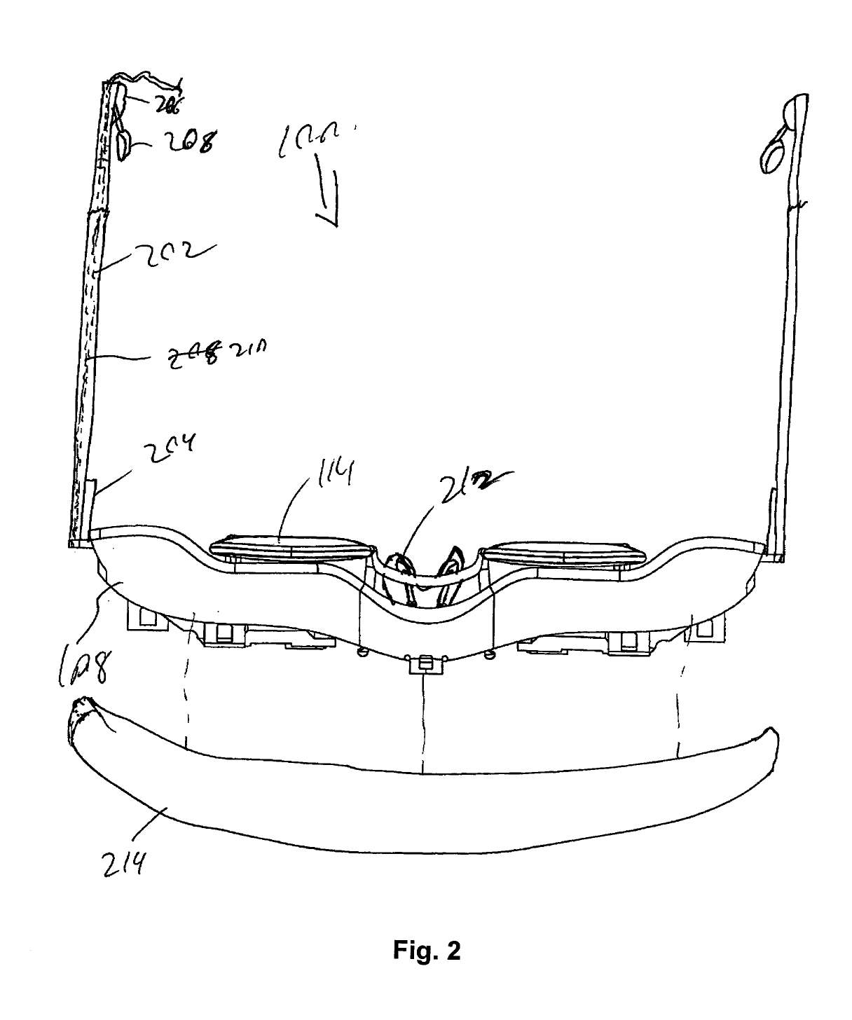

FIG. 1 depicts an illustrative microdisplay system 100 according to a preferred embodiment of the present invention. In the embodiment shown in FIG. 1, the headwear resembles a pair of glasses. Similar to a pair of eyeglasses, the device comprises a mounting portion that incorporates displays, electronics and optics, and two temple pieces (shown in FIG. 2) to help support the device over the ears. In other embodiments of the present invention, such headwear can include other eyeglass-like devices, goggles, helmets, visors, or any other item amenable to wearing on the head of the wearer.

In more detail, the microdisplay system includes a pair of displays 102,104 detachably or permanently mounted to the display mounting portion 106 of the head-borne device, i.e., headwear 108. The preferred type of displays are LCD displays.

The virtual computer display occupies only a portion of the total visual space of the wearer. The remainder of the wearer's visual space is not occupied by the device and enables the wearer to see their surrounding visual environment. This system is “non-immersive” because a portion of the real visual environment is visible to the wearer.

In more detail, each of the displays has opposite top and bottom edges 110,112 which define a vertical extent of each panel. The vertical extent is preferably less than about 40 mm, and ideally less than about 37 mm. These dimensions provide “look over” and “look under” capabilities as well as allow for integration of the display into more versatile and aesthetic headwear. The display is capable of displaying an image at a resolution of at least 640×480 pixels to create desktop-like viewing.

The present invention preferably enables the user to view a virtual computer display that appears to be imaged at a designed distance from the user (e.g. 6 feet from the face of the user).

FIG. 2 is a top view of the embodiment of the present invention of FIG. 1. As shown, the headwear includes a pair of temple pieces 202 extending therefrom. As an option, a pair of spring hinges 204 can be used to couple the temple pieces to the display mounting portion of the headwear. The spring hinges cause the temple pieces to exert a constant clamping force on the head of the user to assist in securing the headwear to the head of the user. Preferably, soft conforming pads 206 are attached to the ends of the temple pieces to help grip the head.

One or more ear buds 208 may be attached to the headwear for producing audio. Preferably, the ear buds snap into the end tips of the temple pieces from below. The audio wires (not shown) that carry the audio signal to the ear buds can be routed directly into recesses in the temple pieces.

Wiring 210 that is coupled to the display can be routed over the temple pieces so that it acts as a cantilever for reducing an effective weight of the headwear on a nose of the user, making the system feel lighter.

An adjustable nosepiece 212 can also be coupled to the headwear to assist in supporting the headwear and/or to provide greater comfort. Such adjustment can be vertical. Another such adjustment can be the width of the nosepiece. Preferably, the portion of the nose piece that contacts the skin is constructed of a soft, slip resistant material and has a large surface area to distribute the weight of the display system across a larger surface area of the nose.

As an option, an outer shield 214 can be positioned on an opposite side of the display with respect to the user. The outer shield is opaque with a partially reflective coating for producing an appearance of depth, thereby disguising the display system as a pair of sunglasses.

The head borne device that displays the virtual images fits close to the face of the user and may be able to be worn over the person's eyeglasses. Referring again to FIG. 1, an optical lens device 114 that has two optical lenses (or, one lens for a monocular device) can be coupled to the headwear so that the user doesn't need to wear glasses when using the device.

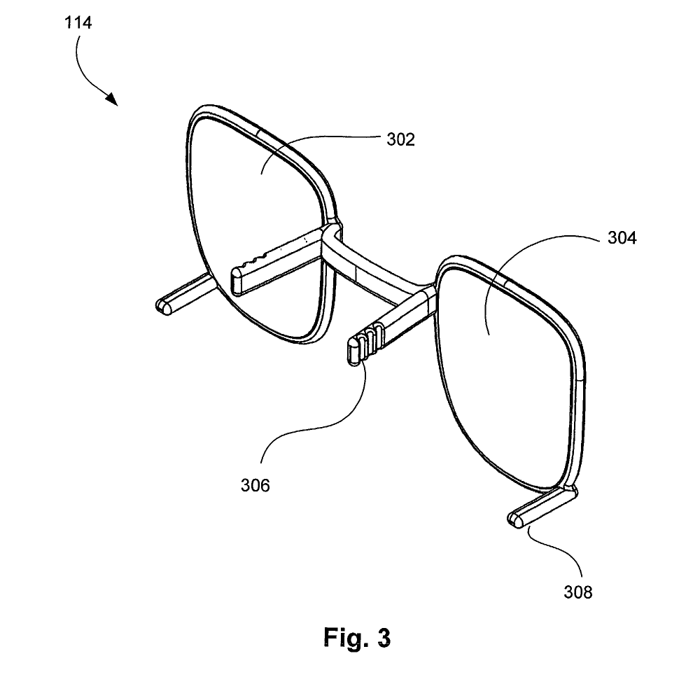

FIG. 3 is a perspective view of a corrective lens device according to an embodiment of the present invention. It should be noted that this device is presented for purposes of illustration only and should not in any way limit the scope of the invention. Further, the present invention will discuss the corrective lens device with reference to the illustrative display system of FIGS. 1 and 2, but it should be understood that the device can be utilized with display types other than those presented here, including non-head borne display devices.

### Optical Corrective Device

Referring again to FIG. 3, the device includes a pair of corrective lenses 302,304 that are spaced laterally and that each have an individual refractive correction based on the optical corrective prescription of the user. A mounting portion 306 is operably coupled to the lenses for detachably or permanently attaching the lenses to the display system. As shown here, the mounting portion includes two flexible members that are inserted into mounting holes 116 of the headwear, where they are held in place by friction and, preferably, serrations. (See FIG. 1.) One skilled in the art will understand the mechanics of this and other types of mountings that may be used. Guide members 308 can be used to stabilize the device. If the optical corrective device is removable, multiple users are able to share a single electronic display.

In an embodiment of the present invention, the surrounding visual environment is visible to the user, and the corrective lenses provide simultaneous refractive correction for the display and the surrounding visual environment.

The visual display can be imaged at a long distance from the eyes, enabling a person's usual refractive correction power for long distances to be used. No focus of the instrument for nearer image distances is required or possible.

Different refractive corrections for the visual display and for surrounding visual space can be provided when desired to meet the refractive needs of the user. (The specific implementation is that a bifocal lens can be placed in the device, allowing distance visual correction for the virtual image and near visual correction for the surrounding visual space.)

Other embodiments of the present invention include correction for one eye (monocular), correction for 2 eyes (binocular) or correction for 2 eyes with disparity-driven depth perception (stereo).

Various embodiments of the present invention allow for all common optical refractive corrections. This includes correction for conditions such as myopia, hyperopia, astigmatism, presbyopia, accommodative dysfunction and oculomotor imbalances. The lenses in the corrective device provide correction for these conditions by having prescribed optical properties of spherical refractive power, cylindrical refractive power, near addition power, and/or prism refractive power.

In one embodiment of the present invention, the lenses are located with respect to one another so they are of appropriate lateral separation to match the measured individual separation of the eyes (inter-pupillary distance or IPD) of the user. This avoids “prism error” and the associated discomfort from conflicting visual stimuli. (Eye lens focus distance is different from eye rotational convergence distance.)

The optical correction system of the present invention, which comprises the lenses and their holder, are preferably designed to utilize the standard operating procedures of the eye care community and the ophthalmic correction industry. This includes the following standard operating procedures and products: the optical prescription normally written by an optometrist or ophthalmologist, the IPD measurement and specification, commonly used lens materials, commonly used lens fabrication procedures. The user can obtain lenses of appropriate power for the device from their usual and customary source.

### Technology Overview

The preferred microdisplay system of the present invention is a compact, low-power, high-resolution display system designed for mobile applications such as cameras, head-mounted displays, and portable Internet devices. Unlike traditional liquid crystal display panels, it is viewed near to the eye, like the viewfinder of a camera. This near-to-eye viewing mode allows for the small size and power efficiency of the design.

### Microdisplay Module and Support Components

The microdisplay is designed to operate in two basic modes distinguished by the number of distinct colors required.

The most power efficient is an eight-color mode which is appropriate for viewing email messages and simple graphics such as topographic charts. This mode offers the benefit of low power consumption and minimum total component count. It is referenced below as Power Miser Mode with a total power requirement under 100 mW.

Also supported is a high color mode that provides the equivalent color of an 18-bit LCD panel. In addition to the higher color depth, this mode offers the benefit of being easier to design into a system, and to program. This mode is referred to as Color Rich Mode throughout the remainder of the discussion.

A Color Rich Mode implementation according to the present invention provides the most functionality. This section will introduce the technology by describing a typical Color Rich implementation.

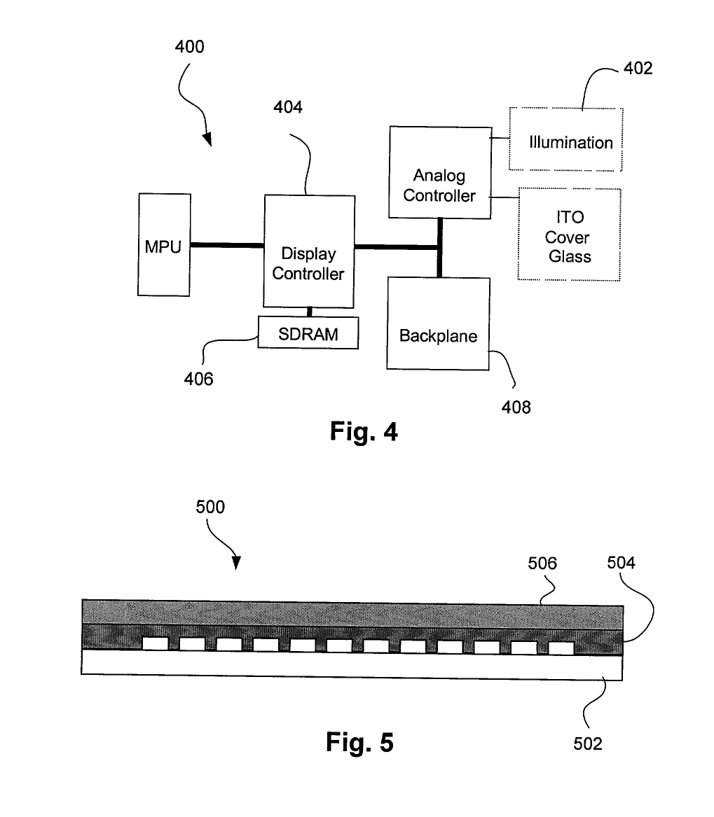

FIG. 4 is a block diagram of a display system 400 according to a preferred embodiment of the present invention. A typical Microdisplay Color Rich implementation consists of the following.

A self-contained display module that contains

Liquid Crystal Module

Illumination 402

Optics

Two support integrated circuits

Color Rich Display Controller ASIC (CRASIC) 404

Auxiliary Integrated Circuit (AIC)

A frame buffer SDRAM 406

Miscellaneous passive components

### Liquid Crystal Module

FIG. 5 is a side cross sectional view of a Liquid Crystal Module 500. The Liquid Crystal Module (LCM) is the primary image producer of the system. It is an 11 mm diagonal, 800 column by 600 row, black and white LCD. The LCM is produced by covering an integrated circuit Backplane die 502 with a thin layer of Liquid Crystal material 504 and a cover glass 506 coated with Indium Tin Oxide (ITO) to form a common electrode. This type of display is called Liquid Crystal on Silicon (LCOS).

The IC Backplane is a standard 3.3V CMOS device using 0.35 micron design rules. In essence it is an 800×600×3 bit Static RAM device (SRAM), with proprietary embedded timing and control logic. The top metal layer contains an array of 800 by 600 squares, each 11 microns on a side. These aluminum squares are highly reflective and act as mirrors. The liquid crystal material directly above each mirror will allow light to pass through depending on the electric field between the metal mirror and the ITO electrode coating on the cover glass. This effect enables the 480,000 pixels on the backplane to act as individual light valves. The LCM is a postage stamp size liquid crystal panel capable of displaying 2300 dpi resolution images.

### Illumination and Field Sequential Color

The LCM does not produce light: A separate light source must be provided. If a white light source were used the LCM would provide a black and white or gray scale display. The Microdisplay uses a triad of red, green, and blue Light Emitting Diodes (LED) to illuminate the LCM and a process called Field Sequential Color to display full color images.

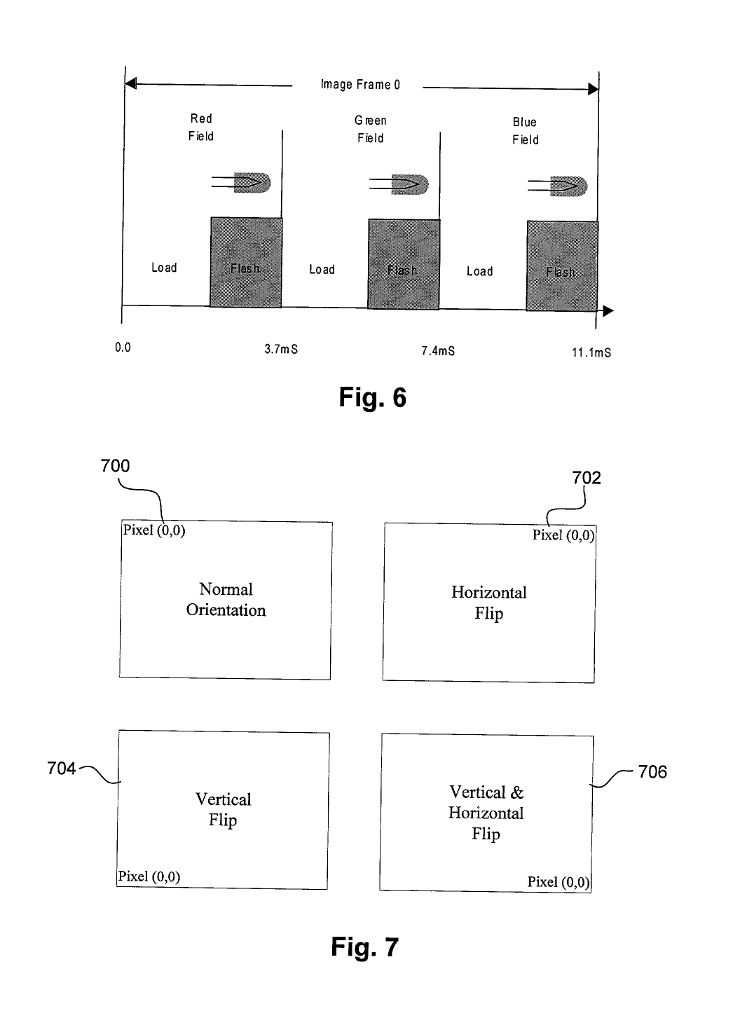

A field sequential color device presents the image to the viewer as separate fields of Red, Green and Blue in rapid succession. FIG. 6 illustrates how the fields are presented to the user. When this is done at a high repetition rate, the viewer's brain merges the fields to form a single full color image. This is the same phenomenon that causes 23 frames of still photographs to appear as 1 second of continuous motion when shown through a movie projector.

The amount of light produced by the LED triad is very little compared to the lamps used in projectors. It is, however, more than sufficient to produce a bright, clear image for the viewer because the display is held close to the eye, and ambient light does not interfere with the display.

### Optics

As mentioned above, the LCM is an 11 mm diagonal display with 11 micron pixels. When the user holds the display near the eye however, the image appears to be a 110 cm diagonal picture located 2 meters from the viewer. This effect is achieved through optics which act like a compound microscope to magnify the image 13.5 times. The LCM is precisely attached to one face of the optics module and is held in place by means of a cradle. The Illumination triad is attached to a separate face of the optics, and is held in place in the same way. The LCM is attached to a flexible printed circuit, which provides the electrical interface to the display module.

### Color Rich Display Controller

The Color Rich Display Controller ASIC (CRASIC) is an IC, which controls the timing of the Backplane, and illumination to produce rich color images. More details of the CRASIC are provided below.

The CRASIC is designed to interface easily to 8, 16, or 32-bit RISC Microprocessors, and hide the complexity generating images with the Backplane. The chip uses a directly attached SDRAM to store a linear frame buffer representation of the screen, and an additional copy of the same information, separated into bit planes. The CRASIC creates these separate bit planes automatically as the CPU writes the linear frame data.

Additionally, the CRASIC provides an internal palette RAM which enables 8-bit color values to be expanded into 24-bit colors before being dithered and converted into the proper bit frame format for the Backplane.

The CRASIC includes an embedded RISC CPU that feeds data to the Backplane. An instruction set enables the system designer to precisely control the transfers to the Backplane. This instruction set also supports functions such as overlays for cursors and generic BITBLT operations. See the sections below on the CRASIC and CRISP instruction set for more detail.

### Auxiliary IC

The AIC chip is the third IC. It acts as a companion device for the Backplane by providing all the analog functions required to produce images.

The first major function it provides is current drive control for the illumination LEDs. The current level for each LED can be varied independently, allowing the color balance of the display subsystem to be software controlled. This is advantageous since the electro-optical characteristics of individual LEDs vary over the operating temperature range of the display system.

The AIC also controls the common ITO voltage. The Backplane is a 3.3v digital device. The pixels on the top metal layer are either 3.3v or ground. The ITO voltage is driven to a magnitude and offset which optimizes the E-field between the pixels and the ITO layer on the cover glass. The precise voltages are also temperature dependent, and may be controlled as appropriate through software.

Due to the tendency of liquid crystal ions to migrate in a static E-field, the field polarity must be frequently inverted so the LC material will not lose its optical effect. The AIC chip enables polarity reversal of ITO voltage supply to accomplish this important function.

The AIC chip also provides an internal temperature sensing function that enables software to determine the temperature of the AIC and the Backplane.

### SUMMARY

The Backplane embodied within the Liquid Crystal Module provides the primary image for the display system. The AIC chip provides all of the analog voltages needed to drive the illumination LEDs and the common electrode ITO cover glass. The Color Rich ASIC provides the primary system interface, and precisely controls the timing of the other two chips.

### Backplane Technology

A preferred backplane of the present invention is a high-speed, low-power integrated SVGA digital CMOS Backplane for use in a reflective silicon micro display such as the one described above. The backplane interfaces either with a microprocessor directly, or an external frame, transforming image data into a matrix of pixel electrodes (or pixels). This then, in conjunction with a common counter electrode, drives individual voltages across a liquid crystal material. When illuminated, light is reflected or absorbed at each pixel, which doubles as a mirror, according to those voltages. An optical image is observed when all of the pixels are viewed together.

### Features

66 Mhz operating frequency

sub 1 ms Backplane refresh times

8 bit address bus

Configurable registers

32 bit data bus

DMA capabilities

Block transfer capability p1 Entire row transfers with zero wait states

Interrupt Generation

RGB and Duelchrome modes

Automatic data inversion for LCM

### Pin Assignment

Tables 1-4 set forth pin assignments and pin descriptions.

TABLE 1
Display Module Connector Pinout

| | Signal |
|---|---|
| Pin | Name |
| 1 | Vdd1 |
| 2 | Vdd2 |
| 3 | readyN |
| 4 | clk |
| 5 | rdceN |
| 6 | Gnd |
| 7 | irqN |
| 8 | D16 |
| 9 | A0 |
| 10 | D8 |
| 11 | A1 |
| 12 | D24 |
| 13 | A2 |
| 14 | D0 |
| 15 | A3 |
| 16 | D17 |
| 17 | A4 |
| 18 | D9 |
| 19 | A5 |
| 20 | D25 |
| 21 | A6 |
| 22 | D1 |
| 23 | wrN |
| 24 | D18 |
| 25 | csN |
| 26 | D10 |
| 27 | rstN |
| 28 | Gnd |
| 29 | A7 |
| 30 | Vdd1 |
| 31 | D22 |
| 32 | D26 |
| 33 | D14 |
| 34 | D2 |
| 35 | D30 |
| 36 | D19 |
| 37 | D6 |
| 38 | D11 |
| 39 | D22 |
| 40 | D27 |
| 41 | D15 |
| 42 | D3 |
| 43 | D31 |
| 44 | D20 |
| 45 | D7 |
| 46 | Vdd2 |
| 47 | iot_os |
| 48 | D12 |
| 49 | led |
| 50 | D28 |
| 51 | ito_glass |
| 52 | D4 |
| 53 | Vdd1 |
| 54 | D21 |
| 55 | blue |
| 56 | D13 |
| 57 | green |
| 58 | D29 |
| 59 | red |
| 60 | D5 |
| LED1 | Red |
| LED2 | COM |
| LED3 | Blue |
| LED4 | Green |

TABLE 2
Backplane Pin Out by Pad Number

| Pin # | Name |
|---|---|
| 1 | gnd0 |
| 2 | vdd0 |
| 3 | readyN |
| 4 | rdceN |
| 5 | irqN |
| 6 | A[0] |
| 7 | A[1] |
| 8 | A[2] |
| 9 | A[3] |
| 10 | A[4] |
| 11 | A[5] |
| 12 | A[6] |
| 13 | wrN |
| 14 | csN |
| 15 | rstN |
| 16 | A[7] |
| 17 | vdd1 |
| 18 | clk |
| 19 | gnd1 |
| 20 | D[16] |
| 21 | D[8] |
| 22 | D[24] |
| 23 | D[0] |
| 24 | D[17] |
| 25 | D[9] |
| 26 | D[25] |
| 27 | D[1] |
| 28 | D[18] |
| 29 | D[10] |
| 30 | gnd2 |
| 31 | vdd2 |
| 32 | D[26] |
| 33 | D[2] |
| 34 | D[19] |
| 35 | D[11] |
| 36 | D[27] |
| 37 | D[3] |
| 38 | D[20] |
| 39 | vdd3 |
| 40 | D[12] |
| 41 | D[28] |
| 42 | D[4] |
| 43 | D[21] |
| 44 | D[13] |
| 45 | D[29] |
| 46 | D[5] |
| 47 | D[22] |
| 48 | D[14] |
| 49 | gnd3 |
| 50 | D[30] |
| 51 | D[6] |
| 52 | D[23] |
| 53 | D[15] |
| 54 | D[31] |
| 55 | D[7] |
| 56 | ito |
| 57 | led |
| 58 | red |
| 59 | green |
| 60 | blue |
| 61 | vdd4 |
| 62 | gnd4 |

### Pin Description

TABLE 3
Pin Description 1

| Name | Direction | Description |
|---|---|---|
| A[7:0] | Input | System address. |
| clk | Input | System clock. |
| rstN | Input | System reset. |
| wrN | Input | Access direction: “high” for reads, “low” for |
| | | writes. |
| csN | Input | Chip select. Active low. |
| D[31:0] | Bi-directional | System data. |
| irqN | Output | Interrupt request. Active low. |
| rdceN | Output | Read data clock enable. Active low. |
| readyN | Output | System ready. Active low. |

TABLE 4
Pin Description 2

| Name | Direction | Description |
|---|---|---|
| A[7:0] | Input | System address. |
| blue | Output | Blue indicator for both ITO and LED control. |
| | | Active high. |
| clk | Input | System clock. |
| csN | Input | System chip select. Active low. |
| D[31:0] | Bidir | System data bus. Valid bus widths are D[7:0] |
| | | (8 bit), D[15:0] (16 bit), and D[31:0] (32 bit). |
| | | Direction is controlled by wrN pin. When wrN |
| | | is low, these pins are configured as inputs. |
| green | Output | Green indicator for both ITO and LED control. |
| | | Active high. |
| gnd | | System ground. In connecting to the system, |
| | | gnd0, gnd2 and gnd4 may be shorted together, |
| | | as may gnd1 and gnd4. Preferably, the system |
| | | ground for gnd0 and gnd4 should be kept |
| | | separate from the ground for gnd2 and gnd3. |
| irqN | Output | Interrupt request. Active low. |
| ito | Output | ITO voltage indicator. |
| led | Output | LED On indicator. Active high. |
| red | Output | Red indicator for both ITO and LED control. |
| | | Active high. |
| rdceN | Output | Read data clock enable. Active low. |
| readyN | Output | System ready. Active low. |
| rstN | Input | System reset. Active low. |
| vdd | | System power. In connecting to the system, |
| | | vdd0, vdd2 and vdd4 may be shorted together, |
| | | as may vdd1 and vdd3. Preferably, the system |
| | | power for vdd0, vdd2 and vdd4 should be kept |
| | | separate from the power for vdd1 and vdd3. |
| wrN | Input | System write. Active low. |

### Data Orientation and Format

Orientation

The orientation of the pixel array can be configured one of four ways, as shown in FIG. 7. FIG. 7 shows the convention of Normal 700, Horizontal 702, Vertical 704, and Horizontal/Vertical 706.

Data Format

Pixel data transferred to and from the backplane can be formatted in two ways: RGB and monochrome. RGB Data is formatted 4 bits per pixel, or 2 pixels per data byte. Monochrome data is formatted 1 bit per pixel, or 8 pixels per data byte.

RGB

In an RGB data byte, two bits in each byte are unused and are denoted ‘X’. The bits marked ‘R’ are always written to, or read from, bit plane 0, ‘G’ to plane 1, and ‘B’ to plane 2. In RGB mode, data for 8 pixels can be packed into one 32-bit data word. The backplane also supports double and single byte word lengths. For example, if the host system decides to write RGB data for only two pixels in one write cycle, then the backplane can be configured to look only at the first eight bits of the data bus for pixel data. The following table shows the relationship between the data bus, relative pixel number, and the different size transfers.

TABLE 5
RGB Data for 8, 16, and 32 bit Transfers

| | Data | | | | | | | |
|---|---|---|---|---|---|---|---|---|
| Bit | 31 30 29 28 | 27 26 25 24 | 23 22 21 20 | 19 18 17 16 | 15 14 13 12 | 11 10 09 08 | 07 06 05 04 | 03 02 01 00 |
| 8 Bit | — | — | — | — | — | — | xBGR | xBGR |
| 16 Bit | — | — | — | — | xBGR | xBGR | xBGR | xBGR |
| 32 Bit | XBGR | xBGR | xBGR | xBGR | xBGR | xBGR | xBGR | xBGR |
| Pixel # | 7 | 6 | 5 | 4 | 3 | 2 | 1 | 0 |

### Monochrome

In monochrome format, each bit of data gets mapped into one pixel. Each bit on the data bus gets mapped inside the Backplane into one of two programmable pixel colors, according to the value of the bit. With the bus configured to 32 bits, 32 pixels of data are present in one data transfer. This is four times the compaction of RGB format. The following table shows how each bit is mapped to a pixel, and the relative position on the data bus for all three sizes of transfers. Bit 0 of the first word is mapped to P0), or pixel 0, for example. Aside from supporting an extremely thin monochrome client, the monochrome format can be used on data reads to filter a color pixel array for a particular color pixel.

TABLE 6
Monochrome Data on a 16-Bit Data Bus

| | Data | | | | | | | | | | | | | | | |
|---|---|---|---|---|---|---|---|---|---|---|---|---|---|---|---|---|
| Bus | D31 | D30 | D29 | D28 | D27 | D26 | D25 | D24 | D23 | D22 | D21 | D20 | D19 | D18 | D17 | D16 |
| 8 | — | — | — | — | — | — | — | — | — | — | — | — | — | — | — | — |
| 16 | — | — | — | — | — | — | — | — | — | — | — | — | — | — | — | — |
| 32 | P31 | P30 | P29 | P28 | P27 | P26 | P25 | P24 | P23 | P22 | P21 | P20 | P19 | P18 | P17 | P16 |
| | Data | | | | | | | | | | | | | | | |
| Bus | D15 | D14 | D13 | D12 | D11 | D10 | D9 | D8 | D7 | D6 | D5 | D4 | D3 | D2 | D1 | D0 |
| 8 | — | — | — | — | — | — | — | — | P7 | P6 | P5 | P4 | P3 | P2 | P1 | P0 |
| 16 | P15 | P14 | P13 | P12 | P11 | P10 | P9 | P8 | P7 | P6 | P5 | P4 | P3 | P2 | P1 | P0 |
| 32 | P15 | P14 | P13 | P12 | P11 | P10 | P9 | P8 | P7 | P6 | P5 | P4 | P3 | P2 | P1 | P0 |

Backplane Addressing

The byte address of a particular pixel on the Backplane IC is a concatenation of its row and column numbers, with its least significant bit (LSB) truncated. The LSB is removed because there are two pixels at each byte address. The column number ranges from 0 to 799, requiring 10 bits. The row number runs from 0 to 599, also requiring 10 bits. The following example illustrates how to calculate the byte address for a given pixel position. The pixel in row 234 and column 567 is given in the upper nibble of the byte as follows.

| | |
|---|---|
| {234, 567} | {10′b00_1110_1010, 10′b10_0011_0111} |
| | {10′b00_1110_1010, 9′b1_0001_1011} |
| | 19′b001_1101_0101_0001_1011 |
| | 0x1D51B |

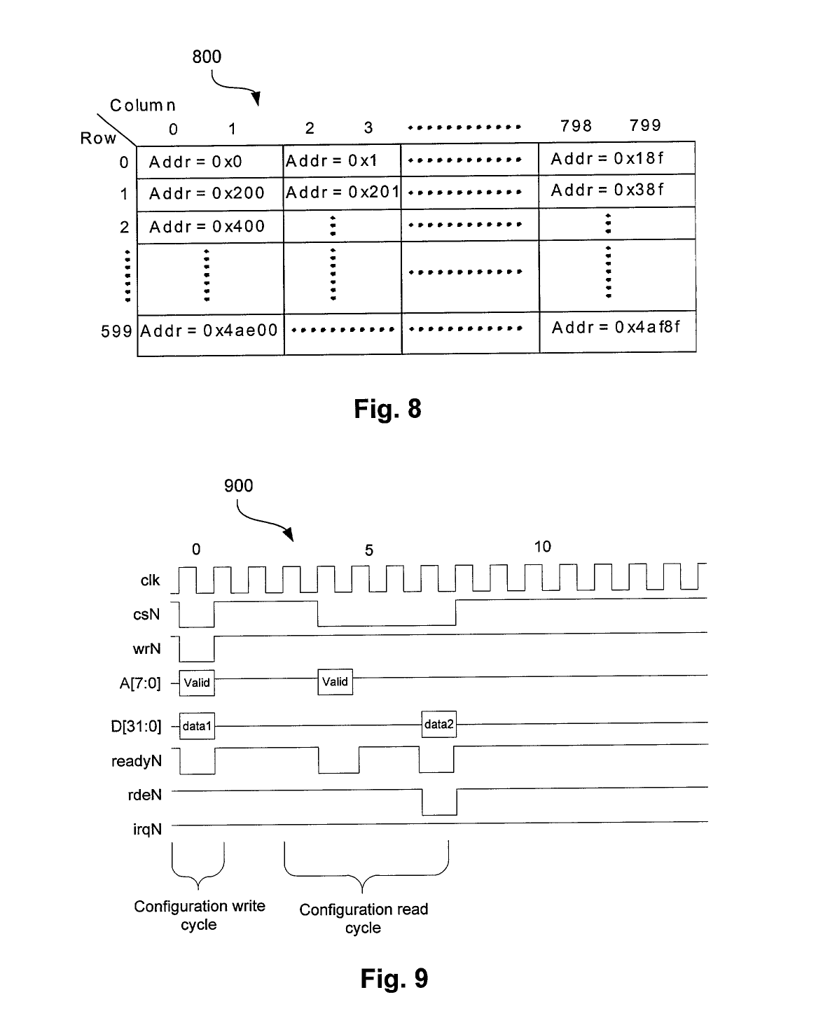

FIG. 8 illustrates the address 800 relative to pixel position for the Backplane.

### System Bus

Address Bus

The Backplane is indirectly addressable from the external system. This means that all data transfer to the Backplane is accomplished through block moves, dma, or other register controlled operations. The Display System has 8 address bits. The internal configuration registers are accessed whenever the most significant address bit A[7] is driven high. The IC resumes block transfer mode when A[7] is low. The remaining address bits, A[6:0], are used for register addresses when A[7] is high, and ignored otherwise.

Data Bus

The Backplane can be configured to look for 8, 16, or 32 bit transfers. Writing to the data bus width register of the Display System configures valid data widths. After reset, the Display System's data bus width register is set to byte mode. This means that only D[7:0] are valid.

### Bus Protocol

Bus Handshake

The host system (CRASIC) initiates all transactions between itself and the Display System. To begin a cycle, the host issues a chip select (csN) and a write enable (weN) to the Display System. At the end of the cycle the host samples the readyN. If the readyN signal has not been selected by the Display System, the transaction must be restarted.

Address data only needs to be driven by the host system for a Display System register transaction. For Display System register accesses, address data is driven at the same time the csN and weN are driven. Otherwise, address data is ignored by the Display System and does not need to be generated by the host.

When weN is driven low, the Display System considers the transaction to be a write transaction. After driving csN and weN, the host checks for readyN assertion. If the readyN signal has been asserted, the host sends data. The readyN signal must remain asserted for each data word placed on the bus. If the readyN signal goes invalid during a -multi-word write cycle, the entire transaction must be restarted.

A valid read transaction occurs when the weN signal is left high following a csN assertion. If the readyN signal is selected immediately after the csN is selected, and weN is high, then a valid read cycle has been started. The readyN signal will de-select, and some indeterminate amount of time later the Display System will put data on the bus. Data is valid with rdeN selected by the Display System.

Block Transfers

Block transfers are a very important function of the Display System. They are important because they are one of only two ways (DMA is the other) that data can be written to, or read from, the Backplane. The block transfers enable all or part of a row of pixel data to be written to the Display System without wait states. A rectangular region of arbitrary shape can be transferred as a sequence of these rows, with only a 3-wait-state delay between rows.

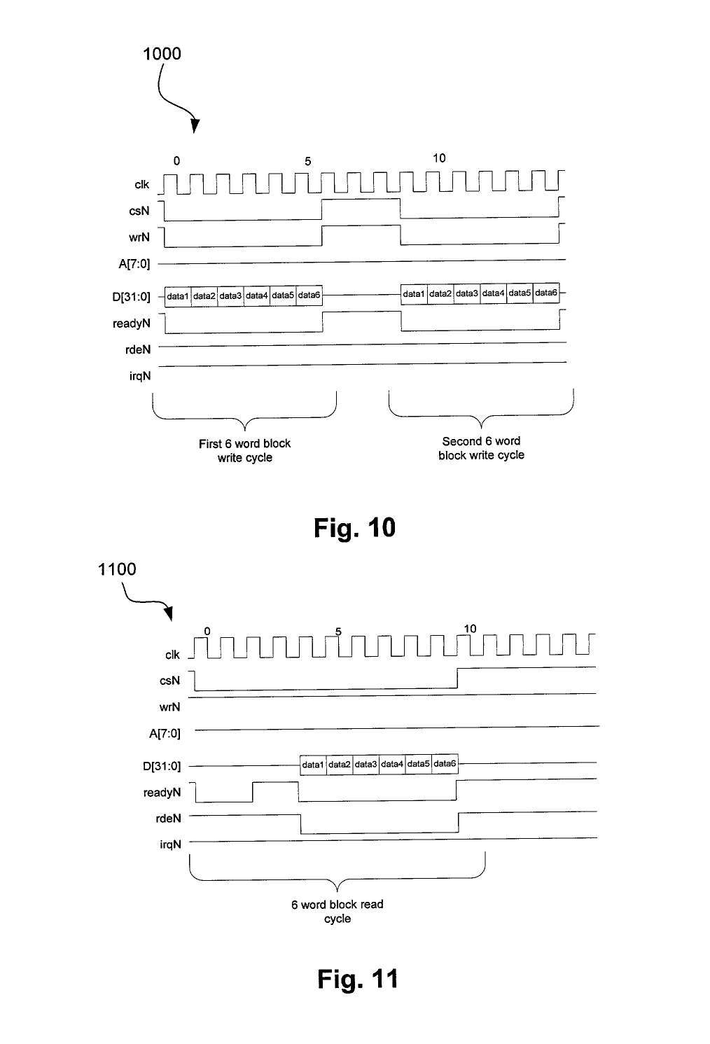

FIG. 9 illustrates a configuration write and read transaction waveform 900. FIG. 10 is a timing diagram depicting an exemplary waveform 1000 of a block transfer of two rows of six words each. The address boundaries of the data are configured prior to the transfer. The values on the address bus are ignored during the transfer.

Block reads are accomplished in a similar manner. FIG. 11 is a timing diagram showing a demonstration of a waveform 1100 of a block read of 6 words. Again, the address range for pixel data is set up prior to starting the block read cycle. Once the cycle begins, the Display System places data words on the bus an indeterminate time later. This fact should be of no great consequence. The Display System is capable of automatically reading data, inverting it and writing it back to the array very quickly. It is only when the host system wants to verify data for system test purposes that a block read will be used. Therefore, the latency of a block read, as seen by the host system, is not important.

A final benefit to the Display System's block transfer capability is that block transfers can work in conjunction with the interrupt mechanism. The Display System can generate interrupts that indicate the end of a field or frame. These interrupts can then be used by the host system to start a new block transfer.

Even with block transfers, the time for loading the whole Backplane is considerable. The following table shows the update duration as a function of the data bus widths possible on the Display System, and a sampling of clock frequencies.

TABLE 7
Full Backplane Update Times

| | | Duration | Duration |
|---|---|---|---|
| Bus Width | # Clock Cycles | @30 MHz | @60 MHz |
| 8 Bits | 240 K | 8 ms | 4 ms |
| 16 Bits | 120 K | 4 ms | 2 ms |
| 32 Bits | 60 K | 2 ms | 1 ms |

### Backplane IC Configuration

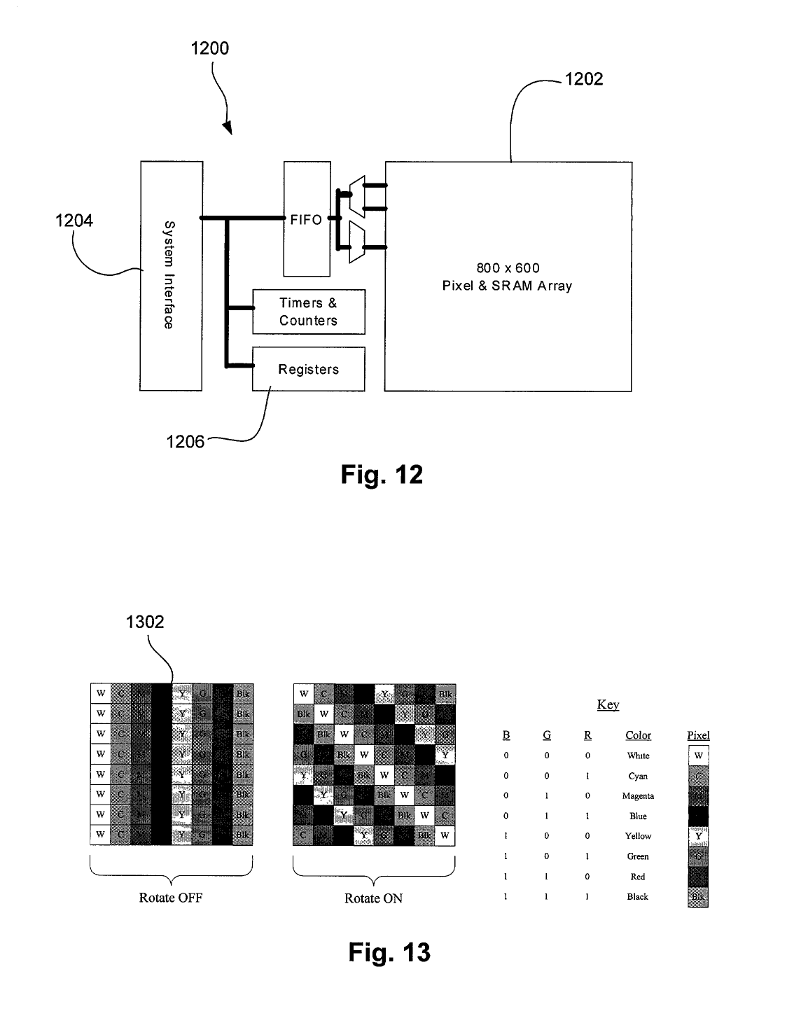

FIG. 12 is a block diagram of the Backplane Integrated Circuit 1200. The components include a pixel and SRAM array 1202, a system interface 1204, a register data store 1206, and timers and counters.

### Configuration Registers

The configuration registers control the operation of the chip. They control everything from basic parameters like data bus width, to complex timing, to special operations such as scrolling. Accessing the configuration registers themselves, however, is simple and fixed, with no special control lines to drive. The configuration registers are grouped in 5 areas, System Interface, General Timing, Strobe Control, LCD Control, and DMA Control. Each of these groups will be discussed in the sections to follow.

The configuration registers are accessed whenever A[ 19]=1. The address for a specific configuration is given by A[10:4]. The values of A[18:11] and A[3:0] are ignored on a configuration access, so that a large number of aliases exist.

In the tables below, A[19]=1 is assumed, and the registers are mapped according to the value of A[10:4] only. Since A[3:0] is ignored, new register addresses occur every sixteen bytes. By convention, the register addresses below occur in multiples of 10 (hex): 0, 10, 20, 30, 40, etc. Because of aliasing, addresses 0x000 and 0x001 point to the same register, although only address 0x000 is given in the tables.

Not always are all 8 bits defined for a particular configuration register in the tables below. Where a bit is undefined, it should be considered reserved, and a ‘0’ written to it for compatibility with future chips. Reading an undefined bit always returns a ‘0’.

Not all possible values of A[10:4] map into a configuration register. Such values should be considered reserved for future configuration registers. Only values of ‘00’ should be written to reserved register addresses, to maintain compatibility with future chips. Reading a reserved register always returns ‘00’.

All registers below are read/write accessible, except where noted. All address values are given in hexadecimal. The Init column indicates the values of the respective variables at reset.

### Configuration Register Address Map

TABLE 8
Configuration Register Summary

| Address Range | Register Group | Description |
|---|---|---|
| 0x000-0x170 | System Interface | Chip ID, data format, bus width, |
| | | burst control, block transfer setup, |
| | | and interrupt handling. |
| 0x180-0x2F0 | General Timing | Time unit, frame, field, and time slot |
| | | length definitions. |
| 0x300-0x3F | Strobe Control | Strobe specification by time slot. |
| 0x400-0x5f0 | LCD Control | LED timing, ITO refresh timing, data |
| | | inversion, and ring electrode control. |
| 0x600-0x7f0 | DMA Control | Self-test, scroll, and pattern fill. |

### System Interface Register (0x0)

The Display System revision number is contained in the 8 bit Chip Id register. This register is read only.

TABLE 9
System Interface Register

| Addr | Bits | Init | Name | Description |
|---|---|---|---|---|
| 0x000 | | | | |
| | 7:0 | 1 | ID | Chip identification (read only). Always |
| | | | | returns 0x01 on a configuration read. |
| 0x010 | | | | |
| | 7 | 0 | monochrome | Pixel format. Enter ‘1’ for monochrome |
| | | | | data packed 8 pixels to a byte. Enter ‘0’ |
| | | | | for RGB data packed 2 pixels to a byte. |
| | 6 | 0 | dumbit | Dummy bit. Value of bits used to fill out |
| | | | | data buses containing RGB pixels on |
| | | | | reads. |
| | 5:3 | 7 | background_color | RGB Color value written to the pixel for |
| | | | | an arriving ‘1’ bit in monochrome mode. |
| | 2:0 | 0 | foreground_color | RGB Color value written to the pixel for |
| | | | | an arriving ‘0’ bit in monochrome mode. |
| 0x020 | | | | |
| | 2 | 0 | ready_off | Pin readyN behavior on reads. Enter ‘1’ to |
| | | | | keep readyN de-selected on the return of |
| | | | | the last read data, and during the bus |
| | | | | turnaround cycle. Enter ‘0’ to assert |
| | | | | readyN on the last data and bus |
| | | | | turnaround cycles. |
| | 1:0 | 0 | width | Data bus width. Enter: |
| | | | | 00: 8-bit bus |
| | | | | 01: 16-bit bus |
| | | | | 1x: 32-bit bus. |
| 0x030 | | | | |
| | 1 | 0 | vert_flip | Vertical orientation. Enter ‘0’ to position |
| | | | | row 0 at the far top, and row 799 at the far |
| | | | | bottom. Enter ‘1’ for the reverse. |
| | 0 | 0 | horiz_flip | Horizontal orientation. Enter ‘0’ to |
| | | | | position column 0 at the far left, and |
| | | | | column 799 at the far right. Enter ‘1’ for |
| | | | | the reverse. |
| 0x040 | | | | |
| | 2:1 | 0 | burst_siz | Burst size. Enter: |
| | | | | 00: 1-word burst (no burst) |
| | | | | 01: 2-word burst |
| | | | | 10: 4-word burst |
| | | | | 11: 8-word burst. |
| | 0 | 0 | subblock | Burst address ordering. Enter: |
| | | | | 0: linear ordering |
| | | | | 1: sub block ordering |
| 0x050 | | | | |
| | 1 | 0 | xfer_row_increment | Row auto increment. Enter ‘1’ to |
| | | | | automatically increment xfer_row at the |
| | | | | end of each row in a block transfer. |
| | 0 | 0 | block_xfer | Block transfer enable. Enter ‘1’ to enable |
| | | | | block transfer operations. Enter ‘0’ to use |
| | | | | the address inA[18:0] as the address for a |
| | | | | data access. |
| 0x080 | | | | |
| | 7:0 | 00 | xfer_left_col[7:0] | Lowest order 8 bits of address of left |
| | | | | column for block transfer operation. |
| | | | | Lowest bit, xfer_left_col[0], is read only |
| | | | | and always returns ‘0’. |
| 0x090 | | | | |
| | 1:0 | 0 | xfer_left_col[9:8] | Highest order 2 bits of address of left |
| | | | | column for block transfer operation. |
| 0x0A0 | | | | |
| | 7:0 | 00 | xfer_right_col[7:0] | Lowest order 8 bits of address of right |
| | | | | column for block transfer operation. |
| | | | | Lowest bit, xfer_right_col[0], is read only |
| | | | | and always returns ‘1’. |
| 0x0B0 | | | | |
| | 1:0 | 0 | xfer_right_col[9:8] | Highest order 2 bits of address of right |
| | | | | column for block transfer operation. |
| 0x0C0 | | | | |
| | 7:0 | 00 | xfer_start_row[7:0] | Lowest order 8 bits of starting row in |
| | | | | block transfer operation. |
| 0x0D0 | | | | |
| | 1:0 | 0 | xfer_start_row[9:8] | Highest order 2 bits of address of starting |
| | | | | row in block transfer operation. |
| 0x0E0 | | | | |
| | 7:0 | 00 | xfer_cur_row[7:0] | Lowest order 8 bits of current row in |
| | | | | block transfer operation. Initialized to |
| | | | | xfer_start_row[7:0] whenever |
| | | | | block_xfer = 0. Read only. |
| 0x0F0 | | | | |
| | 1:0 | 0 | xfer_cur_row[9:8] | Highest order 2 bits of address of current |
| | | | | row in block transfer operation. Initialized |
| | | | | to xfer_start_row[9:8] whenever |
| | | | | block_xfer = 0. Read only. |
| 0x100 | | | | Interrupt enable register #0. Writing a ‘1’ |
| | | | | to a bit enables the detection of the |
| | | | | corresponding condition to cause an |
| | | | | interrupt request on pin irqN. |
| | 7 | 0 | irq_enable[7] | Pattern fill done enable. |
| | 6 | 0 | irq_enable[6] | Data inversion done enable. |
| | 5 | 0 | irq_enable[5] | Pending data inversion enable. |
| | 4 | 0 | irq_enable[4] | Frame done enable. |
| | 3 | 0 | irq_enable[3] | Field done enable. |
| | 2 | 0 | irq_enable[2] | Region done enable. |
| | 1 | 0 | irq_enable[1] | Slot done enable. |
| | 0 | 0 | irq_enable[0] | Tick done enable. |
| 0x110 | | | | Interrupt enable register #1. |
| | 1 | 0 | irq_enable[9] | Self-test done enable. |
| | 0 | 0 | irq_enable[8] | Scroll done enable. |
| 0x120 | | | | Interrupt status register #0. On a read, a |
| | | | | ‘1’ in a bit indicates the detection of the |
| | | | | corresponding condition since the last |
| | | | | time the bit was cleared. Writing a ‘0’ to a |
| | | | | bit clears the bit. Writing a ‘1’ has no |
| | | | | effect. |
| | 7 | 0 | irq_status [7] | Pattern fill done status. |
| | 6 | 0 | irq_status [6] | Data inversion done status. |
| | 5 | 0 | irq_status [5] | Pending data inversion status. |
| | 4 | 0 | irq_status [4] | Frame done status. |
| | 3 | 0 | irq_status [3] | Field done status. |
| | 2 | 0 | irq_status [2] | Region done status. |
| | 1 | 0 | irq_status [1] | Slot done status. |
| | 0 | 0 | irq_status [0] | Tick done status. |
| 0x130 | | | | Interrupt status register #1. |
| | 1 | 0 | irq_status [9] | Self-test done status. |
| | 0 | 0 | irq_status [8] | Scroll done status. |

### System Registers (0x10-0xF0)

Pixel Formats (0x10)

There are 3 bits of data associated with every pixel in the Backplane. In RGB mode, when the MSB of the low and high order 4 bits in an 8 bit data word is thrown out, the remaining 6 bits are stored at each pixel pair location. In Monochrome mode, the value of each bit in the data word tells the Display System which value to store at each pixel location. For example, if the 8 bit data word is 11110000, then each of the first 4 pixel locations would be filled with the 3 bit foreground color value, and the next four pixel locations would be filled with the 3 bit background color. Refer to previous table for the description of each bit in the pixel format configuration register, 0x10. In this register the user can select between Monochrome and RGB mode, set the background and foreground color, and set the value of the dumbit. The dumbit is the value of the extra two bits in an 8 bit word when reading from RGB pixel values.

Bus Width and Ready Control (0x20)

The width of the data bus can be configured in the system register 0x20. The width can be 8, 16, or 32 bits in length. This register also contains a bit called ready off which controls the behavior of the readyN signal on reads. When this bit is set, the readyN signal will be de-selected on the return of the last read of data, and during the bus turnaround cycle. The reverse is true when the ready off is set to 0.

Orientation (0x30)

The orientation register allows the pixel orientation to be changed in one of four ways. The orientation can be flipped vertically, horizontally, both vertically and horizontally, or unmodified. A vertical flip puts pixels from the right side over to the left. A horizontal flip puts pixels from the top to the bottom.

Block Move Control (0x50-0xF0)

There are nine registers that control block moves. They are block control register, left column, right column, start row, and current row. Several of these registers are split into two parts for high and low order bits. Register 0x50 controls starting and stopping the block moves. The other registers set the row and column position for the block move.

### Interrupt Control Registers (0x100-0x130)

Interrupts can be sent to the host system from the Display System following several events. The criteria for controlling the interrupt select is setup in the Interrupt Configuration registers that range from address 0x100 to 0x130. Registers 0x100 and 0x110 are the interrupt enable signals that specify which Display System events can cause an interrupt to occur. Registers 0x120 and 0x130 are the interrupt status registers that indicate which Display System events have triggered an interrupt. When registers 0x120 and 0x130 are read, a 1 in a particular bit position indicates that the corresponding Display System event has caused an interrupt. The host system can write a 0 to appropriate interrupt status register bit position, to clear the interrupt event and thereby end the interrupt cycle.

The Boolean expression for the output interrupt request pin irqN is

irqN=˜|(irq_status & irq_enable),

Where the AND (&) operation is bit-wise between the irq_status and irq_enable arrays, and the bits of the resultant array are ORed (|)together, and then inverted (˜).

### General Timing Registers (0x180-0x2F0)

Tick (0x180-0x190)

The Tick Configuration register is used for setting up the tick length of the in system timers. The tick length can be 32, 64, or 96 clock cycles. This register also contains the tick_enable bit. The tick_enable bit enables or disables all timers.

Time Slot (0x1E0-0x1F0)

The Time Slot register contains the timer overflow values for the transition and flash regions of fields 0 to 3. This register also contains the remaining count for the current time slot.

Field (0x1C0-1D0)

The Field register is used for setting the number of time slots in the transition and flash regions.

Frame Configuration (0xA0)

A frame can be defined as having one, two, three, or four fields. While each field has the same number of time slots, the time slots for each are individually programmable. This way the lengths of each field are individually programmable. The timing of interrupts, ITO refreshes, LED flashes, and bit plane strobing are all entered relative to the definition of a frame. The Frame Configuration register holds the number of fields in a frame, and the field division. The field division bit chooses between having only one flash region per frame, or a flash region following each transition region.

TABLE 10
General Timing Registers

| Addr | Bits | Init | Name | Description |
|---|---|---|---|---|
| 0x180 | | | | |
| | 7:0 | FF | tick_cycles | Tick length in clock cycles. Enter ‘0’ for |
| | | | | 32 cycles, ‘1’ for 64 cycles, ‘2’ for 96 |
| | | | | cycles, etc. |
| 0x190 | | | | |
| | 0 | 1 | tick_enable | Master enable for all timers. Enter ‘0’ to |
| | | | | turn off all timers. A rising edge on this |
| | | | | bit serves as the master trigger for all |
| | | | | timers. Note that the ITO refresh timer is |
| | | | | enabled directly out of reset, prior to a |
| | | | | rising edge on tick_enable. |
| 0x1A0 | | | | |
| | 2:1 | 0 | nfields | Number of fields in a frame. Enter ‘0’ for |
| | | | | 1 field, ‘1’ for 2 fields, etc. |
| | 0 | 0 | flash_only | Field division. Enter ‘1’ to define each |
| | | | | field as containing only a flash region. |
| | | | | Enter ‘0’ to divide each field into a |
| | | | | transition region, followed by a flash |
| | | | | region. |
| 0x1C0 | | | | |
| | 4:0 | 0 | ntrans_slots | Number of time slots in the transition |
| | | | | region of a field. Enter ‘0’ for 1 time slot, |
| | | | | ‘1’ for 2 time slots, etc. |
| 0x1D0 | | | | |
| | 4:0 | 0 | nflash_slots | Number of time slots in the flash region of |
| | | | | a field. Analogous to ntrans_slots. |
| 0x1E0 | | | | |
| | 7:0 | 00 | cur_slot_lng[7:0] | Highest order 8 bits of current count of |
| | | | | remaining ticks in a slot. Read only. |
| | | | | Interpret ‘0’ as 1 tick, ‘1’ for 2 ticks, etc. |
| 0x1F0 | | | | |
| | 7:0 | 04 | cur_slot_lng[15:8] | Highest order 8 bits of current count of |
| | | | | remaining ticks in a slot. Read only. |
| 0x200 | | | | |
| | 7:0 | 00 | trans_slot_lng[0] | Lowest order 8 bits of length of a time slot |
| | | | [7:0] | in the transition region for field 0. Enter |
| | | | | ‘0’ for 1 tick, ‘1’ for 2 ticks, etc. |
| 0x210 | | | | |
| | 7:0 | 04 | trans_slot_lng[0] | Highest order 8 bits of length of a time |
| | | | [15:8] | slot in the transition region for field 0. |
| 0x220 | | | | |
| | 7:0 | 00 | trans_slot_lng[1] | Lowest order 8 bits of length of a time slot |
| | | | [7:0] | in the transition region for field 1. |
| 0x230 | | | | |
| | 7:0 | 04 | trans_slot_lng[1] | Highest order 8 bits of length of a time |
| | | | [15:8] | slot in the transition region for field 1. |
| 0x240 | | | | |
| | 7:0 | 00 | trans_slot_lng[2] | Lowest order 8 bits of length of a time slot |
| | | | [7:0] | in the transition region for field 2. |
| 0x250 | | | | |
| | 7:0 | 04 | trans_slot_lng[2] | Highest order 8 bits of length of a time |
| | | | [15:8] | slot in the transition region for field 2. |
| 0x260 | | | | |
| | 7:0 | 00 | trans_slot_lng[3] | Lowest order 8 bits of length of a time slot |
| | | | [7:0] | in the transition region for field 3. |
| 0x270 | | | | |
| | 7:0 | 04 | trans_slot_lng[3] | Highest order 8 bits of length of a time |
| | | | [15:8] | slot in the transition region for field 3. |
| 0x280 | | | | |
| | 7:0 | 00 | flash_slot_lng[0] | Lowest order 8 bits of length of a time slot |
| | | | [7:0] | in the flash region for field 0. |
| 0x290 | | | | |
| | 7:0 | 04 | flash_slot_lng[0] | Highest order 8 bits of length of a time |
| | | | [15:8] | slot in the flash region for field 0. |
| 0x2A0 | | | | |
| | 7:0 | 00 | flash_slot_lng[1] | Lowest order 8 bits of length of a time slot |
| | | | [7:0] | in the flash region for field 1. |
| 0x2B0 | | | | |
| | 7:0 | 04 | flash_slot_lng[1] | Highest order 8 bits of length of a time |
| | | | [15:8] | slot in the flash region for field 1. |
| 0x2C0 | | | | |
| | 7:0 | 00 | flash_slot_lng[2] | Lowest order 8 bits of length of a time slot |
| | | | [7:0] | in the flash region for field 2. |
| 0x2D0 | | | | |
| | 7:0 | 04 | flash_slot_lng[2] | Highest order 8 bits of length of a time |
| | | | [15:8] | slot in the flash region for field 2. |
| 0x2E0 | | | | |
| | 7:0 | 00 | flash_slot_lng[3] | Lowest order 8 bits of length of a time slot |
| | | | [7:0] | in the flash region for field 3. |
| 0x2F0 | | | | |
| | 7:0 | 04 | flash_slot_lng[3] | Highest order 8 bits of length of a time |
| | | | [15:8] | slot in the flash region for field 3. |

### Color Strobing Registers (0x300-0x3F0)

Separate gray scale algorithms can be specified for the flash and transition regions of each field. Each algorithm consists of an assignment of bit planes to time slots for up to 32 slots. The gray scale algorithm for the flash region is repeated for every field. The gray scale algorithm for the flash region is shared among all fields.

Alternately, each flash or transition region can be treated as having only a single time slot, and can be assigned different bit planes from those of other flash and transition regions.

TABLE 11
Strobe Control Registers

| Addr | Bits | Init | Name | Description |
|---|---|---|---|---|
| 0x300 | | | | |
| | 7:2 | 00 | trans_color[3:1] | Color of time slots 3 - 1 in the transition |
| | | | | region. Analogous to trans_color[0]. |
| | 1:0 | 00 | trans_color[0] | Color of time slot 0 in the transition |
| | | | | region. Enter ‘0’ for red strobe (plane 0), |
| | | | | ‘1’ for green strobe (plane 1), ‘2’ for blue |
| | | | | strobe (plane 2), or ‘3’ for no strobe at all. |
| | | | | If ntrans_slots = 1, then trans_color[0] is |
| | | | | the color of the transition region of field 0 |
| | | | | only. Else trans_color[0] is the color of |
| | | | | time slot 0 for the transition regions of all |
| | | | | fields. |
| 0x310 | | | | |
| | 7:0 | 00 | trans_color[7:4] | Color of time slots 7 - 4 in the transition |
| | | | | region of all fields. Enter ‘0’ for red strobe |
| | | | | (plane 0), ‘1’ for green strobe (plane 1), |
| | | | | ‘2’ for blue strobe (plane 2), or ‘3’ for no |
| | | | | strobe at all. |
| | | | | The color of time slot n is ignored unless |
| | | | | ntrans_slots >= n. |
| 0x320 | | | | |
| | 7:0 | 00 | trans_color[11:8] | Color of time slots 11 - 8 in the transition |
| | | | | region of each field. Analogous to |
| | | | | trans_color[7:4]. |
| 0x330 | | | | |
| | 7:0 | 00 | trans_color[15:12] | Color of time slots 15 - 12 in the |
| | | | | transition region of each field. Analogous |
| | | | | to trans_color[7:4]. |
| 0x340 | | | | |
| | 7:0 | 00 | trans_color[19:16] | Color of time slots 19 - 16 in the |
| | | | | transition region of each field. Analogous |
| | | | | to trans_color[7:4]. |
| 0x350 | | | | |
| | 7:0 | 00 | trans_color[23:20] | Color of time slots 23 - 20 in the transition |
| | | | | region of each field. Analogous to |
| | | | | trans_color[7:4]. |
| 0x360 | | | | |
| | 7:0 | 00 | trans_color[27:24] | Color of time slots 27 - 24 in the transition |
| | | | | region of each field. Analogous to |
| | | | | trans_color[7:4]. |
| 0x370 | | | | |
| | 7:0 | 00 | trans_color[31:28] | Color of time slots 31 - 28 in the transition |
| | | | | region of each field. Analogous to |
| | | | | trans_color[7:4]. |
| 0x380 | | | | |
| | 7:2 | 00 | flash_color[3:1] | Color of time slots 3 - 1 in the flash. |
| | | | | Analogous to flash_color[0]. |
| | 1:0 | 00 | flash_color[0] | Color of time slot 0 in the flash region. |
| | | | | Enter ‘0’ for red strobe (plane 0), ‘1’ for |
| | | | | green strobe (plane 1), ‘2’ for blue strobe |
| | | | | (plane 2), or ‘3’ for no strobe at all. |
| | | | | If nflash_slots = 1, then flash_color[0] is |
| | | | | the color of the flash region of field 0 |
| | | | | only. Else flash_color[0] is the color of |
| | | | | time slot 0 for the flash regions of all |
| | | | | fields. |
| 0x390 | | | | |
| | 7:0 | 00 | flash_color[7:4] | Color of time slots 7 - 4 in the flash |
| | | | | region of all fields. Enter ‘0’ for red strobe |
| | | | | (plane 0), ‘1’ for green strobe (plane 1), |
| | | | | ‘2’ for blue strobe (plane 2), or ‘3’ for no |
| | | | | strobe at all. |
| | | | | The color of time slot n is ignored unless |
| | | | | nflash_slots >= n. |
| 0x3A0 | | | | |
| | 7:0 | 00 | flash_color[11:8] | Color of time slots 11 - 8 in the flash |
| | | | | region of each field. Analogous to |
| | | | | flash_color[7:4]. |
| 0x3B0 | | | | |
| | 7:0 | 00 | flash_color[15:12] | Color of time slots 15 - 12 in the flash |
| | | | | region of each field. Analogous to |
| | | | | flash_color[7:4]. |
| 0x3C0 | | | | |
| | 7:0 | 00 | flash_color[19:16] | Color of time slots 19 - 16 in the flash |
| | | | | region of each field. Analogous to |
| | | | | flash_color[7:4]. |
| 0x3D0 | | | | |
| | 7:0 | 00 | flash_color[23:20] | Color of time slots 23 - 20 in the flash |
| | | | | region of each field. Analogous to |
| | | | | flash_color[7:4]. |
| 0x3E0 | | | | |
| | 7:0 | 00 | flash_color[27:24] | Color of time slots 27 - 24 in the flash |
| | | | | region of each field. Analogous to |
| | | | | flash_color[7:4]. |
| 0x3F0 | | | | |
| | 7:0 | 00 | flash_color[31:28] | Color of time slots 31 - 28 in the flash |
| | | | | region of each field. Analogous to |
| | | | | flash_color[7:4]. |

### ITO Refresh Registers (0x490-0x4A0)

The ITO Refresh register allows the host system to setup Display System ITO inversion automatically, or manually. This register also controls the relationship between the ring polarity and the ITO voltage, the refresh interval, and provides the status of ITO and ring levels. Polarity switching of the ring electrode can be synchronized with ITO refreshes, or put in a manual control state. When ITO inversion is set to automatic control, the frequency can be set in units of frames.

Internal data inversion can be set for all at once at the time of ITO refresh, or broken into two stages. In the first stage, the field preceding an ITO refresh is used to invert the data strobed in the field concurrent with the ITO refresh. The two-stage format doubles the power consumption incident in internal data inversion.

### LED Control Registers (0x4E0-0x5B0)

The LED Control registers setup and control the behavior of the LED's. In these registers, the delay length after the flash can be set for each led. These registers also provide the ability to configure the led manually using the led level field.

TABLE 12
LCD Control

| Addr | Bits | Init | Name | Description |
|---|---|---|---|---|
| 0x400 | | | | |
| | 7:0 | 00 | inv_left_col[7:0] | Lowest order 8 bits of address of left |
| | | | | column for data inversion operation. |
| | | | | Lowest 6 bits, inv_left_col[5:0], are read |
| | | | | only and always return ‘0x00’. |
| 0x410 | | | | |
| | 1:0 | 0 | inv_left_col[9:8] | Highest order 2 bits of address of left |
| | | | | column for data inversion operation |
| 0x420 | | | | |
| | 7:0 | 3F | inv_right_col[7:0] | Lowest order 8 bits of address of right |
| | | | | column for data inversion operation. |
| | | | | Lowest 6 bits, inv_right_col[5:0], are read |
| | | | | only and always return ‘0x3F’. |
| 0x430 | | | | |
| | 1:0 | 3 | inv_right_col[9:8] | Highest order 2 bits of address of right |
| | | | | column for data inversion operation |
| 0x440 | | | | |
| | 7:0 | 00 | inv_top_row[7:0] | Lowest order 8 bits of address of top row |
| | | | | for data inversion operation. |
| 0x450 | | | | |
| | 0 | 0 | inv_top_row[8] | Highest order bit of address of top row for |
| | | | | data inversion operation. |
| 0x460 | | | | |
| | 7:0 | 2B | inv_bottom_row | Lowest order 8 bits of address of bottom |
| | | | [7:0] | row for data inversion operation. |
| 0x470 | | | | |
| | 0 | 1 | inv_bottom_row[8] | Highest order bit of address of bottom row |
| | | | | for data inversion operation. |
| 0x480 | | | | |
| | 2 | 1 | auto_invert | Automatic data inversion. Enter ‘1’ to |
| | | | | invert data on ITO refresh. Ignored if |
| | | | | auto_refresh = 0. |
| | 1 | 0 | staged_invert | Staged inversion. Enter ‘1’ to invert data |
| | | | | over two consecutive fields. Enter ‘0’ to |
| | | | | invert data in one stage. Ignored if |
| | | | | auto_refresh = 0. |
| | 0 | 0 | man_invert | Manual data inversion. Initiates data |
| | | | | inversion on a rising edge of this bit. |
| | | | | Ignored if auto_refresh = 1 and |
| | | | | auto_invert = 1. |
| 0x490 | | | | |
| | 4 | 1 | ring_follow | Automatic synchronization of ring |
| | | | | electrode to ITO refresh. Enter ‘1’ to |
| | | | | enable. |
| | 3 | 1 | ring_polarity | Polarity of ring electrode relative to ITO |
| | | | | value. Enter ‘0’ to echo ITO value, ‘1’ to |
| | | | | invert. Valid only if ring_follow = 1. |
| | 2 | 1 | ring_level | Ring electrode voltage. Read only if |
| | | | | ring_follow = 1. |
| | 1 | 0 | ito_level | ITO Voltage. Read only if auto_refresh = |
| | | | | 1. |
| | 0 | 1 | auto_refresh | Automatic ITO refresh enable. |
| 0x4A0 | | | | |
| | 7:0 | 0 | refresh_interval | Interval between refreshes, Enter ‘0’ for 1 |
| | | | | frame, ‘1’ for 2 frames, etc. |
| Ox4E0 | | | | |
| | 7:0 | 00 | cur_delay[7:0] | Highest order 8 bits of current count of |
| | | | | remaining ticks in the flash delay. Read |
| | | | | only. Interpret ‘0’ as 1 tick, ‘1’ for 2 ticks, |
| | | | | etc. |
| 0x4F0 | | | | |
| | 7:0 | 04 | cur_delay[15:8] | Highest order 8 bits of current count of |
| | | | | remaining ticks in the flash delay. Read |
| | | | | only. |
| 0x500 | | | | |
| | 7:0 | 00 | flash_delay[0] | Lowest order 8 bits of illumination delay |
| | | | [7:0] | after the start of the flash region for field |
| | | | | 0. Enter ‘0’ for 0 ticks, ‘1’ for 1 tick, etc. |
| 0x510 | | | | |
| | 7:0 | 00 | flash_delay[0] | Highest order 8 bits of illumination delay |
| | | | [15:8] | after the start of the flash region for field |
| | | | | 0. |
| 0x520 | | | | |
| | 7:0 | 00 | flash_delay[1] [7:0] | Lowest order 8 bits of illumination delay |
| | | | | after the start of the flash region for field |
| | | | | 1. |
| 0x530 | | | | |
| | 7:0 | 00 | flash_delay[1] | Highest order 8 bits of illumination delay |
| | | | [15:8] | after the start of the flash region for field |
| | | | | 1. |
| 0x540 | | | | |
| | 7:0 | 00 | flash_delay[2] | Lowest order 8 bits of illumination delay |
| | | | [7:0] | after the start of the flash region for field |
| | | | | 2. |
| 0x550 | | | | |
| | 7:0 | 00 | flash_delay[2] | Highest order 8 bits of illumination delay |
| | | | [15:8] | after the start of the flash region for field |
| | | | | 2. |
| 0x560 | | | | |
| | 7:0 | 00 | flash_delay[3] [7:0] | Lowest order 8 bits of illumination delay |
| | | | | after the start of the flash region for field |
| | | | | 3. |
| 0x570 | | | | |
| | 7:0 | 00 | flash_delay[3] | Highest order 8 bits of illumination delay |
| | | | [15:8] | after the start of the flash region for field |
| | | | | 3. |
| 0x580 | | | | |
| | 5:3 | 0 | led _color[1] | Field 1 illumination. Analogous to field 0 |
| | | | | illumination. |
| | 2 | 0 | led_color[0] [2] | Blue illumination in field 0. |
| | 1 | 0 | led_color[0] [1] | Green illumination in field 0. |
| | 0 | 0 | led_color[0] [0] | Red illumination in field 0. Enter a ‘1’ to |
| | | | | turn the red LED on during the flash |
| | | | | region of field 0. |
| 0x590 | | | | |
| | 5:3 | 0 | led_color[3] | Field 3 illumination. Analogous to field 0 |
| | | | | illumination. |
| | 2:0 | 0 | led_color[2] | Field 2 illumination. Analogous to field 0 |
| | | | | illumination. |
| 0x5A0 | | | | |
| | 3 | 0 | man_led | Manual LED control. Enter ‘1’ to control |
| | | | | the led pin manually using the led_level |
| | | | | field (5B0: 3). Enter ‘0’ to put the led pin |
| | | | | under automatic control of the chip timing |
| | | | | system. |
| | 2 | 0 | man_blue | Manual blue control. Enter ‘1’ to control |
| | | | | the blue pin manually using the blue_level |
| | | | | field (5B0: 2). Enter ‘0’ to put the blue pin |
| | | | | under automatic control of the chip timing |
| | | | | system. |
| | 1 | 0 | man_green | Manual green control. Enter ‘1’ to control |
| | | | | the green pin manually using the |
| | | | | green_level field (5B0: 1). Enter ‘0’ to put |
| | | | | the green pin under automatic control of |
| | | | | the chip timing system. |
| | 0 | 0 | man_red | Manual red control. Enter ‘1’ to control |
| | | | | the red pin manually using the red_level |
| | | | | field (5B0: 0). Enter ‘0’ to put the red pin |
| | | | | under automatic control of the chip timing |
| | | | | system. |
| 0x5B0 | | | | |
| | 3 | 0 | led_level | LED Voltage. Read only if man_led = 0. |
| | 2 | 0 | blue_level | Blue voltage. Read only if man_blue = 0. |
| | 1 | 0 | green_level | Green voltage. Read only if man_green = |
| | | | | 0. |
| | 0 | 0 | Red _level | Red voltage. Read only if man_red = 0. |

### DMA Control Registers (0x400-7F0)

The DMA Control registers can be divided into several groups. The groups are Data Inversion, Pattern Fill, Scrolling, and Self Test.

The Data inversion group is located from 0x400-0x480. These registers contain the row and column pixel array positions of the region to be inverted. Inversion of this region can happen automatically or manually, depending on the value placed in the man_invert and auto_invert register bits.

The Pattern Fill is achieved by writing to several registers. These include, DMA Region Registers (0x600-0x670), Pattern Configuration Registers (0x680-0x6B0), and Fill Configuration Register (0x6C0). The DMA Region Register set is used to set up the pixel array area to be filled with a pattern. It contains right and left column pixel positions, and top and bottom pixel positions. The Pattern Configuration Registers are where the pattern to be loaded into the region is set up. Finally, the Fill Configuration Register turns on or off the pattern fill. FIG. 13 illustrates how patterns are loaded into the array 1302 with and without the rotate pattern bit set.

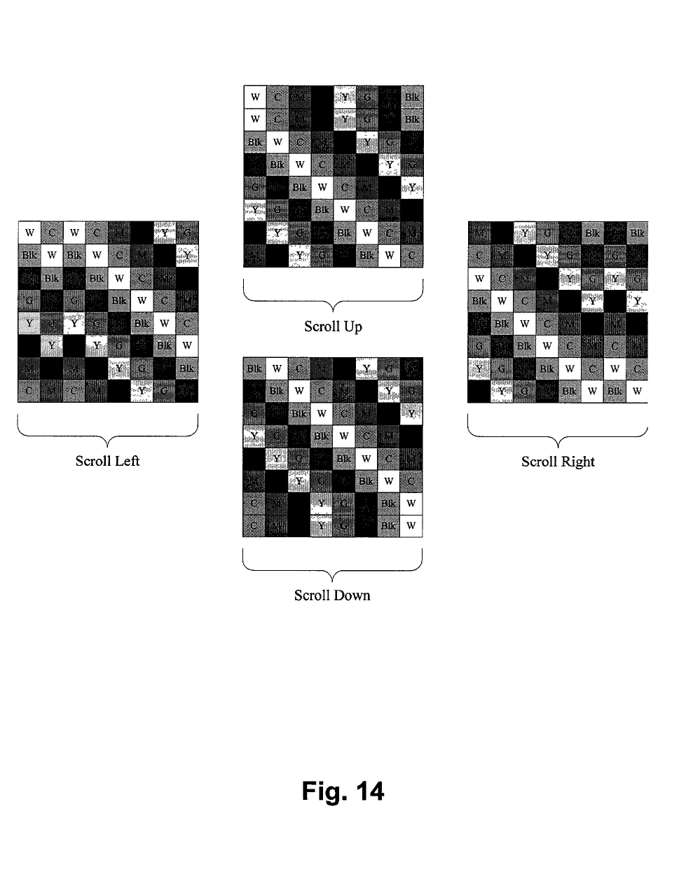

Scrolling can be accomplished by writing to the DMA Region Registers and the Scroll Configuration Register (0x6D0). Once the DMA region is specified, the Scroll Configuration Register is used to specify the direction of scrolling and enable scrolling. FIG. 14 demonstrates how data is moved relative to the scroll direction.

Self-test is a feature that allows the host system to check the integrity of the Display System pixel array automatically. The registers associated with self-test are located between addresses 0x6E0 to 0x7F0. The self-test is started, stopped, and paused by writing to the register bits at 0x6E0. If the Display System has any defective pixels in the array, the register at 0x6F0 will contain the number of failed pixels. The rest of the registers from 0x700-0x7F0 contain details about failed pixels, such as column and row position.

TABLE 13
DMA Control Registers

| Addr | Bits | Init | Name | Description |
|---|---|---|---|---|
| 0x600 | | | | |
| | 7:0 | 00 | dma_left_col[7:0] | Lowest order 8 bits of address of left |
| | | | | column for scroll, pattern fill, and self-test |
| | | | | operations. Lowest bit, dma_left_col[0], is |
| | | | | read only and always returns ‘0’. |
| 0x610 | | | | |
| | 1:0 | 0 | dma_left_col[9:8] | Highest order 2 bits of address of left |
| | | | | column for scroll, pattern fill, and self-test |
| | | | | operations. |
| 0x620 | | | | |
| | 7:0 | 1F | dma_right_col[7:0] | Lowest order 8 bits of address of right |
| | | | | column for scroll, pattern fill, and self-test |
| | | | | operations. Lowest bit, dma_right_col[0], |
| | | | | is read only and always returns ‘1’. |
| 0x630 | | | | |
| | 1:0 | 3 | dma_right_col[9:8] | Highest order 2 bits of address of right |
| | | | | column for scroll, pattern fill, and self-test |
| | | | | operations. |
| 0x640 | | | | |
| | 7:0 | 00 | dma_top_row[7:0] | Lowest order 8 bits of address of top row |
| | | | | for scroll, pattern fill, and self-test |
| | | | | operations. |
| 0x650 | | | | |
| | 1:0 | 0 | dma_top_row[9:8] | Highest order 2 bits of address of top row |
| | | | | for scroll, pattern fill, and self-test |
| | | | | operations. |
| 0x660 | | | | |
| | 7:0 | 57 | dma_bottom_row | Lowest order 8 bits of address of bottom |
| | | | [7:0] | row for scroll, pattern fill, and self-test |
| | | | | operations. |
| 0x670 | | | | |
| | 1:0 | 2 | dma_bottom_row | Highest order 2 bits of address of bottom |
| | | | [9:8] | row for scroll, pattern fill, and self-test |
| | | | | operations. |
| 0x680 | | | | |
| | 7:0 | 55 | red_pattern[7:0] | Pattern for red data (plane 0) during |
| | | | | pattern fill and self-test operations. |
| 0x690 | | | | |
| | 7:0 | AA | green_pattern[7:0] | Pattern for green data (plane 1) during |
| | | | | pattern fill and self-test operations. |
| 0x6A0 | | | | |
| | 7:0 | 55 | blue_pattern[7:0] | Pattern for blue data (plane 2) during |
| | | | | pattern fill and self-test operations. |
| 0x6B0 | | | | |
| | 0 | 1 | pattern_rotate | Pattern rotate. Enter ‘1’ to rotate the red, |
| | | | | green, and blue patterns by a number of |
| | | | | bits each equal to the row number modulo |
| | | | | 8. |
| 0x6C0 | | | | |
| | 0 | 0 | fill_enable | Pattern fill enable. A rising edge on this |
| | | | | bit initiates a pattern fill. |
| 0x6D0 | | | | |
| | 2 | 0 | scroll_enable | Scroll enable. A rising edge on this bit |
| | | | | initiates a scroll. |
| | 1:0 | 0 | scroll_direction | Scroll direction. Enter ‘0’ to scroll |
| | | | | upward, ‘1’ to scroll downward, ‘2’ to |
| | | | | scroll left, and ‘3’ to scroll right. |
| 0x6E0 | | | | |
| | 1 | 0 | self-test_enable | Self-test enable. A rising edge on this bit |
| | | | | initiates a self-test. |
| | 0 | 0 | self-test_pause | Self-test pause. A ‘1’ on this bit pauses |
| | | | | the self-test between the writing and |
| | | | | checking stages. Other than for |
| | | | | diagnostics, this bit should in general be |
| | | | | left at ‘0’. |
| 0x6F0 | | | | |
| | 7:0 | 0 | nerr | Total number of failing pixels, up to a |
| | | | | maximum of 255, detected by the self- |
| | | | | test. |
| 0x700 | | | | |
| | 7:6 | 0 | bad_word_col[0] | Bits [7:6] of the starting column address |
| | | | [7:6] | of bad_word [0]. |
| | 5:0 | 0 | bad_word_nerr[0] | Number of bad pixels, up to a maximum |
| | | | | of 63, in bad_word[0], where |
| | | | | bad_word[0] is the first pixel word found |
| | | | | to have failing pixels. If there is no |
| | | | | bad_word[0], then bad_word_nerr[0] = 0. |
| 0x710 | | | | |
| | 1:0 | 0 | bad_word_col | Highest order 2 bits of the starting column |
| | | | [0] [9:8] | address of bad_word [0]. |
| 0x720 | | | | |
| | 7:0 | 0 | bad_word_row [0] | Lowest order 8 bits of the row address of |
| | | | [7:0] | bad_word[0]. |
| 0x730 | | | | |
| | 1:0 | 0 | bad_word_row[0] | Highest order 2 bits of the row address of |
| | | | [9:8] | bad_word[0]. |
| 0x740 | | | | |
| | 7:6 | 0 | bad_word_col[1] | Analogous to bad_word_col[0] [7:6]. |
| | | | [7:6] | |
| | 5:0 | 0 | bad_word_nerr[1] | Analogous to bad_word_nerr[0]. |
| 0x750 | | | | |
| | 1:0 | 0 | bad_word_col | Analogous to bad_word_col[0] [9:8]. |
| | | | [1] [9:8] | |
| 0x760 | | | | |
| | 7:0 | 0 | bad_word_row[1] | Analogous to bad_word_row[0] [7:0]. |
| | | | [7:0] | |
| 0x770 | | | | |
| | 1:0 | 0 | bad_word_row[1] | Analogous to bad_word_row[0] [9:8]. |
| | | | [9:8] | |
| 0x780 | | | | |
| | 7:6 | 0 | bad_word_col[2] | Analogous to bad_word_col[0] [7:6]. |
| | | | [7.6] | |
| | 5:0 | 0 | bad_word_nerr[2] | Analogous to bad_word_nerr[0]. |
| 0x790 | | | | |
| | 1:0 | 0 | bad_word_col | Analogous to bad_word_col[0] [9:8]. |
| | | | [2] [9:8] | |
| 0x7A0 | | | | |
| | 7:0 | 0 | bad_word_row[2] | Analogous to bad_word_row[0] [7:0]. |
| | | | [7.0] | |
| 0x7B0 | | | | |
| | 1:0 | 0 | bad_word_row[2] | Analogous to bad_word_row[0] [9:8]. |
| | | | [9.8] | |
| 0x7C0 | | | | |
| | 7:6 | 0 | bad_word_col[3] | Analogous to bad_word_col[0] [7:6]. |
| | | | [7:6] | |
| | 5.0 | 0 | bad_word_nerr[3] | Analogous to bad_word_nerr[0]. |
| 0x7D0 | | | | |
| | 1:0 | 0 | bad_word_col | Analogous to bad_word_col[0] [9:8]. |
| | | | [3] [9.8] | |
| 0x7E0 | | | | |
| | 7:0 | 0 | bad_word_row[3] | Analogous to bad_word_row[0] [7:0]. |
| | | | [7:0] | |
| 0x7F0 | | | | |
| | 1:0 | 0 | bad_word_row[3] | Analogous to bad_word_row[0] [9:8]. |
| | | | [9:8] | |

### Electrical Characteristics—Basic Chip Parameters

The table below gives the basic chip parameters for the Backplane IC.

TABLE 14
Basic Chip Parameters

| Parameter | Value | Units | Notes |
|---|---|---|---|
| Technology | 0.35 | um | Single-poly, quad-metal, salicide |
| | | | process. |
| Maximum | 66 | MHz | Internal operating clock |
| Operating | | | identical to system bus clock. |
| Frequency | | | |
| Maximum | 3.6 | V | Voltage on individual pixels |
| Operating | | | alternates between ground and |
| Voltage | | | operating voltage. Voltage on |
| | | | ITO driven independently. |
| Minimum | 2.7 | V | 3V Battery operation supported. |
| Operating | | | |
| Voltage | | | |
| Minimum | 0 | C. | |
| Operating | | | |
| Temperature | | | |
| Maximum | 70 | C. | |
| Operating | | | |
| Temperature | | | |
| Dimensions | 12.9 × 9.6 | (mm)\hat{ }2 | |
| Resolution | SVGA | | 800 × 600 Pixels. |
| Pixel Type | SRAM | | |
| Pixel Depth | 3 | Bits | |
| Maximum | 30/100 | mW | Power miser mode / color rich mode. |
| Operating | | | Color rich mode value does not |
| Power | | | include additional power consumed |
| | | | by an external frame buffer. |
| | | | Illumination power excluded in |
| | | | both cases. |

### Color Rich Display Controller (CRASIC)

### Description

The Color Rich Display Controller serves as the external frame buffer controller and system interface for the Microdisplay. It receives image data from a microprocessor or other external host, reformats the data, and transmits the data to the Backplane IC of the Display Module. The Backplane IC maps the data onto an 800 by 600 (SVGA) Liquid Crystal on Silicon display. The Color Rich Display Controller controls the transfer of the frame buffer data to the display, providing an enhanced color rich image that is illuminated with the help of the Analog Controller, and the LEDs.

### Features

66 MHZ synchronous interface to host processor.

3.3V I/Os

2.5V Core power

Implemented in 0.25 u cmos

304 pin BGA package

Awake/Active/Dormant and Sleep power saving modes

Host MPU to MicroDisplay, Analog Controller and SDRAM

### System Interface and Timing

### Pin Description

Tables 15-22 set forth pin assignments and pin descriptions.

TABLE 15
COLOR RICH CONTROLLER Pinout

| Pin | Description | Pin | Description |
|---|---|---|---|
| 1 | CR_DD[28] | 153 | FORCE1 |
| 2 | CR_DD[27] | 154 | PLL_LOCK |
| 3 | CR_DD[22] | 155 | CR_DA[4] |
| 4 | CR_DD[14] | 156 | OS_rdceBN |
| 5 | TCK | 157 | OS_rdyBN |
| 6 | MST | 158 | OS_wrN |
| 7 | MMS2 | 159 | SDI3 |
| 8 | SDO1 | 160 | AIC_clkA |
| 9 | SDO6 | 161 | AIC_clkB |
| 10 | SDO3 | 162 | CR_DD[23] |
| 11 | CR_MD[24] | 163 | CR_DD[15] |
| 12 | CR_MD[25] | 164 | CR_DD[9] |
| 13 | CR_MD[26] | 165 | CR_DD[16] |
| 14 | CR_MD[27] | 166 | CR_DD[17] |
| 15 | CR_MD[28] | 167 | CR_DD[18] |
| 16 | CR_MD[29] | 168 | CR_DD[13] |
| 17 | CR_MD[30] | 169 | CR_DD[6] |
| 18 | CR_MD[31] | 170 | CR_DD[0] |
| 19 | CR_MD[19] | 171 | CR_mcs0N |
| 20 | CR_MD[15] | 172 | spare2 |
| 21 | CR_MD[16] | 173 | TRST |
| 22 | CR_MD[17] | 174 | MMS1 |
| 23 | spare4 | 175 | RESETN |
| 24 | OGPIO_0 | 176 | SDO5 |
| 25 | CR_MA[7] | 177 | CR_MD[4] |
| 26 | CR_MA[1] | 178 | CR_MD[5] |
| 27 | CR_MA[5] | 179 | CR_MD[6] |
| 28 | CR_casN | 180 | CR_MD[7] |
| 29 | CR_dqm[2] | 181 | CR_MD[8] |
| 30 | SDI7 | 182 | CR_MD[9] |
| 31 | ABRD_WRN | 183 | CR_MA[12] |
| 32 | SDI5 | 184 | CR_mcke |
| 33 | NANDOEN | 185 | CR_MD[0] |
| 34 | TDO | 186 | CR_MD[1] |
| 35 | CODEC_DATO | 187 | spare7 |
| 36 | PCDBN | 188 | CR_MA[10] |
| 37 | ACE2N | 189 | CR_MA[3] |
| 38 | PIORN | 190 | CR_rasN |
| 39 | PCDAN | 191 | CR_dqm[3] |
| 40 | PWAITN | 192 | CR_dqm[0] |
| 41 | IOIS16N | 193 | ACD2N |
| 42 | IGPIO_0 | 194 | BCD1N |
| 43 | D[9] | 195 | BCD2N |
| 44 | D[12] | 196 | CODEC_BCLK |
| 45 | D[7] | 197 | NANDWEN |
| 46 | I2C_data | 198 | BWP_IO16N |
| 47 | D[5] | 199 | SCLK_C |
| 48 | D[10] | 200 | PSKTSEL |
| 49 | D[4] | 201 | PCE2N |
| 50 | D[24] | 202 | ACD1N |
| 51 | D[3] | 203 | BWAITN |
| 52 | D[23] | 204 | D[13] |
| 53 | D[1] | 205 | D[20] |
| 54 | D[14] | 206 | D[18] |
| 55 | OEN | 207 | OGPIO_3 |
| 56 | A[7] | 208 | WEN |
| 57 | A[2] | 209 | D[16] |
| 58 | A[21] | 210 | D[15] |
| 59 | sirqN | 211 | D[30] |
| 60 | A[11] | 212 | D[28] |
| 61 | A[17] | 213 | D[27] |
| 62 | A[23] | 214 | A[14] |
| 63 | A[20] | 215 | SDCLK |
| 64 | TPD | 216 | spare8 |
| 65 | OS_powerN | 217 | A[15] |
| 66 | OS_power | 218 | A[3] |
| 67 | SDI | 219 | A[16] |
| 68 | XTST | 220 | A[5] |
| 69 | OS_irqAN | 221 | A[13] |
| 70 | XTCK | 222 | A[6] |
| 71 | AIC_csBN | 223 | SDO |
| 72 | OS_csBN | 224 | FORCEZ |
| 73 | AIC_csAN | 225 | CLKCTL |
| 74 | CR_DA[5] | 226 | FORCE0 |
| 75 | OS_rdceAN | 227 | PLL_OUT |
| 76 | OS_irqBN | 228 | CR_DA[2] |
| 77 | OS_rstN | 229 | OS_rdyAN |
| 78 | SDI4 | 230 | CR_DA[0] |
| 79 | CR_DA[7] | 231 | CR_DA[3] |
| 80 | OS_clkB | 232 | SDI2 |
| 81 | OS_clkA | 233 | CR_DA[6] |
| 82 | CR_DD[24] | 234 | SDI1 |
| 83 | CR_DD[29] | 235 | CR_DD[2] |
| 84 | CR_DD[30] | 236 | CR_DD[8] |
| 85 | CR_DD[31] | 237 | CR_DD[3] |
| 86 | CR_DD[25] | 238 | CR_DD[10] |
| 87 | CR_DD[19] | 239 | CR_DD[11] |
| 88 | CR_DD[26] | 240 | CR_DD[12] |
| 89 | CR_DD[21] | 241 | CR_DD[5] |
| 90 | CR_DD[20] | 242 | DE |
| 91 | CR_DD[1] | 243 | VSS |
| 92 | spare3 | 244 | VDDL |
| 93 | TMS | 245 | SMCK |
| 94 | MMS0 | 246 | VSS |
| 95 | MMS3 | 247 | VDDH |
| 96 | SDO7 | 248 | err_crasic |
| 97 | SDO4 | 249 | VSS |
| 98 | CR_MD[20] | 250 | VDDL |
| 99 | CR_MD[21] | 251 | SDO2 |
| 100 | CR_MD[22] | 252 | VSS |
| 101 | CR_MD[23] | 253 | VDDH |
| 102 | CR_MD[10] | 254 | CR_MA[8] |
| 103 | CR_MD[11] | 255 | VSS |
| 104 | CR_MD[12] | 256 | VDDL |
| 105 | CR_MD[13] | 257 | CR_MA[9] |
| 106 | CR_MD[14] | 258 | CR_MA[2] |
| 107 | CR_MD[18] | 259 | VSS |
| 108 | CR_MD[2] | 260 | VDDL |
| 109 | CR_MD[3] | 261 | CR_dqm[1] |
| 110 | CR_MA[6] | 262 | VSS |
| 111 | CR_MA[11] | 263 | VDDH |
| 112 | CR_MA[4] | 264 | CODEC_DATI |
| 113 | CR_MA[0] | 265 | VSS |
| 114 | CR_mwrN | 266 | VDDL |
| 115 | CR_mclk | 267 | SFRM_C |
| 116 | SDI6 | 268 | VSS |
| 117 | IGPIO_1 | 269 | VDDH |
| 118 | CS3N | 270 | PCE1N |
| 119 | AWP_IO16N | 271 | VSS |
| 120 | CODEC_WS | 272 | VDDL |
| 121 | BCE1N | 273 | D[19] |
| 122 | AWAITN | 274 | D[26] |
| 123 | POEN | 275 | VSS |
| 124 | CF_PWR_ONN | 276 | VDDL |
| 125 | ACE1N | 277 | GPIO_2 |
| 126 | ABCE1N | 278 | VSS |
| 127 | D[8] | 279 | VDDH |
| 128 | D[21] | 280 | CS5N |
| 129 | D[6] | 281 | VSS |
| 130 | D[11] | 282 | VDDL |
| 131 | D[25] | 283 | A[8] |
| 132 | D[17] | 284 | VSS |
| 133 | D[31] | 284 | VSS |
| 134 | D[2] | 285 | — |
| 135 | D[29] | 286 | A[10] |
| 136 | D[0] | 287 | VSS |
| 137 | D[22] | 288 | VDDL |
| 138 | A[19] | 289 | TDI |
| 139 | RDY | 290 | PLL_CLK_IN |
| 140 | vss | 291 | VSS |
| 141 | A[9] | 292 | VDDL |
| 142 | A[22] | 293 | CR_DA[1] |
| 143 | A[4] | 295 | VDDH |
| 144 | A[12] | 296 | CR_DD[7] |
| 145 | A[18] | 297 | VSS |
| 146 | 12C_clk | 298 | VDDL |
| 147 | TPC | 299 | OS_csAN |
| 148 | BCE2N | 300 | VSS |
| 149 | ABCE2N | 301 | VDDH |
| 150 | XSM | 302 | CR_DD[4] |
| 151 | spare1 | 303 | VSS |
| 152 | OGPIO_1 | 304 | VDDL |

TABLE 16
System Interface Pins

| Name | Direction | Description |
|---|---|---|
| RESETN | Input | System reset. |
| SIRQN | Output | System interrupt request |
| OEN | Input | System read. Active low |
| WEN | Input | System write. Active low. |
| CS4N | Input | System chip select. Active low |
| CS5N | Input | System chip select. Active low |
| RDY | Input | System ready |
| A[23:0] | Input | System address. |
| D[31:0] | Bi- | System data. |
| | directional | |
| SDCLK | Input | System clock. |

TABLE 17
SDRAM Interface Pins

| Name | Direction | Description |
|---|---|---|
| CR_MA[10:0] | Output | Memory address bus. Multiplexed row |
| | | and column address. Row addresses use |
| | | MA[10:0]. Column addresses use |
| | | MA[7:0]. Note that MA[10] is |
| | | a control signal during column address |
| | | strobing. |
| CR_MD[31:0] | Bi- | Memory data bus |
| | directional | |
| CR_MCLK | Output | Memory clock. |
| CR_RASN | Output | Row address strobe. Latches row |
| | | addresses on the positive edge |
| | | of mclk with mrasN low. |
| CR_CASN | Output | Column address strobe. Latches column |
| | | addresses on the positive edge of |
| | | mclk when low. |
| CR_MWRN | Output | Memory write enable. Enables write |
| | | operation and row precharge. Latches |
| | | data in starting from casN and mwrN |
| | | low. |
| CR_DQM[3:0] | Output | Data input/output masks by byte. Serves |
| | | as the byte enables on writes |
| CR_MCKE | Output | Memory clock enable. Used to enable |
| | | auto refresh during sleep mode. |
| mcsN | Output | Chip select. Always active following |
| | | initial 100 us wait on power on. |
| | | Active low. |

TABLE 18
Interface Pins

| Name | Direction | Description |
|---|---|---|
| CR_DA[7:0] | Output | Display address. |
| CR_DD[31:0] | Bi- | Display data. |
| | directional | |
| AIC_CSAN | Output | Chip select for first Analog Controller. |
| | | Active low. |
| AIC_CSBN | Output | Chip select for second Analog Controller. |
| | | Active low. |
| AIC_CLKA | Output | Clock for first Analog Controller. |
| AIC_CLKB | Output | Clock for second Analog Controller. |
| OS_CSAN | Output | Chip select for first Backplane. Active |
| | | low. |
| OS_CSBN | Output | Chip select for second Backplane. Active |
| | | low. |
| OS_CLKA | Output | Display clock for first Backplane. |
| OS_CLKB | Output | Display clock for second Backplane. |
| OS_IRQAN | Input | Display interrupt request for first Back- |
| | | plane. Active low. |
| OS_IRQBN | Input | Display interrupt request for second Back- |
| | | plane. Active low |
| OS_RESETN | Output | Backplane reset. Active low. |
| OS_RDCEAN | Input | First Backplane read data clock enable. |
| | | Active low. |
| OS_RDCEBN | Input | Second Backplane read data clock enable. |
| | | Active low. |
| OS_RDYAN | Input | First Backplane ready. Active low. |
| OS_RDYBN | Input | Second Backplane ready. Active low. |
| OS_WRN | Output | Shared write for both Analog Controllers |
| | | and Backplanes Active low. |
| OS_POWER | Output | |
| OS_POWERN | Output | |

TABLE 19
Serial Interface Pins

| Name | Direction | Description |
|---|---|---|
| SB_CLK | Output | Serial clock. Should be connected to a |
| | | pull-up resistor. |
| SB_DATA | Bi- | Serial data. Must be connected to a |
| | directional | pull-up resistor. |

TABLE 20
Tap Control Pins

| Name | Direction | Description |
|---|---|---|
| TPC | Input | Tap clock. |
| TPD | Input | Tap data. |

TABLE 21
Test Pins

| Name | Direction | Description |
|---|---|---|
| TCK | Input | Boundary Scan TAP controller clock |
| TMS | Input | Boundary Scan Setting of condition for TAP |
| | | controller |
| TRST | Input | Boundary Scan Reset for Tap controller |
| TDI | Input | Input of scan data of BSR and IR |
| TDO | Output | Output of scan data of BSR and IR |
| XTST | Input | Setting of LSI testing condition |
| XSM | Input | Setting of scan shift condition in LSI |
| | | test mode |
| XTCK | Input | Test clock input |
| SDI | Input | Data input for scan chain |
| SDI[1:7] | Input | Additional inputs for scan chain |
| SDO | Output | Data output for scan chain |
| SDO[1:7] | Output | Additional outputs for scan chain |
| MST | Input | Setting of memory unit testing condition |
| SMACK | Input | Mode clock for RAM unit testing |
| MMS0-4 | Input | Selection of memory macro for testing. |
| FORCE0 | Input | Force all outputs to 0 for testing |
| FORCE1 | Input | Force all outputs to 1 for testing |
| FORCEZ | Input | Force all outputs to Z for testing. |

TABLE 22
PLL Pins

| Name | Direction | Description |
|---|---|---|
| PLL_CLKI | Input | 3.6 MHZ input to multiply to 68.4 for internal |
| N | | core frequency |
| PLL_RST | Input | PLL reset |
| PLL_OUT | Output | PLL_CLOCK output for debug. |
| PLL_LOCK | Output | Signal indicating PLL is locked. High indicates |
| | | Locked PLL |
| CLKCTL | Input | Clock input bypass for PLL. |
| PLL_SEL | Input | Low will select the PLL BYPASS as |
| | | input clock. |
| PLLVDD | Input | Analog VDD for PLL |
| PLLGND | Input | Analog GND for PLL |

### Color Rich Display Controller Configuration

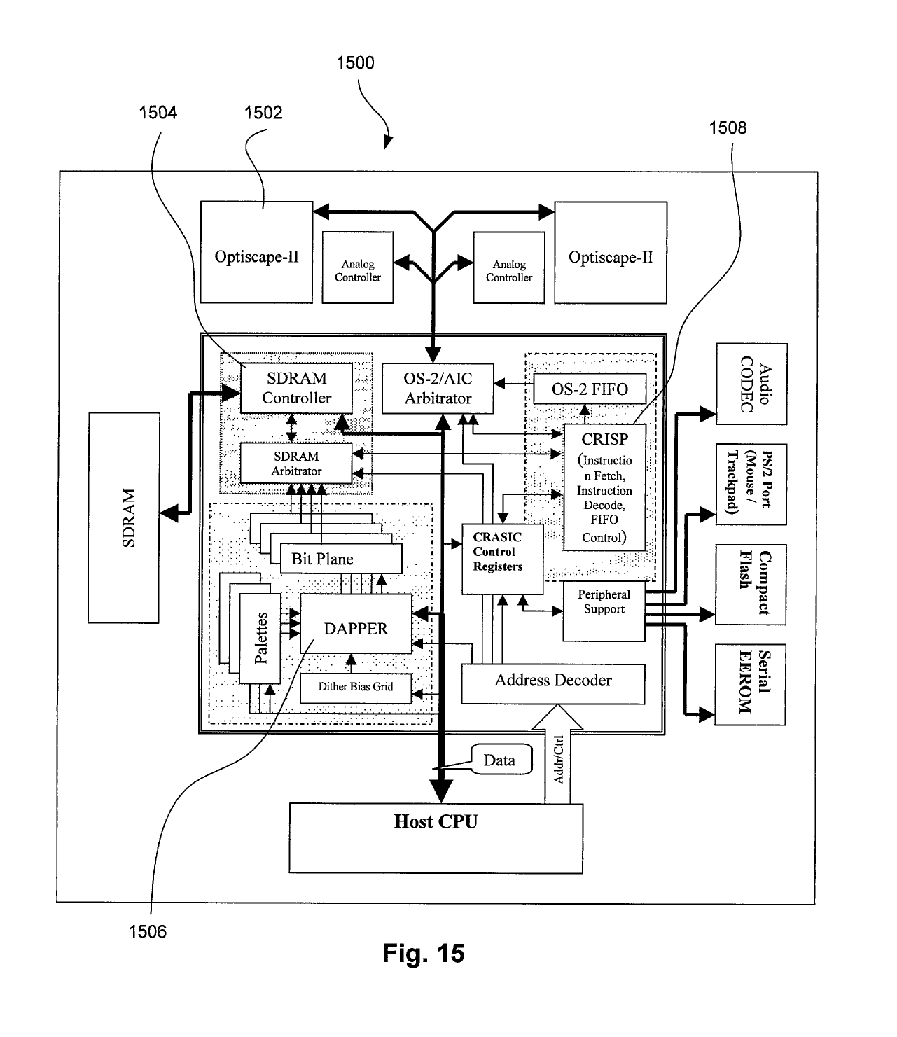

FIG. 15 is a block diagram that shows the system components of an embodiment of the Microdisplay 1500. The Color Rich Display Controller can support up to two Display Modules 1502.

The Color Rich Display Controller [CRASIC] is comprised of three major subsystems and peripheral GLU (primarily intended for an SA1110 host processor).

1. SDRAM Controller 1504. The SDRAM section arbitrates access to the SDRAM for DAPPER, CRISP, and a host CPU. It also takes care of SDRAM refresh.

2. DAPPER 1506. The “Dithering and Planarization Process Engine & Router,” converts incoming 8-bit/pixel data into the 24-bit color space, then dithers down to 9, 12, or 15 “Bit Planes”. The dithering process attempts to preserve general 24-bit color depth by sacrificing absolute spatial resolution, e.g., adjusting the color of adjacent bits to give an overall illusion that color has been preserved.

3. CRISP 1508 is a very limited, but highly programmable, processor that manages timing and data transfers to the MicroDisplay(s) to produce images. The CRISP may, in its full implementation, also take care of tasks such as Cursor management, LC temperature compensation, and stereo audio. See the section on the CRISP, below.

The peripheral GLU includes a PS/2 port, supplemental logic for Compact Flash slots, and Serial device bus master.

### Configuration Registers

The external interface for the Color Rich Display Controller provides the means for a host processor to access the entire contents of the SDRAM, MicroDisplay(s) registers and memory, and Analog Controller(s) registers. These devices, along with Color Rich Display Controller own registers, are arranged into a unified memory map.

The host processor may be interfaced using the full 22-bit address bus, allowing direct access to the entire map. For applications where fewer address lines are desirable, just 13 address lines may be used. In this case, device registers are fully addressable and SDRAM is accessed indirectly through the use of an auto-increment pointer register (see Addressing_Control register definition).

TABLE 23
CRASIC Address Map

| Address | | |
|---|---|---|
| Range | Device Name | Description |
| 0x000000 | SDRAM | Must be at least 512K to support “Color |
| through | | Rich”, but can be as large as 8 Mb. Used |
| 0x7FFFFF | | for display buffers, cursors, palettes, etc. |
| 0x800000 | MicroDisplay memory | Organization of memory depends on |
| through | [Right Device] | MicroDisplay mode. |
| 0x8FFFFF | | |
| 0x900000 | MicroDisplay display | Organization of memory depends on |
| through | [Left Device] | MicroDisplay mode. |
| 0x9FFFFF | | |
| 0xA00000 | MicroDisplay display | Organization of memory depends on |
| through | [Both Devices - | MicroDisplay mode. |
| 0xAFFFFF | Write Only] | |
| 0xB00000 | Auxiliary device | This is undefined at this time. It might be |
| through | | used for audio, or as a high-speed data |
| 0xB7FFFF | | transport device, such as Fire-Wire, that |
| | | could benefit from CRISP's DMA |
| | | capabilities. Note: at the very least, we |
| | | ought to have an external chip enable and |
| | | ready line associated with this “device”. |
| | | It could be serviced by MicroDisplay |
| | | memory FIFO, using all the same signals. |
| 0xB80000 | DAPPER Color Palette | All 256 locations are used to hold the |
| through | (8-bit to 24-bit | palette. These registers are write-only. |
| 0xFFFFFF | Lookup Table) | |
| 0xC00000 | Analog Controller | Up to 256 8-bit registers. Registers |
| through | registers [Left | appear in least significant byte of 32-bit |
| 0xC7FFFF | Device] | word access. |
| 0xC80000 | MicroDisplay | Up to 256 8-bit registers. Registers |
| through | registers [Left | appear in least significant byte of 32-bit |
| 0xCFFFFF | Device] | word access. |
| 0xD00000 | Analog Controller | Up to 256 8-bit registers. Registers |
| through | registers [Right | appear in least significant byte of 32-bit |
| 0xD7FFFF | Device] | word access. |
| 0xD80000 | MicroDisplay | Up to 256 8-bit registers. Registers |
| through | registers [Right | appear in least significant byte of 32-bit |
| 0xDFFFFF | Device] | word access. |
| 0xE00000 | Analog Controller | Up to 256 8-bit registers. Registers |
| through | registers [Both | appear in least significant byte of 32-bit |
| 0xE7FFFF | Devices - Write | word access. |
| | Only] | |
| 0xE80000 | MicroDisplay | Up to 256 8-bit registers. Registers |
| through | registers [Both | appear in least significant byte of 32-bit |
| 0xEFFFFF | Devices - Write | word access. |
| | Only] | |
| 0xF00000 | CRISP and DAPPER | Up to 256 registers. Registers may be up |
| through | registers | to 32-bits. While primarily used by |
| 0xF7FFFF | | CRISP, these registers are fully visible to |
| | | the Host processor. |
| 0xF80000 | CRASIC External | These are always readily accessible to the |
| through | interface and GLU | host processor. They are only accessible |
| 0xBFFFFF | peripheral registers | to CRISP through Data Transfer |
| | | operations such as the MOV instruction. |

### 0xB80xxx DAPPER Registers

TABLE 24
(24-bit) - Palette (Color Lookup Table)

| Addr | Bits | Init | Name | Description |
|---|---|---|---|---|
| 0x000 | | | Palette[00] | |
| | 23:16 | | Blue_Lookup_00 | Blue value for 8-bit pixel equal to 0x00 |
| | | | | (write only) |
| | 15:8 | | Green_Lookup_00 | Green value for 8-bit pixel equal to 0x00 |
| | | | | (write only) |
| | 7:0 | | Red_Lookup_00 | Red value for 8-bit pixel equal to 0x00 |
| | | | | (write only) |
| 0x004 | | | Palette[02] | |
| | 23:0 | | RGB_Lookup_01 | Same as Palette[00] except for pixel |
| | | | | equal to 0x01 |
| 0x008 | . . . | | Palette[02] | |
| | 23:0 | | RGB_Lookup_02 | Same as Palette[00] except for pixel |
| | | | | equal to 0x02 |
| 0x00C | . . . | | Palette[03] | . . . |
| 0x010 | . . . | | Palette[04] | . . . |
| . . . | . . . | | . . . | . . . |
| . . . | . . . | | . . . | . . . |
| 0x3F0 | . . . | | Palette[FC] | . . . |
| 0x3F4 | . . . | | Palette[FD] | |
| | 23:0 | | RGB_Lookup_FD | Same as Palette[0] except for pixel equal |
| | | | | to 0xFD |
| 0x3F8 | | | Palette[FE] | |
| | 23:0 | | RGB_Lookup_FE | Same as Palette[0] except for pixel equal |
| | | | | to 0xFE |
| 0x3FC | | | Palette[FF] | |
| | 23:0 | | RGB_Lookup_FF | Same as Palette[0] except for pixel equal |
| | | | | to 0xFF |

Note
The above registers are addressable by CRISP via Data Transfer Operations, primarily MOV instruction.

### 0xC00xxx, 0xD00xxx Analog Controller Registers

See the section entitled Analog Controller, below

### 0xC00xxx, 0xD80xxx Display Registers

See the section on Display Registers, above.

### 0xF00xxx CRISP Registers

TABLE 25
(8-bit) - Device Control and Status

| Addr | Bits | Init | Name | Description |
|---|---|---|---|---|
| 0x000 | | | DevCon | Device Control Register. |
| | 7 | | GPDD_3 | GPIO 3 Data Direction 1 = Output |
| | 6 | | GPDD_2 | GPIO 2 Data Direction 1 = Output |
| | 5 | | GPDD_1 | GPIO 1 Data Direction 1 = Output |
| | 4 | | GPDD_0 | GPIO 0 Data Direction 1 = Output |
| | 3 | | DBT | Bus clock: 0 = SysClk/2, 1 = SysClk/3 |
| | 2 | | CLK | Clock Enable for Bus Devices |
| | 1 | | RST | Reset Control for Bus Devices |
| | 0 | | PWR | Power Enable for Bus Devices |
| 0x004 | | | AuxCon | |
| | 7 | | GPI0_3 | General Purpose I/O 3 |
| | 6 | | GPIO_2 | General Purpose I/O 2 |
| | 5 | | GPIO_1 | General Purpose I/O 1 |
| | 4 | | GPIO_0 | General Purpose I/O 0 |
| | 3 | | WDRUN | Watch-Dog/Timer Run |
| | 2 | | WDENBL | WatchDog Abort Enable Abort - time out |
| | | | | causes abort and sets WD IRQ to host, if |
| | | | | enabled. When this bit is false the |
| | | | | WatchDog Status is mapped to AUX cc, |
| | | | | allowing WD as a general purpose |
| | | | | program timer |
| | 1 | | AIC_RST | Reset Control for Analog Controller - if |
| | | | | dual Displays are used, this signal may be |
| | | | | used for both Analog Controllers |
| | 0 | | AIC_PWR | Power Enable for Analog Controller - if |
| | | | | dual Displays are used, this signal may be |
| | | | | used for both Analog Controllers. |
| 0x008 | | | ConStat | |
| | 7 | | DGPC_2 | When a 1 is written, General Purpose |
| | | | | Counter_2 is decremented |
| | 6 | | DGPC_1 | When a 1 is written, General Purpose |
| | | | | Counter_1 is decremented. |
| | 5 | | ZGPC_2 | When General Purpose Counter_2 = 0, |
| | | | | this register is set to “1”. |
| | 4 | | ZGPC_1 | When General Purpose Counter_1 = 0, |
| | | | | this register is set to “1”. |
| | 3 | | WDTO | WatchDog Timer Timed Out (This signal |
| | | | | may or may not be assigned an external |
| | | | | CRASIC pin. It may be cleared by writing |
| | | | | to the WDCNT register.) |
| | 2 | | CIRQ | CRASIC Interrupt line level |
| | 1 | | OIRQ_2 | MicroDisplay Interrupt line level [Right] |
| | 0 | | OIRQ_1 | MicroDisplay Interrupt line level [Left] |
| 0x00C | | | WDCnt | WatchDog Timer |
| | 7:0 | | WDCnt | The WatchDog/Timer count is an 8 bit |
| | | | | register whose value is transferred to a |
| | | | | countdown counter each time a CRISP |
| | | | | instruction with WDR = True is executed, |
| | | | | or when this register is written. |

Note
The above 8-bit registers are also addressable with CRISP immediate instructions.

### 0xF00xxx ISP Registers

TABLE 26
(8-bit) - Semaphore Registers

| Addr | Bits | Init | Name | Description |
|---|---|---|---|---|
| 0x010 | | | SEM_0 | Semaphore Register 0 |
| | 7:0 | | SEM_0 | Each bit may be read or written by either |
| | | | | the Host Processor or CRISP through |
| | | | | SEMx registers. |
| 0x014 | | | SEM_1 | Semaphore Register 0 |
| | 7:0 | | SEM_1 | Each bit may be read or written by either |
| | | | | the Host Processor or CRISP through |
| | | | | SEMx registers. |
| 0x018 | | | SEM_2 | Semaphore Register 0 |
| | 7:0 | | SEM_2 | Each bit may be read or written by either |
| | | | | the Host Processor or CRISP through |
| | | | | SEMx registers. |
| 0x01C | | | SEM_3 | Semaphore Register 0 |
| | 7:0 | | SEM_3 | Each bit may be read or written by either |
| | | | | the Host Processor or CRISP through |
| | | | | SEMx registers. |
| 0x020 | | | GP_Counter_1 | |
| | 7:0 | | GPC_1 | General purpose count-down counter |
| 0x024 | | | GP_Counter_2 | |
| | 7:0 | | GPC_2 | General purpose count-down counter |
| 0x028 | | | Reserved 8-bit | |
| . | | | | |
| . | | | | |
| . | | | | |
| 0x0FC | | | | |

Note
The above 8-bit registers are also addressable with CRISP immediate instructions.

### 0xF00xxx CRISP Registers

TABLE 27
(32-bit) - Data Processing

| Addr | Bits | Init | Name | Description |
|---|---|---|---|---|
| 0x100 | | | TranSourceStart | |
| | 31:0 | | *TSA | Transfer Start Address, used with Data |
| | | | | Transfer Operations (MOV, AND, ORR, |
| | | | | NOT and XOR instructions). Address |
| | | | | must be on a 32-bit boundary (23:2), but |
| | | | | all 32 bits may be used when the register |
| | | | | is used for ADD operations. |
| 0x104 | | | TranSourceEnd | |
| | 31:0 | | *TEA | Transfer End Address, used with Data |
| | | | | Transfer Operations (MOV, AND, ORR, |
| | | | | NOT and XOR instructions). This address |
| | | | | must be greater than, or equal to, TSA for |
| | | | | predictable operation. Address must be on |
| | | | | a 32-bit boundary (23:2), but all 32 bits |
| | | | | may be used when the register is used for |
| | | | | ADD operations. |
| 0x108 | | | TranDestination | |
| | 31:24 | | RowLen | This 8-bit value specifies the number of |
| | | | | 32-bit transfers for each row when the |
| | | | | destination is MicroDisplay memory (or |
| | | | | memories. It has no effect when |
| | | | | transferring to SDRAM or other devices. |
| | 23:2 | | TDA | Transfer Destination Address, used with |
| | | | | Data Transfer Operations (MOV, AND, |
| | | | | ORR, NOT and XOR instructions). |
| | | | | Address must be on a 32-bit boundary. |
| 0x10C | | | CrispPC Register | |
| | 22:2 | | CPC | This register holds the current program |
| | | | | counter of a CRISP program. When |
| | | | | CRISP writes to this register (LDR), it |
| | | | | effectively acts as a jump instruction. |
| | | | | Address must always be on a 32-bit |
| | | | | boundary, and it must be a valid SDRAM |
| | | | | address. |

Note
The above registers are also addressable by CRISP LDR, STR, and ADD* instructions.

### 0xF00xxx CRISP Registers

TABLE 28
(32-bit) - RESERVED

| Addr | Bits | Init | Name | Description |
|---|---|---|---|---|
| 0x110 | | | Reserved | |
| . | | | | |
| . | | | | |
| . | | | | |
| 0x1FC | | | | |

### 0xF00xxx DAPPER Registers

TABLE 29
(32-bit) - Control and Dither Grid

| Addr | Bits | Init | Name | Description |
|---|---|---|---|---|
| 0x200 | | | Dapper_Control | |
| | 7 | | Dapper_Enable | When set to “1” Dapper Enable directs all |
| | | | | transfers to SDRAM to be processed |
| | | | | through the DAPPER. Multiples of 32 |
| | | | | pixels, written to 32-pixel boundaries, are |
| | | | | required for Dapper to properly process |
| | | | | bit plane data through to SDRAM. Note: |
| | | | | This bit must be “0” when loading CRISP |
| | | | | programs and data to the SDRAM. |
| | 6 | | No_Original_Data | Original pixel data is not written to the |
| | | | | SDRAM when this bit is “1” only Dapper |
| | | | | processed bit-planes are written. This bit |
| | | | | is only valid when Dapper_Enable is “1” |
| | 5 | | Palette_Bypass | When this bit is “1”, the Palette (Color |
| | | | | Lookup Table) is bypassed and each 32- |
| | | | | bit write to SDRAM is treated as a single |
| | | | | 24-bit pixel. When this bit is “0”, 32-bit |
| | | | | data is treated as four 8-bit pixels to be |
| | | | | processed through the Palette. |
| | 4 | | FIFO_Reset | Writing a “1” to the Dapper FIFO Reset |
| | | | | causes the Dapper to reset the FIFO |
| | | | | without writing its content to SDRAM. |
| | | | | This bit should be toggled back to ‘0’ to |
| | | | | make the FIFO functional again. There is |
| | | | | no minimum time interval required |
| | | | | between bringing the bit to ‘1’ and back |
| | | | | to ‘0’. |
| | 3:0 | | Bit_Planes | Number of bit planes (−1) generated by |
| | | | | Dapper. Bit planes are generated R-msb, |
| | | | | G-msb, B-msb, and so on through to R- |
| | | | | lsb, G-lsb, and B-lsb. Up to 15 bit planes |
| | | | | may be generated corresponding to 5 bits |
| | | | | per color. |
| 0x204 | | | Plane_Base_Addr | |
| | 22:2 | | Plane_Base | The Plane Base register specifies the |
| | | | | address of the first “bit-plane” for Dapper |
| | | | | processed image data. |
| 0x208 | | | Plane_Length | |
| | 17:10 | | Plane_Len | Plane Length is specified in 1K |
| | | | | increments. |
| Ox20C | | | Reserved | |
| 0x210 | | | Grid_Bias_Row_0 | |
| | 23:16 | | Grid_Col_2 | This value is added to Row (mod (3)) = 0 |
| | | | | Column (mod (3)) = 2 8-bit color values |
| | | | | (R, G, & B) before the data is truncated |
| | | | | into N bit planes. This provides the |
| | | | | “Dither” dapper does . . . |
| | 15:8 | | Grid_Col_1 | This value is added to Row (mod (3)) = 0 |
| | | | | Column (mod (3)) = 1 8-bit color values |
| | | | | (R, G, & B) before the data is truncated |
| | | | | into N bit planes. This provides the |
| | | | | “Dither” dapper does . . . |
| | 7:0 | | Grid_Col_0 | This value is added to Row (mod (3)) = 0 |
| | | | | Column (mod (3)) = 0 8-bit color values |
| | | | | (R, G, & B) before the data is truncated |
| | | | | into N bit planes. This provides the |
| | | | | “Dither” dapper does . . . |
| 0x214 | | | Grid_Bias_Row_1 | |
| | 23:0 | | Grid_Col_2.0 | Same as Grid_Bias_Row_0, except values |
| | | | | are used for Row(mod(3)) = 1 data |
| 0x218 | | | Grid_Bias_Row_2 | |
| | 23:0 | | Grid_Col_2.0 | Same as Grid_Bias_Row_0, except values |
| | | | | are used for Row (mod (3)) = 2 data. |
| 0x21C | | | Reserved | |

Note
The above registers are addressable by CRISP via Data Transfer Operations, primarily MOV instruction.

### 0xF00xxx DAPPER Registers

TABLE 30
(32-bit) - Gamma Waveform Control

| Addr | Bits | Init | Name | Description |
|---|---|---|---|---|
| 0x220 | | | Gamma_Wave[00.03] | |
| | 31:29 | | not used | |
| | 28:24 | | Wform_03 | 5-bit substitution value used when bit- |
| | | | | plane data equals binary 00011. |
| | 23:21 | | not used | |
| | 20:16 | | Wform_02 | 5-bit substitution value used when bit- |
| | | | | plane data equals binary 00010. |
| | 15:13 | | not used | |
| | 12:8 | | Wform_01 | 5-bit substitution value used when bit- |
| | | | | plane data equals binary 00001. |
| | 7:5 | | not used | |
| | 4:0 | | Wform_00 | 5-bit substitution value used when bit- |
| | | | | plane data equals binary 00000. |
| 0x224 | | | Gamma_Wave[04.07] | |
| | 31:0 | | Wform 07:04 | Same as Gamma_Waveform [0.3], except |
| | | | | these are substitution values for 00111, |
| | | | | 00110, 00101, and 00100. |
| 0x228 | | | Gamma_Wave[08.0B] | |
| | 31:0 | | Wform 0B:08 | Same as Gamma_Waveform [0.3], except |
| | | | | these are substitution values for 01011, |
| | | | | 01010, 01001, and 01000. |
| 0x22C | | | Gamma_Wave[0C.0F] | |
| | 31:0 | | Wform 0F:0C | Same as Gamma_Waveform [0.3], except |
| | | | | these are substitution values for 01111, |
| | | | | 01110, 01101, and 01100. |
| 0x230 | | | Gamma_Wave[10.13] | |
| | 31:0 | | Wform 13:10 | Same as Gamma_Waveform [0.3], except |
| | | | | these are substitution values for 10011, |
| | | | | 10010, 10001, and 10000. |
| 0x234 | | | Gamma_Wave[14.17] | |
| | 31:0 | | Wform 17:14 | Same as Gamma_Waveform [0.3], except |
| | | | | these are substitution values for 10111, |
| | | | | 10110, 10101, and 10100. |
| 0x238 | | | Gamma_Wave[18.1B] | |
| | 31:0 | | Wform 1B:18 | Same as Gamma_Waveform [0.3], except |
| | | | | these are substitution values for 11011, |
| | | | | 11010, 11001, and 11000. |
| 0x23C | | | Gamma_Wave[1C.1F] | |
| | 31:0 | | Wform 1F:1C | Same as Gamma_Waveform [0.3], except |
| | | | | these are substitution values for 11111, |
| | | | | 11110, 11101, and 11100. |

Note
The above registers are addressable by CRISP via Data Transfer Operations, primarily MOV instruction.

### 0xF00xxx DAPPER Registers

TABLE 31
(32-bit) - RESERVED

| Addr | Bits | Init | Name | Description |
|---|---|---|---|---|
| 0x240 | | | Reserved | |
| . | | | | |
| . | | | | |
| . | | | | |
| 0x3FC | | | | |

Note
The above registers are addressable by CRISP via Data Transfer Operations, primarily MOV instruction

### 0xF80xxx CRASIC Registers

TABLE 32
CRISP and IRQ control

| Addr | Bits | Init | Name | Description |
|---|---|---|---|---|
| 0x0000 | | | Central Control | Read and Write Register |
| | 31 | | GLU_Logic_Reset | 0 -> 1 -> 0 resets misc logic |
| | 30:15 | | unused | |
| | 14 | | BackEnd_FIFO_Reset | 0 -> 1 -> 0 resets “backend” FIFO |
| | | | | (Analog Controller bus) |
| | 13 | | Extended_RDY | 1 = Hold RDY (ready) true 'til WE# |
| | | | | OE# goes inactive, 0 = RDY is a single clock |
| | | | | wide |
| | 12:9 | 0xE | Refresh_Rate | SDRAM refresh |
| | 8:3 | | unused | |
| | 2 | | STEP | Write of 1 executes a single Opcode |
| | | | | self-clearing upon completion. (HOLD is se = |
| | | | | 1) |
| | 1 | 1 | HOLD | 0 = RUN (continue), 1 = HOLD (halt) |
| | | | | CRISP process |
| | 0 | | Crisp_Reset | 0 -> 1 Resets Crisp processor |
| | | | | 1 -> 0 transition Starts CRISP at address |
| | | | | held in Crisp_PC register |
| 0x004 | | | Timer_Tick | |
| | 15:0 | | TMR | Clock scaler for CRISP watchdog/ |
| | | | | timer. This value is transferred to an interna |
| | | | | Counter. Each time the counter “rolls over” |
| | | | | one “tick” is applied to CRISPs watchdog/ |
| | | | | tuner register. |
| 0x008 | | | IRQEN | Read and Write register |
| | 8 | | Error_IRQ_Enable | 1 = Enabled. This IRQ may occur if a |
| | | | | bad transaction to the Display System is |
| | | | | detected. (Primarily an unexpected nReady |
| | | | | during a row burst). Toggle this bit to ‘0’ to |
| | | | | clear the interrupt. |
| | 7 | | GPIO_3_IRQ_Enable | 1 = Enabled. When the general- |
| | | | | purpose I/O-3 line transitions from high to |
| | | | | low, an interrupted will be generated. Togg |
| | | | | this bit to “0” to clear the interrupt. |
| | 6 | | GPIO_2_IRQ_Enable | 1 = Enabled. When the general- |
| | | | | purpose I/O-2 line transitions from high to |
| | | | | low, an interrupted will be generated. Togg |
| | | | | this bit to ‘0’ to clear the interrupt. |
| | 5 | | GPIO_1_IRQ_Enable | 1 = Enabled. When the general- |
| | | | | purpose I/O-1 line transitions from high to |
| | | | | low, an interrupted will be generated. Togg |
| | | | | this bit to ‘0’ to clear the interrupt. |
| | 4 | | GPIO_0_IRQ_Enable | 1 = Enabled. When the general- |
| | | | | purpose I/O-0 line transitions from high to |
| | | | | low, an interrupted will be generated. Togg |
| | | | | this bit to ‘0’ to clear the interrupt. |
| | 3 | | WDog_IRQ_Enable | 1 = Enabled. If the watchdog function |
| | | | | is enabled, and the watchdog timer times-ou |
| | | | | an interrupt is generated. Toggle this bit to |
| | | | | ‘0’ to clear the interrupt. |
| | 2 | | PS2_IRQ_Enable | 1 = Enabled. When PS/2 port is set to |
| | | | | automatically poll, and data is available, an |
| | | | | interrupt will be generated. Toggle this bit t |
| | | | | ‘0’ to clear the interrupt. |
| | 1 | | OS2R_IRQ_Enable | 1 = Enabled. When the Right |
| | | | | MicroDisplay interrupt line transitions from |
| | | | | high to low, an interrupted will be generated |
| | | | | Toggle this bit to ‘0’ to clear the interrupt. |
| | 0 | | OS2L_IRQ_Enable | 1 = Enabled. When the Left |
| | | | | MicroDisplay interrupt line transitions from |
| | | | | high to low, an interrupted will be generated |
| | | | | Toggle this bit to ‘0’ to clear the interrupt. |
| 0x00C | | | IRQSC | Read Only Register |
| | 8 | | Error_IRQ_Status | 1 = True. Buss Error IRQ status. A write |
| | | | | of “1” clears. |
| | 7 | | GPIO_3_IRQ_Status | 1 = True. GPIO_3 IRQ status. |
| | 6 | | GPIO_2_IRQ_Status | 1 = True. GPIO_2 IRQ status. |
| | 5 | | GPIO_1_IRQ_Status | 1 = True. GPIO_1 IRQ status. |
| | 4 | | GPIO_0_IRQ_Status | 1 = True. GPIO_0 IRQ status. |
| | 3 | | WDog_IRQ_Status | 1 = True. Watchdog overrun IRQ status. |
| | 2 | | PS2_IRQ_Status | 1 = True. PS/2 IRQ status. |
| | 1 | | OS2R_IRQ_Status | 1 = True. Right MicroDisplay IRQ status. |
| | 0 | | OS2L_IRQ_Status | 1 = True. Left MicroDisplay IRQ status. |
| 0x010 | | | PS2_Control_Status | Read and Write Register |
| | 7 | | PS2_Enable | Setting this bit to “1” enables PS/2 port |
| | | | | operation, a “0” will disable all PS/2 |
| | | | | related functions. |
| | 6 | | PS2Clk_Enable | When set to “1” device's Clock is allowed to |
| | | | | run. This bit must be set to “1” if PS/2 port |
| | | | | interrupts are to be used. This bit must be se |
| | | | | to “0” when sending commands to the PS/2 |
| | | | | device. |
| | 5 | | Send_Command | Writing a “1” will cause a PS/2 command |
| | | | | sequence to commence, e.g. the PS2Clk |
| | | | | is un-inhibited, command and data will |
| | | | | be sent, then the “PS2Clk_Enable” is set |
| | | | | to “1” to allow the PS/2 device to send |
| | | | | any data it may have ready. This bit |
| | | | | should be cleared before clearing the |
| | | | | corresponding interrupt - to ensure no |
| | | | | erroneous data is transmitted to the PS2 |
| | | | | port. |
| | 4 | | PS2_Reset | Resets the PS/2 port when toggled from ‘0’ |
| | | | | ‘1’. Should be normally ‘0’. As long as this |
| | | | | bit is set to ‘1’, the ps2_port will stay in |
| | | | | ‘inhibit’ state. |
| | 3 | | PS/2_Error | Set to “1” if an error is detected on the |
| | | | | PS/2 port. The error bit will become ‘0’ |
| | | | | automatically after initiating the next |
| | | | | send/receive command to the PS2 port. |
| | 2 | | | |
| | 1:0 | | | |
| 0x014 | | | PS2_Command | Read and Write Register |
| | 7:0 | | PS2_Command | To send a command to the PS/2 device, |
| | | | | this register is written to the command |
| | | | | byte before setting the |
| | | | | PS2_send_command bit. |
| 0x018 | | | PS2_Data | Read Only Register |
| | 7:0 | | PS2_Data | This is a single byte register, which |
| | | | | contains the last data received from the |
| | | | | PS2 port. |
| 0x1C | | | ID Register | Read Only Register |
| | 7:0 | | | The upper nibble of the byte [7:4] |
| | | | | defines the product. The lower nibble [3:0] |
| | | | | defines the revision number of the ASIC. |
| | | | | ASIC ID: |
| | | | | D [7:0]. |
| | 15:8 | | | FPGA ID: |
| | | | | D[15:12] LP1M4 − 0 |
| | | | | FPGA Revision Number: |
| | | | | D[11:8]: As new features are added |
| | | | | for e.g. palette bypass, this number will be |
| | | | | incremented. For LP1M4 board the rev. 1 is |
| | | | | to be released. (There is no revision 0.) |
| 0x020 | | | Addressing_Control | Read and Write Register |
| | 31 | | Auto_Increment | When this bit is set to “1”, the DPTR is |
| | | | | automatically incremented by 4 bytes |
| | | | | subsequent to each transfer, otherwise the |
| | | | | indirect R/W will reflect a single |
| | | | | CRASIC address location. |
| | 30 | | Redirect_SDRAM | When this bit is set to “1”, all Host |
| | | | | SDRAM write accesses are redirected |
| | | | | using DPTR. |
| | 29 | | Cnt_Skip_Enable | Used in conjunction with |
| | | | | “Redirect_SDRAM”, setting this bit to |
| | | | | “1” enables the use of the |
| | | | | Rectangle_Control register values to |
| | | | | adjust DPTR addressing (see |
| | | | | Rectangle_Control register, below). This |
| | | | | is the key to handling DVI data |
| | | | | automatically. |
| | 28:24 | | not used | |
| | 23:2 | | DPTR | The data pointer provides a R/W address |
| | | | | for transfers to and SDRAM when |
| | | | | Redirect_SDRAM is enabled. All |
| | | | | transfers are 32-bit aligned. |
| | 1:0 | | not used | |
| 0x24 | | | Row_Control | Read and Write Register |
| | 31:24 | | not used | |
| | 23:16 | | Row_Skip | When “Cnt_Skip_Enable” in |
| | | | | Addressing_Control register is set to “1” an |
| | | | | “Row_Count” is exhausted, this value is |
| | | | | added to DPTR (23:2) to form the address f |
| | | | | the next logical row write to SDRAM. This |
| | | | | the number of 32-bit words to skip at the en |
| | | | | of each row. |
| | 15:10 | | not used | |
| | 9:0 | | Row_Count | When “Cnt_Skip_Enable” in |
| | | | | Addressing_Control register is set to “1” thi |
| | | | | value provides a count of 32-bit transfers fo |
| | | | | each logical image row. Used in conjunctio |
| | | | | with “Row_skip”, any rectangle up to 1024 |
| | | | | words wide can be directed into SDRAM. |
| 0x24 | | | DE_Control | Read and Write Register |
| | 25 | | DE_Enable | When ‘1’, DE signal is asserted periodically. |
| | | | | When ‘0’, DE is disabled and never asserted. |
| | | | | Note: DE signal is used only when using panel |
| | | | | link interface. |
| | 24 | | DE_Polarity | When ‘0’, DE will be active low. When ‘1’, |
| | | | | DE will be active high. |
| | 23:16 | | DE_Width | The pulse width of DE signal is equal to the |
| | | | | number of clocks of this hex value. |
| | 15:0 | | DE_Frequency | This is the hex value of the number of clocks |
| | | | | before which the DE signal will be asserted. |
| 0x2C: | | | Reserved for | |
| 0x0FC | | | Debug Registers | |

### 0xF80xxx CRASIC Registers

TABLE 33
(8-bit) - Serial EEPROM

| | | | | |
|---|---|---|---|---|
| Addr | Bits | Init | Name | Description |

| | | | |
|---|---|---|---|
| 0x100 | | SB_Control | |
| | 7 | sbStart | Writing a “1” initiates a new command |
| | | | transaction. This is cleared automatically |
| | | | when target device has acknowledged the |
| | | | command and is ready for data transfers, |
| | | | if any. |
| | 6:4 | sbCommand | Commands supported are as follow |
| | | | 000 = Nop |
| | | | 001 = Read Address |
| | | | 010 = Read |
| | | | 011 = Write |
| | | | 100 − 111 = not defined |
| | 3 | sbAddrMode | 0 = small address, 1 = extended address |
| | 2:0 | sbDevAddr | Device address |
| 0x104 | | SB_Status | |
| | 7 | sbReady | This bit goes high when the data register |
| | | | is ready for a transaction. If reading, it |
| | | | goes high when data is available, for write |
| | | | it goes high when the device is ready to |
| | | | receive the next data. |
| | 6 | sbDone | This bit goes high when all data has been |
| | | | transferred, e.g. the Read Address |
| | | | command will return 1 or 2 bytes |
| | | | (depending on device addressing |
| | | | capabilities) and then will be “done”. |
| | 5 | sbError | If any transaction is unacknowledged by |
| | | | target device, this bit is set to indicate an |
| | | | error. It is automatically cleared when the |
| | | | next iStart is issued. |
| 0x108 | | SB_AddrLow | |
| | 7:0 | sbAddrL | For small address devices (such as |
| | | | Analog Controller), this provides |
| | | | addressing of up to 256 locations |
| 0x10C | | SB_AddrHigh | |
| | 7:0 | sbAddrH | Extends the addressing to 64K-byte (such |
| | | | as the CRISP boot ROM) |
| 0x110 | | SB_Data | |
| | 7:0 | sbData | Data register for I\hat{ }2C transactions |
| 0x114 | — | Reserved | |
| 0x11C | | | |

### Dithering and Planerization Processing Engine & (data) Router (DAPPER)

The MicroDisplay supports a native color depth of one bit per color, e.g. 8 possible colors for each pixel. In order to generate higher color depths, image data must be separated into color planes for each bit of color depth. Each image color plane is written to the MicroDisplay once per frame, reproducing the image on the display.

The color separation process is somewhat time consuming and inconvenient on most microprocessors. The DAPPER relieves the host processor from this chore by providing an 8-bit per pixel display buffer interface. In addition, DAPPER allows the representation of even higher color depths through the use of an 8-to-24-bit color palette and spatial dithering.

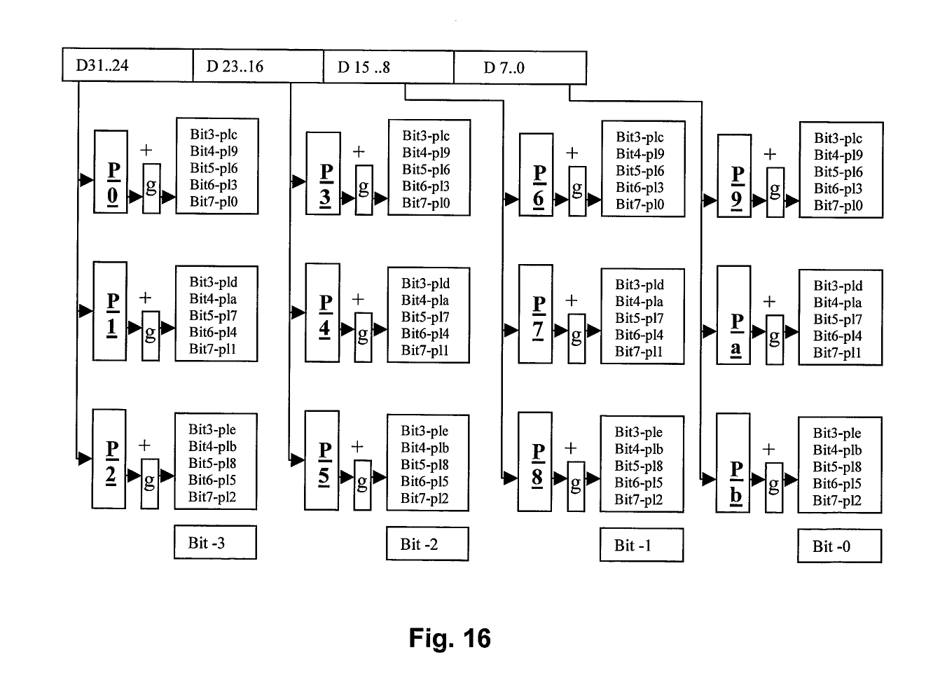

FIG. 16 shows how each byte of image data is processed through the palette, adjusted by the “grid” (see Dithering, below), and separated into individual bit planes. Up to 5 bit planes per color can be generated automatically.

### Dithering

Dithering is achieved with the use of a 3 by 3 noise injection grid. Each (RGB) color of pixel is rounded up or down according to the grid, producing on average the approximate original color when viewed over a group of adjacent pixels. Such spatial dithering improves color fidelity by 3 bits per color at the expense of absolute image resolution.

Either the host or CRISP processor can initialize the three ‘grid’ (g) registers. Each register holds three “noise” values corresponding to pixel column modulo-3. The register used for a given row is selected by the value of row modulo-3.

### Data Router

The 32 bit values of the unprocessed, and as well as the processed, data (Plane-registers) are written into the local memory (SDRAM). The address generated by the router is stored in an address FIFO (32 deep) known as AFIFO. The corresponding data is stored in DFIFO, as shown in the table below. The router calculates the address for each plane register-write as follows:

Destination address=Plane_Base_Address+(A19-A3 of the first write address remapped as A16-A0)+(Plane_number×Plane_Length)

The Plane_number is the value referred by the Row Address A17-A14. The ‘Plane_Base_Address’ & ‘Plane Length’ are registers initialized by either the Host or CRISP processor.

The data and addresses are written sequentially into the AFIFO and DFIFO as the plane registers are filled up. The address for the unprocessed data is retained as it is from the processor. The address and the unprocessed data also are written into the AFIFO and DFIFO.

The router arbitrates for the local memory along with CRISP and the Host microprocessor (it only reads in the regular address space and not in the DAPPER address space). When it wins the arbitration, it writes the data into the corresponding address of the local memory (SDRAM).

TABLE 34

| | |
|---|---|
| AFIFO (0) | DFIFO (0) |
| AFIFO (1) | DFIFO (1) |
| AFIFO (2) | DFIFO (2) |
| ↓ | ↓ |
| AFIFO (31) | DFIFO (31) |

The AFIFO and DFIFO are designed into the system to reduce the latency unprocessed data writes of the processor, into the DAPPER. If the AFIFO/DFIFO is full, and the CRISP processor is moving data from the SDRAM to the MicroDisplay, the host processor may be held off from completing a write operation for up to N micro-seconds.

### Color Rich Internal System Processor (CRISP)

The Color Rich Internal System Processor, or CRISP, is a very small instruction set processor used, primarily, to drive DMA transfers from memory to the MicroDisplay. CRISP is the part of the Color Rich Controller that programmatically controls the operation of the MicroDisplay and Analog Controller.

CRISP is designed to handle a simple 512-Color mode of operation, but is flexible enough to manage higher color operations, as well as stereo imaging on dual displays. With its simple instruction set, it can simplify cursor tracking, fonts, and multiple screen and window management for the host processor.

It is possible to create a simplified (host) software interface to enable display module customers to develop products without having to understand the details of CRISP programming, MicroDisplay, or Analog Controller. The CRISP programming may be auto-loaded from a serial EEPROM, or downloaded by the host driver at initialization.

Note, this simplified interface and CRISP programming is under development and is not yet available.

### Design Considerations

To deliver a complete Color Rich solution for MicroDisplay customers, it must simplify both hardware and software development. For the hardware, it can standardize the way Color Rich mode is implemented. For the software, it can eliminate the need for separating color planes, and provide automatic conversion from industry standard pixel definitions to MicroDisplay's way of doing things.

The following is a list of functional desires and/or requirements.

Support for varied color depth, allowing tradeoff between color depth and power usage. Minimum of 512 colors.

Conversion from 8, 16, and 24 bits per pixel to MicroDisplay Color Rich.

Color Palettes and real time Dithering.

Support for two Displays, simultaneously.

System must be capable of video frame-rate image throughput.

Low power consumption while display image is static.

Support for Fonts, Cursors, Windows, etc.

32-bit bus to maximize throughput.

Buffer memory addressing is flexible, avoiding hard coded address maps.

An integrated “Watch-Dog” to protect the liquid crystal display.

### CRISP Instruction Start Conditions

The majority of CRISP instructions have a field called Start Conditions. See the table below. This field specifies which signal(s) must be “true” before the instruction is allowed to execute. The instruction halts the CRISP processor until the conditions are satisfied. Note that a WatchDog timer can prevent the processor from hanging indefinitely in the event that the specified signals never come “true”.

The start condition(s) to be tested are specified in the instruction as a “1” or “true”, while conditions to be ignored are “0”. Interrupt signals are “true” when they are “asserted” by the MicroDisplay.

This capability allows for precise synchronization of display data transfers between buffer memory, and the MicroDisplay(s). Registers for all devices may also require synchronous updates according to the state of the MicroDisplay.

TABLE 35

| Start | | |
|---|---|---|
| Condition | Source Signal | Notes |
| GPIO_3 | GPIO_3 | “True” when high. |
| GPIO_2 | GPIO_2 | “True” when high. |
| GPIO_1 | GPIO_1 | “True” when high. |
| GPIO_0 | GPIO_0 | “True” when high. |
| [not | — | — |
| applicable] | | |
| WDTO | WD timer | WatchDog time-out. This signal is useful only if AUXCON |
| | | register, WDENBL = 0, otherwise time-out |
| | | will cause an ABORT interrupt. |
| ORQ_2 | Interrupt | “True” when Right MicroDisplay interrupt line is low. |
| ORQ_1 | Interrupt | “True” when Left MicroDisplay interrupt line is low. |

### CRISP Branch Conditions

The CRISP flow control instructions have Branch Conditions, instead of Start Conditions. Branch Conditions are immediately tested, and the instruction executes according to the results of the test. Flow control instructions allow for more complex “real-time” programs, such as automatically updating a cursor's screen position or preparing new host data for display utilizing the time between MicroDisplay field updates.

The branch condition(s) to be tested are specified in the instruction as a “1”, while conditions to be ignored are “0”. Unlike Start Conditions, Branch Conditions are tested as high or low, not true or false. The actual state of a tested flag or signal is important.

TABLE 36

| Branch | | |
|---|---|---|
| Condition | Source Signal | Notes |
| GPIO_3 | GPI_3 | General Purpose Input/Output 3 state. |
| GPIO_2 | GPI_2 | General Purpose Input/Output 2 state. |
| GPIO_1 | GPI_1 | General Purpose Input/Output 1 state. |
| GPIO_0 | GPI_0 | General Purpose Input/Output 0 state. |
| TCC | — | Condition code set by TST instruction. |
| WDTO | WD timer | WatchDog time-out. This signal is useful only if AUXCON |
| | | register, WDENBL = 0, otherwise time-out |
| | | will cause an ABORT interrupt. |
| ORQ_2 | Interrupt | Right MicroDisplay IRQ state. |
| ORQ_1 | Interrupt | Left MicroDisplay IRQ state. |

### Instruction Set Summary

TABLE 37
Load CRA register

| Instruction | CRA Reg | Address |
|---|---|---|
| (31:27) | (26:24) | (23:0) |
| 00000 - LDR | nnn | aaaa aaaa aaaa aaaa aaaa aaaa |
| 00001 - STR | nnn | aaaa aaaa aaaa aaaa aaaa aaaa |

These instructions move the data found at the specified Address to/from one of up to eight registers in the CRISP.

### Data Transfer Operations

These instructions move data from one part of memory to another, or to memory mapped devices such as MicroDisplay. Some of the instructions combine source and destination data using Boolean operators.

TABLE 38

| | | Addr | Move | Skip | |
|---|---|---|---|---|---|
| Instruction | WDR | Mode | Count | Count | Start Conditions |
| (31:27) | (26) | (25:24) | (23:16) | (15:8) | (7:0) |
| 00010 - | b | Src Dst | cccc cccc | ssss ssss | g3 g2 g1 g0 na wd |
| MOP | | | | | q2 q1 |
| 00011 - | b | Src Dst | cccc cccc | ssss ssss | g3 g2 g1 g0 na wd |
| MOV | | | | | q2 q1 |
| 00100 - | b | Src Dst | cccc cccc | ssss ssss | g3 g2 g1 g0 na wd |
| NOT | | | | | q2 q1 |
| 00101 - | b | Src Dst | cccc cccc | ssss ssss | g3 g2 g1 g0 na wd |
| AND | | | | | q2 q1 |
| 00110 - | b | Src Dst | cccc cccc | ssss ssss | g3 g2 g1 g0 na wd |
| XOR | | | | | q2 q1 |
| 00111 - | b | Src Dst | cccc cccc | ssss ssss | g3 g2 g1 g0 na wd |
| ORR | | | | | q2 q1 |

### Immediate Data Operations

These instructions operate on 8-bit registers found on the MicroDisplay, Analog Controller, CRISP, and an additional (TBD) device.

TABLE 39

| Instruction | Dev Sel | Device Address | Data | Start Conditions |
|---|---|---|---|---|
| (31:27) | (26:24) | (23:16) | (15:8) | (7:0) |
| 01000 - LDC | nnn | aaaa aaaa | dddd | g3 g2 g1 g0 na wd |
| | | | dddd | q2 q1 |
| 01001 - SET | nnn | aaaa aaaa | dddd | g3 g2 g1 g0 na wd |
| | | | dddd | q2 q1 |
| 01010 - CLR | nnn | aaaa aaaa | dddd | g3 g2 g1 g0 na wd |
| | | | dddd | q2 q1 |
| 01011 - TST | nnn | aaaa aaaa | dddd | g3 g2 g1 g0 na wd |
| | | | dddd | q2 q1 |

### Flow Control Operations

These instructions provide program flow control to create loops and conditional execution.

TABLE 40

| Instruction | WDR | Offset Address | Conditions |
|---|---|---|---|
| (31:27) | (26) | (25:8) | (7:0) |
| 01100 - BCL | b | aa aaaa aaaa aaaa aaaa | g3 g2 g1 g0 tc wd |
| | | | q2 q1 |
| 01101 - BCH | b | aa aaaa aaaa aaaa aaaa | g3 g2 g1 g0 tc wd |
| | | | q2 q1 |
| 01110 - HBL | b | aa aaaa aaaa aaaa aaaa | g3 g2 g1 g0 tc wd |
| | | | q2 q1 |
| 01111 - HBH | b | aa aaaa aaaa aaaa aaaa | g3 g2 g1 g0 tc wd |
| | | | q2 q1 |

### Timing Control Operations

This instruction provides precise inline timing for display field control.

TABLE 41

| | [not | | | |
|---|---|---|---|---|
| Instruction | used] | [not used] | Delay Count | [not used] |
| (31:27) | (26) | (25:18) | (17:8) | (7:0) |
| 11111 - DLY | b | — | cc cccc cccc | g3 g2 g1 g0 na wd |
| | | | | q2 q1 |

Note Instructions 10000 through 11110 are undefined and should not be used.

### Instruction Set Details

TABLE 42
Load CRA Register

| Instruction | CRA Reg | Address |
|---|---|---|
| (31:27) | (26:24) | (23:0) |
| 00000 - LDR | nnn | aaaa aaaa aaaa aaaa aaaa aaaa |

| | |
|---|---|
| LDR reg, address | // address (data)->reg |

Data found at the Address location specified is loaded to specified register. The details of this instruction's fields may be found below.

TABLE 43
Store CRA Register

| Instruction | CRA Reg | Address |
|---|---|---|
| (31:27) | (26:24) | (23:0) |
| 00001 - STR | nnn | aaaa aaaa aaaa aaaa aaaa aaaa |

| | |
|---|---|
| STR reg, address | // reg->mem address |

The contents of the specified register are written to memory at the specified address.

The values designating CRA registers (nnn) are as follows.

TABLE 44

| | Register | |
|---|---|---|
| nnn | Name | Actual Size - Usage |
| 000 | Source | 24 bits - Starting address value used by “Memory to |
| | Pointer | MicroDisplay” and “Memory to Memory” |
| | | operations as the data source memory address. |
| | | Note: the low order two bits of loaded |
| | | value are ignored because all transfers must be |
| | | 32-bit word aligned. |
| 001 | Destination | 24 bits - Starting address value used by “Memory to |
| | Pointer | MicroDisplay” and “Memory to Memory” |
| | | operations as the data destination memory address. |
| | | Note: the low order two bits of loaded value are |
| | | ignored because all transfers must be 32-bit |
| | | word aligned. |
| 010 | Transfer | 22 bits - Used by “Memory to MicroDisplay” and |
| | Count | “Memory to Memory” operations as a byte count |
| | | for the entire transfer operation. The upper |
| | | two unused bits (of the 24-bit field) are ignored, |
| | | but should be set to zero for future compatibility. |
| | | Note: the low order two bits of loaded |
| | | value are ignored because all transfers are |
| | | 32-bit data operations. |
| 011 | Program | 24 bits - This is the CRISP Program counter. |
| | Counter | An LRI to this register is effectively a JMP |
| | | indirect. Note: the low order two bits of loaded |
| | | value are ignored because instructions |
| | | must be 32-bit word aligned. |
| 1xx | Undefined | These four register addresses are reserved for future |
| | | expansion. |

### Data Transfer Operations

TABLE 45

| | | Addr | Move | Skip | |
|---|---|---|---|---|---|
| Instruction | WDR | Mode | Count | Count | Start Conditions |
| (31:27) | (26) | (25:24) | (23:16) | (15:8) | (7:0) |
| 00010 - | b | x x | cccc cccc | ssss ssss | na g2 g1 wd i2 q2 |
| MOP | | | | | i1 q1 |

MMD wdr, smode=1, dmode=0, mCount, sCount, conditions //Src->Dst

Move memory to MicroDisplay. This instruction copies 32-bit words from “Source Address” memory through “End Address”, to “Destination Address” MicroDisplay(s). This instruction invokes an optimized data path between the SDRAM and the MicroDisplay.

TABLE 46

| | | Addr | Move | Skip | |
|---|---|---|---|---|---|
| Instruction | WDR | Mode | Count | Count | Start Conditions |
| (31:27) | (26) | (25:24) | (23:16) | (15:8) | (7:0) |
| 00011 - | b | Src Dst | cccc cccc | ssss ssss | na g2 g1 wd i2 q2 |
| MOV | | | | | i1 q1 |

MOV wdr, smode, dmode, mCount, sCount, conditions // Src->Dst

This general purpose data move instruction copies 32-bit words from “Source Address” to “Destination Address” according to SRC and DST “Addr Mode” settings.

Below is a breakdown of each of the fields for MOP and MMD.

TABLE 47

| | Value | |
|---|---|---|
| Field | or | |
| Name | Range | Function |
| WDR | b=0 | Watchdog is not reset on this operation |
| | b=1 | Watchdog is reset to last loaded full count, WD status is cleared |
| Addr | SRC = | Source/Destination Addresses are incremented normally |
| Mode | 0 | (e.g. +4 bytes for each 32-bit transfer) for the duration of |
| | DST=0 | the transfer. |
| | SRC=1 | After each 32-bit move the Source/Destination Address |
| | DST=1 | is incremented by 4 (to next word address), and the |
| | | “Move Count” is decremented by 1. When “Move |
| | | Count” is exhausted, it is reset to it's original value, and |
| | | the Source/Destination Address is incremented by “Skip |
| | | Count”. |
| Move | 0-0xFF | When SRC and/or DST Addr Mode is “1”, this value is |
| Count | | used to load a countdown counter to track 32-bit |
| | | transfers. Upon reaching zero, each affected Address |
| | | register is incremented by “Skip Count”, and the counter |
| | | is reloaded to begin countdown again. |
| Skip | 0-0xFF | When SRC and/or DST Addr Mode is “1”, this value is |
| Count | | used to increment each affected Address register. |
| Start | XX | For each of the 8 start conditions, a “0” denotes a “Don't |
| Conditions | | Care” while a “1” indicates the condition must be met |
| | | (condition is “True”) before the instruction is executed. |
| | | Note: some conditions cannot happen simultaneously. |
| | | For more information, see “Start Conditions” discussion |
| | | on page nn. |

TABLE 48

| | | Addr | Move | Skip | |
|---|---|---|---|---|---|
| Instruction | WDR | Mode | Count | Count | Start Conditions |
| (31:27) | (26) | (25:24) | (23:16) | (15:8) | (7:0) |
| 00100 - | b | Src Dst | cccc cccc | ssss ssss | na g2 g1 wd i2 q2 |
| NOT | | | | | i1 q1 |

NOT wdr, smode, dmode, mCount, sCount, conditions // !Src->Dst

This instruction transfers 32 bit words from “Source Address” through “End Address” to “Destination Address” according to SRC and DST “Addr Mode” settings. The destination data is inverted from the source data. Details of this instruction's fields found below.

TABLE 49

| | | Addr | Move | Skip | |
|---|---|---|---|---|---|
| Instruction | WDR | Mode | Count | Count | Start Conditions |
| (31:27) | (26) | (25:24) | (23:16) | (15:8) | (7:0) |
| 00101 - | b | Src Dst | cccc cccc | ssss ssss | na g2 g1 wd i2 q2 |
| AND | | | | | i1 q1 |

AND wdr, smode, dmode, mCount, sCount, conditions // Src & Dst ->Dst

This instruction transfers 32 bit words from “Source Address” through “End Address” to “Destination Address” according to SRC and DST “Addr Mode” settings. The prior data at the destination address is ANDed with the source data, then stored at the destination address.

Below is a breakdown of each of the fields for NOT and AND.

TABLE 50

| | Value | |
|---|---|---|
| Field | or | |
| Name | Range | Function |
| WDR | | |
| | b = 0 | Watchdog is not reset on this operation |
| | b = 1 | Watchdog is reset to last loaded full count, WD |
| | | status is cleared |
| Addr | | |
| Mode | | |
| | SRC = | Source / Destination Addresses are incremented |
| | 0 DST = | normally (e.g. +4 bytes for each 32-bit transfer) |
| | 0 | for the duration of the transfer. |
| | | After each 32-bit move the Source / Destination |
| | SRC = 1 | Address is incremented by 4 (to next word address), |
| | DST = 1 | and the “Move Count” is decremented by 1. When |
| | | “Move Count” is exhausted, it is reset to |
| | | it's original value, and the Source / Destination |
| | | Address is incremented by “Skip Count”. |
| Move | | |
| Count | | |
| | 0-0xFF | When SRC and / or DST Addr Mode is “1”, this |
| | | value is used to load a countdown counter to track |
| | | 32-bit transfers. Upon reaching zero, each affected |
| | | Address register is incremented by “Skip Count”, |
| | | and the counter is reloaded to begin countdown |
| | | again. |
| Skip | | |
| Count | | |
| | 0-0xFF | When SRC and/or DST Addr Mode is “1”, this |
| | | value is used to increment each affected Address |
| | | register. |
| Start | | |
| Condi- | | |
| tions | | |
| | xx | For each of the 8 start conditions, a “0” denotes |
| | | a “Don't Care” while a “1” indicates the |
| | | condition must be met (e.g. condition is “True”) |
| | | before the instruction is executed. Note: some |
| | | conditions cannot happen simultaneously. For more |
| | | information, see “Start Conditions” discussion |
| | | on page nn. |

TABLE 51

| | | Addr | Move | Skip | |
|---|---|---|---|---|---|
| Instruction | WDR | Mode | Count | Count | Start Conditions |
| (31:27) | (26) | (25:24) | (23:16) | (15:8) | (7:0) |
| 00110 - | b | Src Dst | cccc cccc | ssss ssss | na g2 g1 wd i2 q2 |
| XOR | | | | | i1 q1 |

XOR wdr, smode, dmode, mCount, sCount, conditions // SrcDst−>Dst

This instruction transfers 32 bit words from “Source Address” through “End Address” to “Destination Address” according to SRC and DST “Addr Mode” settings. The prior data at the destination address is EXCLUSIVE-ORed with the source data, then stored at the destination address. Details of this instruction's fields found below.

TABLE 52

| | | Addr | Move | Skip | |
|---|---|---|---|---|---|
| Instruction | WDR | Mode | Count | Count | Start Conditions |
| (31:27) | (26) | (25:24) | (23:16) | (15:8) | (7:0) |
| 00111 - | b | Src Dst | cccc cccc | ssss ssss | na g2 g1 wd i2 q2 |
| ORR | | | | | i1 q1 |

ORR wdr, smode, dmode, mCount, sCount, conditions // Src|Dst−>Dst

This instruction transfers 32 bit words from “Source Address” through “End Address” to “Destination Address” according to SRC and DST “Addr Mode” settings. The prior data at the destination address is ORed with the source data, then stored at the destination address.

Below is a breakdown of each of the fields for XOR and ORR

TABLE 53

| | Value | |
|---|---|---|
| Field | or | |
| Name | Range | Function |
| WDR | | |
| | b = 0 | Watchdog is not reset on this operation |
| | b = 1 | Watchdog is reset to last loaded full count, |
| | | WD status is cleared |
| Addr | | |
| Mode | | |
| | SRC = | Source / Destination Addresses are incremented |
| | 0 DST = | normally (e.g. +4 bytes for each 32-bit transfer) |
| | 0 | for the duration of the transfer. |
| | | After each 32-bit move the Source / Destination |
| | SRC = 1 | Address is incremented by 4 (to next word address), |
| | DST = 1 | and the “Move Count” is decremented by 1. |
| | | When “Move Count” is exhausted, it is reset |
| | | to it's original value, and the Source/Destination |
| | | Address is incremented by “Skip Count”. |
| Move | | |
| Count | | |
| | 0-0xFF | When SRC and / or DST Addr Mode is “1”, this |
| | | value is used to load a countdown counter to track |
| | | 32-bit transfers. Upon reaching zero, each affected |
| | | Address register is incremented by “Skip Count”, |
| | | and the counter is reloaded to begin countdown |
| | | again. |
| Skip | | |
| Count | | |
| | 0-0xFF | When SRC and/or DST Addr Mode is “1”, this |
| | | value is used to increment each affected Address |
| | | register. |
| Start | | |
| Condi- | | |
| tions | | |
| | xx | For each of the 8 start conditions, a “0” |
| | | denotes a “Don't Care” while a “1” |
| | | indicates the condition must be met (e.g. condition |
| | | is “True”) before the instruction is executed. |
| | | Note: some conditions cannot happen |
| | | simultaneously. For more information, see “Start |
| | | Conditions” discussion on page nn. |

### Immediate Data Operations

TABLE 54

| | | Device | | Start |
|---|---|---|---|---|
| Instruction | Dev Sel | Address | Data | Conditions |
| (31:27) | (26:24) | (23:16) | (15:8) | (7:0) |
| 01000 - LDC | nnn | aaaa aaaa | dddd | na I Q W L R |
| | | | dddd | G B |

LDC dSel, dAddr, data, conditions // data --> regAddr

This instruction writes the immediate Data to the specified device register address (regAddr). Details of this instruction's fields found below.

TABLE 55

| | | Device | | |
|---|---|---|---|---|
| Instruction | Dev Sel | Address | Data | Start Conditions |
| (31:27) | (26:24) | (23:16) | (15:8) | (7:0) |
| 01001 - SET | nnn | aaaa aaaa | dddd | na g2 g1 wd i2 q2 |
| | | | dddd | i1 q1 |

SET dSel, dAddr, data, condition // data | regAddr --> regAddr

This instruction ORs the immediate Data with the specified device register address (regAddr), then writes the result to that same device register address.

Below is a breakdown of each of the fields for LDC and SET.

TABLE 56

| | Value | |
|---|---|---|
| Field | or | |
| Name | Range | Function |
| DevSel | | |
| | 00x | Registers selected (see also CRISP Control & Status |
| | | registers, AUXCON) x = left or right device |
| | 01x | Analog Controller parallel interface selected (see also |
| | | CRISP Control & Status registers, AUXCON) x = |
| | | left or right device |
| | 100 | MicroDisplay Registers selected (see also CRISP |
| | | Control & Status registers, AUXCON) Both L & R |
| | | devices are selected. |
| | 101 | Analog Controller parallel interface selected (see also |
| | | CRISP Control & Status registers, AUXCON) Both |
| | | L & R devices are selected. |
| | 110 | Auxiliary device selected |
| | 111 | Color Rich ASIC selected (internal 8-bit registers - see |
| | | page nn) |
| Device | | |
| Address | | |
| | 0-0xFF | 8 bit address of device. (see also CRISP Control |
| | | & Status registers, AUXCON) |
| Data | | |
| | 0-0xFF | 8 bit data to be used with device register. |
| | | For LDC, this value is written to the device |
| | | register. For SET, each bit that is a “1” |
| | | is set in the device register, while “0” |
| | | bits are left unchanged. |
| Start | | |
| Condi- | | |
| tions | | |
| | xx | For each of the 8 start conditions, a “0” |
| | | denotes a “Don't Care” while a “1” |
| | | indicates the condition must be met (condition is |
| | | “True”) before the instruction is executed. |
| | | Note: some conditions cannot happen simultaneously. |
| | | For more information, see “Start Conditions” |
| | | discussion on page nn. |

TABLE 57

| | | Device | | |
|---|---|---|---|---|
| Instruction | Dev Sel | Address | Data | Start Conditions |
| (31:27) | (26:24) | (23:16) | (15:8) | (7:0) |
| 01010 - CLR | nnn | aaaa aaaa | dddd | na g2 g1 wd i2 q2 |
| | | | dddd | i1 q1 |

CLR dSel, dAddr, data, condition // !data & regAddr --> regAddr

This instruction inverts the immediate Data; ANDs the result with the specified device register address (regAddr), then writes the result to that same device register address. Details of this instruction's fields found below.

TABLE 58

| | | Device | | |
|---|---|---|---|---|
| Instruction | Dev Sel | Address | Data | Start Conditions |
| (31:27) | (26:24) | (23:16) | (15:8) | (7:0) |
| 01011 - TST | nnn | a aaaa aaaa | dddd | na g2 g1 wd i2 q2 |
| | | | dddd | i1 q1 |

TST dSel, dAddr, data, conditions // data & regAddr --> TCC (affects

This instruction ANDs the immediate Data with specified device register. When the results are 0x00, the “TCC” bit of the condition register is cleared (false). Otherwise it is set (true). The specified device register is unchanged by this operation.

Below is a breakdown of each of the fields for CLR and TST.

TABLE 59

| | Value | |
|---|---|---|
| Field | or | |
| Name | Range | Function |
| DevSel | | |
| | 00x | MicroDisplay Registers selected (see also CRISP |
| | | Control & Status registers, AUXCON) x = left or right |
| | | device |
| | 01x | Analog Controller parallel interface selected (see also |
| | | CRISP Control & Status registers, AUXCON) x = |
| | | left or right device |
| | 100 | MicroDisplay Registers selected (see also CRISP |
| | | Control & Status registers, AUXCON) Both L & R |
| | | devices are selected. |
| | 101 | Analog Controller parallel interface selected (see also |
| | | CRISP Control & Status registers, AUXCON) |
| | | Both L & R devices are selected. |
| | 110 | Auxiliary device selected |
| | 111 | Color Rich ASIC selected (internal 8-bit registers - see |
| | | page nn) |
| Device | | |
| Address | | |
| | 0-0xFF | 8-bit address of device registers. (see also |
| | | CRISP Control & Status registers, AUXCON) |
| Data | | |
| | 0-0xFF | 8 bit data to be used with device register. For |
| | | CLR, each bit that is a “1” is cleared in |
| | | the device register, while “0” bits are left |
| | | unchanged. For TST, this value is ANDed with the |
| | | device register and the TCC bit is set if the result |
| | | is not zero, otherwise TCC is cleared. |
| Start | | |
| Condi- | | |
| tions | | |
| | xx | For each of the 8 start conditions, a “0” denotes |
| | | a “Don't Care” while a “1” indicates the condition |
| | | must be met (e.g. condition is “True”) before the |
| | | instruction is executed. Note: some conditions cannot |
| | | happen simultaneously. For more information, see |
| | | “Start Conditions” discussion on page nn. |

### Flow Control Operations

TABLE 60

| Instruction | WDR | Offset Address | Conditions |
|---|---|---|---|
| (31:27) | (26) | (26:8) | (7:0) |
| 01100 - BCL | b | aa aaaa aaaa aaaa | g3 g2 g1 g0 tc wd |
| | | aaaa | q2 q1 |

BCL (Branch if Condition LOW) // if LOW: PC += Offset Address

The selected conditions are tested immediately against the source signals to determine if the branch is to be taken or not. If all conditions are not met, the branch is taken. Non-selected conditions are ignored; thus a BCL with no conditions would always branch. If the selected conditions are met, the instruction processing continues at the next subsequent instruction.

TABLE 61

| Instruction | WDR | Offset Address | Conditions |
|---|---|---|---|
| (31:27) | (26) | (26:8) | (7:0) |
| 01101 - BCH | b | aa aaaa aaaa aaaa | g3 g2 g1 g0 tc wd |
| | | aaaa | q2 q1 |

BCH (Branch if Condition HIGH) // if HIGH: PC += Offset Address

The selected conditions are tested immediately against the source signals to determine if the branch is to be taken or not. If all conditions are met, the branch is taken. Non-selected conditions are ignored; thus a BCH with no conditions would always branch. If the selected conditions are not met, the instruction processing continues at the next subsequent instruction.

Here is a description for each of the fields of BCH and BCL.

TABLE 62

| | Value | |
|---|---|---|
| Field | or | |
| Name | Range | Function |
| WDR | | |
| | b = 0 | Watchdog is not reset on this operation |
| | b = 1 | Watchdog is reset to last loaded full count, |
| | | WD status is cleared |
| Offset | | |
| Address | | |
| | 0x00000 | Positive offset, added to the Program Counter (PC) |
| | through | if the conditions of the instruction are met. Since the |
| | 0x1FFFF | instructions are 32-bit word aligned, this value |
| | | represents the word, not byte, offset. Thus a |
| | | 0x00000 would not increase the (post increment) |
| | | PC, while 0x00002 would add 8 to the (post |
| | | increment) PC, skipping two instructions. |
| | 0x20000 | Negative offset, added to the Program Counter (PC) |
| | through | if the conditions of the instruction are met Since the |
| | 0x3FFFF | instructions are 32-bit word aligned, this value |
| | | represents the word, not byte, offset. Thus a |
| | | 0x3FFFF would decrease the (post increment) PC by |
| | | 4, causing the Branch instruction to loop until the |
| | | conditions were invalid. A value of 0x3FFF0 would |
| | | adjust the PC to point to the 15^{th} prior instruction |
| Condi- | | |
| tions | | |
| | xx | For each of the 8 conditions, a “0” denotes a “Don't |
| | | Care” while a “1” indicates the condition must |
| | | be met if the Branch is to be executed, otherwise the |
| | | PC continues with the next sequential instruction. |
| | | Note: This is different from “Start Conditions” used |
| | | in other instructions in that the condition test is |
| | | immediate and only happens once. For more |
| | | information, see “Flow Control Conditions” |
| | | discussion on page nn. |

TABLE 63

| Instruction | WDR | Offset Address | Conditions |
|---|---|---|---|
| (31:27) | (26) | (26:8) | (7:0) |
| 01110 - HBL | b | aa aaaa aaaa aaaa | g3 g2 g1 g0 tc wd |
| | | aaaa | q2 q1 |

HBL (Halt if Condition LOW) // if LOW: HALT, ELSE PC +=Offset

The selected conditions are tested immediately against the source signals to determine if the branch is to be taken or not. If all conditions are not met, the instruction processing is halted. Non-selected conditions are ignored; thus a HBL with no conditions would halt instruction processing. If the selected conditions are met, the instruction processing continues at the offset address.

TABLE 64

| Instruction | WDR | Offset Address | Conditions |
|---|---|---|---|
| (31:27) | (26) | (26:8) | (7:0) |
| 01111 - HBH | b | aa aaaa aaaa aaaa | g3 g2 g1 g0 tc wd |
| | | aaaa | q2 q1 |

HBT (Halt if Condition HIGH) // if HIGH: HALT, ELSE PC +=Ofset

HBT (Halt if Condition HIGH) //if HIGH: HALT, ELSE PC+=Offset

The selected conditions are tested immediately against the source signals to determine if the branch is to be taken, or not. If all conditions are met, the instruction processing is halted. Non-selected conditions are ignored; thus a HBH with no conditions would halt instruction processing. If the selected conditions are not met, the instruction processing continues at the offset address.

Below is a description for each of the fields of HBH and HBL.

TABLE 65

| | Value | |
|---|---|---|
| Field | or | |
| Name | Range | Function |
| WDR | | |
| | b = 0 | Watchdog is not reset on this operation |
| | b = 1 | Watchdog is reset to last loaded full count, |
| | | WD status is cleared |
| Offset | | |
| Address | | |
| | 0x00000 | Positive offset, added to the Program Counter (PC) |
| | through | if the conditions of the instruction are met. Since the |
| | 0x1FFFF | instructions are 32-bit word aligned, this value |
| | | represents the word, not byte, offset. Thus a |
| | | 0x00000 would not increase the (post increment) |
| | | PC, while 0x00002 would add 8 to the (post |
| | | increment) PC, skipping two instructions. |
| | 0x20000 | Negative offset, added to the Program Counter (PC) |
| | through | if the conditions of the instruction are met. Since the |
| | 0x3FFFF | instructions are 32-bit word aligned, this value |
| | | represents the word, not byte, offset. Thus a |
| | | 0x3FFFF would decrease the (post increment) |
| | | PC by 4, causing the Branch instruction to loop until |
| | | the conditions were invalid. A value of 0x3FFF0 |
| | | would adjust the PC to point to the 15^{th} prior |
| | | instruction. |
| Condi- | | |
| tions | | |
| | xx | For each of the 8 conditions, a “0” denotes a “Don't |
| | | Care” while a “1” indicates the condition must if the |
| | | Halt is to be executed, otherwise the PC continues |
| | | with the instruction at PC+Offset Address. Note: |
| | | This is different from “Start Conditions” used in |
| | | other instructions in that the condition test is |
| | | immediate and only happens once. For more |
| | | information, see “Flow Control Conditions” |
| | | discussion on page nn. |

TABLE 66

| | [not | | | |
|---|---|---|---|---|
| Instruction | used] | [not used] | Delay Count | [not used] |
| (31:27) | (26) | (25:18) | (17:8) | (7:0) |
| 11111 - DLY | — | — | cc cccc cccc | — |

DLV (Delay) // Wait awhile before proceeding.

The delay instruction is used when the CRISP processor, rather than the MicroDisplay's built-in timing parameters are controlling all display timing.

Below is a description for each of the fields of DLY.

TABLE 67

| | Value | |
|---|---|---|
| Field | or | |
| Name | Range | Function |
| Delay | | |
| Time | | |
| | 0x000 | The period for which the flow of instructions is delayed = |
| | through | ((this hex value+1) × 256 clocks); under normal |
| | 0x3FF | operating conditions this is about 4 uSec per count. |

### Color Rich Internal System Processor (CRISP)

### Introduction

The Color Rich Internal System Processor, or CRISP, is a very small instruction set processor used primarily to drive DMA transfers from memory to the Microdisplay. CRISP is the part of the Color Rich ASIC (CRASIC) that programmatically controls the operation of the Microdisplay and AIC.

Experience with the DB1-plus demonstrated the power and flexibility of “DMA List Processing”. CRISP leverages that experience and expands processing capabilities with the addition of a few Boolean operations and a simplified dithering algorithm. These new operations can be applied to image data as it is moved from memory to memory or memory to the Microdisplay.

CRISP is designed to handle directly a simple 512-Color mode of operation, but is flexible enough to also manage higher color operations. With its simple instruction set it can also vastly simplify cursor tracking, fonts, multiple screen and window management for the Host.

In addition, it may be possible to create a simplified (host) software interface to enable display module customers to develop products without having to understand the “nitty-gritty” details of the Microdisplay or AIC. They wouldn't even need to learn the internal operation of CRISP, only the external interface of the CRASIC. The CRISP programming can either be “booted” from an I\hat{0}2C EEPROM, or downloaded by the host driver at initialization.

### Design Considerations

For the CRASIC to deliver a complete Color-Rich solution for customers, it must simplify both hardware and software development. For the hardware side, it can standardize the way Color Rich mode is implemented. For the software side, it can eliminate the need for separating out color plains and provide automatic conversion from industry standard pixel definitions to the Display System's way of doing things.

The following is a list, in no particular order, of functional desires and/or requirements:

Support for at least 512 Colors (minimum to claim “Color Rich”)

Conversion from 8, 16, and 24 bits per pixel to Color Rich.

Color Palettes and real time Dithering

Support for two Displays, simultaneously

System must be capable of video frame-rate image throughput

Low power consumption while display image is static

Support for Fonts, Cursors, Windows, etc . . .

Flexible enough to allow higher-than-512 Color modes (e.g. more than 3 bits used per color plain).

Other considerations, in no particular order:

Schedule (e.g. keep it simple, stupid)

32-bit bus to maximize throughput—instructions would ideally be 32-bit as well.

Keeping buffer memory addressing flexible (e.g. avoiding hard coded address maps for what part of RAM is used for what.)

An integrated “Watch-Dog” to avoid burning the display

Avoid necessity of complex calculations, if possible.

### CRISP Memory Map

The CRISP memory map refers to RAM and memory mapped devices (AIC, etc.) controlled directly by the Color Rich ASIC. RAM is used primarily for CRISP programs, cursors and display buffers, but could also be used as buffer by the host processor for fonts, audio data, etc.

The external interface for the Color Rich ASIC provides the means for a host processor to access the entire contents of the CRISP memory. The CRASIC external interface registers (some of which control CRISP itself) are also fully accessible to CRISP programs.

The memory map is as follows:

TABLE 68

| Addr Range | Device Name | Description |
|---|---|---|
| 0x000000 | SDRAM | Must be at least 512K to support “Color Rich”, but can |
| thru | | be as large as 8 Mb. Used for display buffers, cursors, |
| 0x7FFFFF | | palettes, etc. |
| 0x800000 | Display memory [Right | Organization of memory depends on the mode. |
| thru | Device] | |
| 0x8FFFFF | | |
| 0x900000 | Display memory [Left | Organization of memory depends on mode. |
| thru | Device] | |
| 0x9FFFFF | | |
| 0xA00000 | Display memory [Both | Organization of memory depends on mode. |
| thru | Devices - Write Only] | |
| 0xAFFFFF | | |
| 0xB00000 | Auxiliary device | This is undefined at this time. It might be used for |
| thru | | audio, or as a high-speed data transport device such as |
| 0xB7FFFF | | Fire-Wire that could benefit from CRISP's DMA |
| | | capabilities. It could be serviced by display memory |
| | | FIFO, using all the same signals. |
| 0xB80000 | DAPPER Color Palette (8- | All 256 locations are used to hold the palette. These |
| thru | bit to 24-bit Lookup | registers are write-only. |
| 0xFFFFFF | Table) | |
| 0xC00000 | AIC registers | Up to 256 8-bit registers. Registers appear in least |
| thru | [Left Device] | significant byte of 32-bit word access. |
| 0xC7FFFF | | |
| 0xC80000 | Registers | Up to 256 8-bit registers. Registers appear in least |
| thru | [Left Device] | significant byte of 32-bit word access. |
| 0xCFFFFF | | |
| 0xD00000 | AIC registers | Up to 256 8-bit registers. Registers appear in least |
| thru | [Right Device] | significant byte of 32-bit word access. |
| 0xD7FFFF | | |
| 0xD80000 | Registers | Up to 256 8-bit registers. Registers appear in least |
| thru | [Right Device] | significant byte of 32-bit word access. |
| 0xDFFFFF | | |
| 0xE00000 | AIC registers | Up to 256 8-bit registers. Registers appear in least |
| thru | [Both Devices - Write | significant byte of 32-bit word access. |
| 0xE7FFFF | Only] | |
| 0xE80000 | Registers | Up to 256 8-bit registers. Registers appear in least |
| thru | [Both Devices - Write | significant byte of 32-bit word access. |
| 0xEFFFFF | Only] | |
| 0xF00000 | CRISP and DAPPER | Up to 256 registers. Registers may be up to 32-bits. |
| thru | registers | While primarily used by CRISP, these registers are |
| 0xF7FFFF | | fully visible to the Host processor. |
| 0xF80000 | CRASIC External inter- | These are always readily accessible to the host |
| thru | face and GLU | processor. They are only accessible to CRISP thru Data |
| 0xBFFFFF | peripheral registers | Transfer operations such as the MOV instruction. |

### CRISP Instruction Start Conditions

Note: the pin definition for the FPGA that is to emulate the Color Rich ASIC does not include all the specific display system signals discussed here. It does, however, include eight generic I/O bits that could be used for these signals. All of these signals could be detected using the system's interrupt capability, but that increases the complexity of CRISP programming.

The majority of CRISP instructions have a field called Start Conditions. This field specifies which signal(s) must be “true” before the instruction is allowed to execute. The instruction, in essence, halts the CRISP processor until the conditions are satisfied. Note, however, that a Watch-Dog timer can prevent the processor from hanging indefinitely in the event that the specified signals never come “true”.

The start condition(s) to be tested are specified in the instruction as a “1”, while conditions to be ignored are “0”.

With the exception of the ITO signals, all signals are “true” when they are “asserted” by the Display System, and Watch-Dog timer. The ITO signals are considered “true” each time it changes polarity (see table below).

This capability allows for precise synchronization of display data transfers between buffer memory and the Microdisplay(s). Registers for all devices may also require synchronous updates according to the state of the Display System.

TABLE 69

| Start | | |
|---|---|---|
| Condition | Source Signal | Notes |
| GPIO_3 | GPIO_3 | “True” when high. |
| GPIO_2 | GPIO_2 | “True” when high. |
| GPIO_1 | GPIO_1 | “True” when high. |
| GPIO_0 | GPIO_0 | “True” when high. |
| WDTO | WD timer | Watch-Dog timeout. This signal is useful |
| | | only if AUXCON register, WDENBL = |
| | | 0; otherwise timeout will cause an |
| | | ABORT interrupt. |
| QRQ_2 | Interrupt | “True” when Secondary interrupt line is low. |
| QRQ_1 | Interrupt | “True” when Primary interrupt line is low. |

### CRISP Branch Conditions

Note: the pin definition for the FPGA that is to emulate the Color Rich ASIC does not include all the specific signals discussed here. It does, however, include eight generic I/O bits that could be used for these signals. All of these signals could be detected using register accesses with CRISP's TST instruction, but that increases the complexity of CRISP programming.

The CRISP flow control instructions have Branch Conditions, instead of Start Conditions. Branch Conditions are immediately tested and the instruction executes according to the results of the test (see Flow Control Instructions for details). Flow control instructions allow for more complex “real-time” programs, such as automatically updating a cursor's screen position or preparing new host data for display, utilizing the time between field updates.

The branch condition(s) to be tested are specified in the instruction as a “1”, while conditions to be ignored are “0”. Unlike Start Conditions, Branch Conditions are tested as either “High” or “Low”, not “True” or “False”. The actual state of a tested flag or signal is what is important.

TABLE 70

| Branch | | |
|---|---|---|
| Condition | Source Signal | Notes |
| TCC | — | Condition code set by TST instruction. |
| GPIO_3 | GPI_3 | General Purpose Input / Output 3 state. |
| GPIO_2 | GPI_2 | General Purpose Input / Output 2 state. |
| GPIO_1 | GPI_1 | General Purpose Input / Output 1 state. |
| GPIO_0 | GPI_0 | General Purpose Input / Output 0 state. |
| WDTO | WD timer | Watch-Dog timeout. This signal is useful |
| | | only if AUXCON register, WDENBL = |
| | | 0; otherwise timeout will cause an ABORT |
| | | interrupt. |
| QRQ_2 | Interrupt | Secondary IRQ state. |
| QRQ_1 | Interrupt | Primary IRQ state. |

### Instruction Set Summary

CRA register

TABLE 71

| Spare | Instruction | CRA Reg | Address |
|---|---|---|---|
| (31) | (30:27) | (26:24) | (23:0) |
| 0 | 0000 - | nnn | aaaa aaaa aaaa aaaa aaaa aaaa |
| | LDR | | |
| 0 | 0001 - | nnn | aaaa aaaa aaaa aaaa aaaa aaaa |
| | STR | | |

These instruction moves the data found at the specified Address to/from one of up to eight registers in the CRISP. In this discussion only 4 registers are defined.

Data Transfer Operations

TABLE 72

| | | | Addr | Move | Skip | |
|---|---|---|---|---|---|---|
| Spare | Instruction | WDR | Mode | Count | Count | Start Conditions |
| (31) | (30:27) | (26) | (25:24) | (23:16) | (15:8) | (7:0) |
| 0 | 0010 - | b | Src Dst | cccc | ssss ssss | na g3 g2 g1 g0 |
| | MOP | | | cccc | | wd q2 q1 |
| 0 | 0011 - | b | Src Dst | cccc | ssss ssss | na g3 g2 g1 g0 |
| | MOV | | | cccc | | wd q2 q1 |
| 0 | 0100 - | b | Src Dst | cccc | ssss ssss | na g3 g2 g1 g0 |
| | NOT | | | cccc | | wd q2 q1 |
| 0 | 0101 - | b | Src Dst | cccc | ssss ssss | na g3 g2 g1 g0 |
| | AND | | | cccc | | wd q2 q1 |
| 0 | 0110 - | b | Src Dst | cccc | ssss ssss | na g3 g2 g1 g0 |
| | XOR | | | cccc | | wd q2 q1 |
| 0 | 0111 - | b | Src Dst | cccc | ssss ssss | na g3 g2 g1 g0 |
| | ORR | | | cccc | | wd q2 q1 |

These instructions move data from one part of memory to another, or to memory mapped devices such as the Microdisplay. Some of the instructions combine source and destination data using Boolean operators.

Immediate Data Operations (for control registers on the Microdisplay, AIC, CRISP, AUX)

TABLE 73

| | | | Device | | |
|---|---|---|---|---|---|
| Spare | Instruction | Dev Sel | Address | Data | Start Conditions |
| (31) | (30:27) | (26:24) | (23:16) | (15:8) | (7:0) |
| 0 | 1000 - | nnn | aaaa | dddd dddd | na g3 g2 g1 g0 wd q2 |
| | LDC | | aaaa | | q1 |
| 0 | 1001 - | nnn | aaaa | dddd dddd | na g3 g2 g1 g0 wd q2 |
| | SET | | aaaa | | q1 |
| 0 | 1010 - | nnn | aaaa | dddd dddd | na g3 g2 g1 g0 wd q2 |
| | CLR | | aaaa | | q1 |
| 0 | 1011 - | nnn | aaaa | dddd dddd | na g3 g2 g1 g0 wd q2 |
| | TST | | aaaa | | q1 |

These instructions operate on 8-bit registers found on the Microdisplay, AIC, CRISP, and an additional (TBD) device.

Flow Control Operations

TABLE 74

| Spare | Instruction | WDR | Offset Address | Conditions |
|---|---|---|---|---|
| (31) | (30:27) | (26) | (25:8) | (7:0) |
| 0 | 1100 - | b | aa aaaa aaaa aaaa aaaa | tc g3 g2 g1 g0 |
| | BCL | | | wd q2 q1 |
| 0 | 1101 - | b | aa aaaa aaaa aaaa aaaa | tc g3 g2 g1 g0 |
| | BCH | | | wd q2 q1 |

These instructions provide program flow control to create loops and conditional execution.

Timing Control Operations

TABLE 75

| Spare | Instruction | WDR | [not used] | Count | Start Conditions |
|---|---|---|---|---|---|
| (31) | (30:27) | (26) | (25:16) | (15:8) | (7:0) |
| 0 | 1110 - | b | — | cccc | na g3 g2 g1 g0 wd q2 q1 |
| | DLY | | | cccc | |
| 0 | 1111 - | b | — | — | na g3 g2 g1 g0 wd q2 q1 |
| | NOP | | | | |

### Instruction Set Details

Load CRA Register

TABLE 76

| Spare | Instruction | CRA Reg | Address |
|---|---|---|---|
| (31) | (30:27) | (26:24) | (23:0) |
| 0 | 0000 - | nnn | aaaa aaaa aaaa aaaa aaaa aaaa |
| | LDR | | |

| | |
|---|---|
| LDR reg, address | // address (data)−>reg |

Data found at the Address location specified is loaded to specified register. The details of each of this instruction's fields may be found below.

Store CRA Register

TABLE 77

| Spare | Instruction | CRA Reg | Address |
|---|---|---|---|
| (31) | (30:27) | (26:24) | (23:0) |
| 0 | 0001 - | nnn | aaaa aaaa aaaa aaaa aaaa aaaa |
| | STR | | |

| | |
|---|---|
| STR reg, address | // reg−>mem address |

The contents of the specified register is written to memory at the specified address.

Illustrative values designating CRA registers (nnn) are as follows:

TABLE 78

| | Register | |
|---|---|---|
| nnn | Name | Actual Size - Usage |
| 000 | Source | 24 bits - Starting address value used by “Memory to |
| | Pointer | Microdisplay” and “Memory to Memory” |
| | | operations as the data source memory address. Note: |
| | | the low order two bits of loaded value are ignored |
| | | because all transfers must be 32-bit word aligned. |
| 001 | Destination | 24 bits - Starting address value used by “Memory to |
| | Pointer | Microdisplay” and “Memory to Memory” |
| | | operations as the data destination memory address. |
| | | Note: the low order two bits of loaded value are |
| | | ignored because all transfers must be 32-bit word |
| | | aligned. |
| 010 | Transfer | 22 bits - Used by “Memory to Microdisplay” and |
| | Count | “Memory to Memory” operations as a byte count |
| | | for the entire transfer operation. The upper 2 unused |
| | | bits (of the 24-bit field) are ignored, but should be |
| | | set to zero for future compatibility. Note: the low |
| | | order two bits of loaded value are ignored because |
| | | all transfers are 32-bit data operations. |
| 011 | Program | 24 bits - This is the CRISP Program counter. An |
| | Counter | LRI to this register is effectively a JMP indirect. |
| | | Note: the low order two bits of loaded value are |
| | | ignored because instructions must be 32-bit word |
| | | aligned. |
| 1xx | Undefined | These four register addresses are reserved for future |
| | | expansion. |

### Data Transfer Operations

TABLE 79

| | | | Addr | Move | Skip | |
|---|---|---|---|---|---|---|
| Spare | Instruction | WDR | Mode | Count | Count | Start Conditions |
| (31) | (30:27) | (26) | (25:24) | (23:16) | (15:8) | (7:0) |
| 0 | 0010 - | b | Src Dst | cccc | ssss ssss | na g2 g1 wd i2 |
| | MOV | | | cccc | | q2 i1 q1 |

MOV wdr, smode, dmode, mCount, sCount, conditions // Src−>Dst

This instruction copies “Transfer Count” bytes from “Source Address” memory to “Destination Address” memory according to SRC and DST “Addr Mode” settings. The destination data should be the same as the source data. The details of each of this instruction's fields may be found below.

TABLE 80

| | | | Addr | Move | Skip | |
|---|---|---|---|---|---|---|
| Spare | Instruction | WDR | Mode | Count | Count | Start Conditions |
| (31) | (30:27) | (26) | (25:24) | (23:16) | (15:8) | (7:0) |
| 0 | 0011 - | b | Src Dst | cccc | ssss ssss | na g2 g1 wd i2 |
| | MPI | | | cccc | | q2 i1 q1 |

MPI wdr, smode, dmode, mCount, sCount, conditions // Src−>Dst
“Move and Process Image” passes source data through the Palette and Bias-grid before depositing results at the destination. Note that the destination will contain only half the number of words as the source, due to this process (see details of Pallets and Dithering on page nn).

Here is a breakdown of each of the fields for MOV and MPI:

TABLE 81

| | Value | |
|---|---|---|
| Field | or | |
| Name | Range | Function |
| WDR | b = 0 | Watchdog is not reset on this operation |
| | b = 1 | Watchdog is reset to last loaded full count, WD |
| | | status is cleared |
| Addr | SRC = 0 | Source / Destination Addresses are incremented |
| Mode | DST = 0 | normally (e.g. +4 bytes for each 32-bit transfer) |
| | | for the duration of the transfer. |
| | SRC = 1 | After each 32-bit move the Source / Destination |
| | DST = 1 | Address is incremented by 4 (to next word ad- |
| | | dress), and the “Move Count” is decremented |
| | | by 1. When “Move Count” is exhausted, it is |
| | | reset to it's original value, and the Source / |
| | | Destination Address is incremented by “Skip |
| | | Count”. |
| Move | 0-0xFF | When SRC and / or DST Addr Mode is “1”, this |
| Count | | value is used to load a count-down counter to |
| | | track 32-bit transfers. Upon reaching zero, each |
| | | affected Address register is incremented by “Skip |
| | | Count”, and the counter is reloaded to begin |
| | | count-down again. |
| Skip | 0-0xFF | When SRC and/or DST Addr Mode is “1”, this |
| Count | | value is used to increment each affected Address |
| | | register. |
| Start | xx | For each of the 8 start conditions, a “0” |
| Conditions | | denotes a “Don't Care” while a “1” |
| | | indicates the condition must be met (e.g. |
| | | condition is “True”) before the instruction is |
| | | executed. Note: some conditions cannot happen |
| | | simultaneously. For more information, see “Start |
| | | Conditions” discussion on page nn. |

TABLE 82

| | | | Addr | Move | Skip | |
|---|---|---|---|---|---|---|
| Spare | Instruction | WDR | Mode | Count | Count | Start Conditions |
| (31) | (30:27) | (26) | (25:24) | (23:16) | (15:8) | (7:0) |
| 0 | 0100 - | b | Src Dst | cccc | ssss ssss | na g2 g1 wd i2 |
| | NOT | | | cccc | | q2 i1 q1 |

NOT wdr, smode, dmode, mCount, sCount, conditions // !Src−>Dst

This instruction transfers “Transfer Count” bytes from “Source Address” memory to “Destination Address” memory according to SRC and DST “Addr Mode” settings. The destination data is INVERTed from the source data. The details of each of this instruction's fields may be found below.

TABLE 83

| | | | Addr | Move | Skip | |
|---|---|---|---|---|---|---|
| Spare | Instruction | WDR | Mode | Count | Count | Start Conditions |
| (31) | (30:27) | (26) | (25:24) | (23:16) | (15:8) | (7:0) |
| 0 | 0101 - | b | Src Dst | cccc | ssss ssss | na g2 g1 wd i2 |
| | AND | | | cccc | | q2 i1 q1 |

AND wdr, smode, dmode, mCount, sCount, conditions // Src & Dst−>Dst

This instruction transfers “Transfer Count” bytes from “Source Address” memory to “Destination Address” memory according to SRC and DST “Addr Mode” settings. The prior data at the destination address is ANDed with the source data, then stored at the destination address.

Here is a breakdown of each of the fields for NOT and AND:

TABLE 84

| | Value | |
|---|---|---|
| Field | or | |
| Name | Range | Function |
| WDR | b = 0 | Watchdog is not reset on this operation |
| | b = 1 | Watchdog is reset to last loaded full count, WD |
| | | status is cleared |
| Addr | SRC = 0 | Source / Destination Addresses are incremented |
| Mode | DST = 0 | normally (e.g. +4 bytes for each 32-bit |
| | | transfer) for the duration of the transfer. |
| | SRC = 1 | After each 32-bit move the Source / Destination |
| | DST = 1 | Address is incremented by 4 (to next word ad- |
| | | dress), and the “Move Count” is decremented |
| | | by 1. When “Move Count” is exhausted, it is |
| | | reset to it's original value, and the Source / |
| | | Destination Address is incremented by “Skip |
| | | Count”. |
| Move | 0-0xFF | When SRC and / or DST Addr Mode is “1”, this |
| Count | | value is used to load a count-down counter to |
| | | track 32-bit transfers. Upon reaching zero, each |
| | | affected Address register is incremented by |
| | | “Skip Count”, and the counter is reloaded to |
| | | begin count-down again. |
| Skip | 0-0xFF | When SRC and/or DST Addr Mode is “1”, this |
| Count | | value is used to increment each affected Address |
| | | register. |
| Start | xx | For each of the 8 start conditions, a “0” denotes |
| Conditions | | a “Don't Care” while a “1” indicates the |
| | | condition must be met (e.g. condition is “True”) |
| | | before the instruction is executed. Note: some |
| | | conditions cannot happen simultaneously. For |
| | | more information, see “Start Conditions” |
| | | discussion on page nn. |

### Data Transfer Operations (continued)

TABLE 85

| | | | Addr | Move | Skip | |
|---|---|---|---|---|---|---|
| Spare | Instruction | WDR | Mode | Count | Count | Start Conditions |
| (31) | (30:27) | (26) | (25:24) | (23:16) | (15:8) | (7:0) |
| 0 | 0110 - | b | Src Dst | cccc | ssss ssss | na g2 g1 wd i2 |
| | XOR | | | cccc | | q2 i1 q1 |

XOR wdr, smode, dmode, mCount, sCount, conditions // SrcDst−>Dst

This instruction transfers “Transfer Count” bytes from “Source Address” memory to “Destination Address” memory according to SRC and DST “Addr Mode” settings. The prior data at the destination address is EXCLUSIVE-ORed with the source data, then stored at the destination address. The details of each of this instruction's fields may be found below.

TABLE 86

| Spar | | WD | Addr | | Skip | |
|---|---|---|---|---|---|---|
| e | Instruction | R | Mode | Move Count | Count | Start Conditions |
| (31) | (30:27) | (26) | (25:24) | (23:16) | (15:8) | (7:0) |
| 0 | 0111 - | b | Src Dst | cccc cccc | ssss ssss | na g2 g1 wd i2 q2 i1 q1 |
| | ORR | | | | | |

ORR wdr, smode, dmode, mCount, sCount, conditions // Src | Dst −> Dst

This instruction transfers “Transfer Count” bytes from “Source Address” memory to “Destination Address” memory according to SRC and DST “Addr Mode” settings. The prior data at the destination address is ORed with the source data, then stored at the destination address.

Here is a breakdown of each of the fields for XOR and ORR:

TABLE 87

| | Value | |
|---|---|---|
| Field | or | |
| Name | Range | Function |
| WDR | b=0 | Watchdog is not reset on this operation |
| | b=1 | Watchdog is reset to last loaded full count, |
| | | WD status is cleared |
| Addr | SRC = | Source/Destination Addresses are incremented normally |
| Mode | 0 DST = | (e.g. +4 bytes for each 32-bit transfer) for the duration of |
| | 0 | the transfer. |
| | SRC=1 | After each 32-bit move the Source/Destination Address |
| | DST=1 | is incremented by 4 (to next word address), and the |
| | | “Move Count” is decremented by 1. When “Move |
| | | Count” is exhausted, it is reset to it's original value, and |
| | | the Source/Destination Address is incremented by “Skip |
| | | Count”. |
| Move | 0-0×FF | When SRC and/or DST Addr Mode is “1”, this value is |
| Count | | used to load a count-down counter to track 32-bit |
| | | transfers. Upon reaching zero, each affected Address |
| | | register is incremented by “Skip Count”, and the counter |
| | | is reloaded to begin count-down again. |
| Skip | 0-0×FF | When SRC and/or DST Addr Mode is “1”, this value is |
| Count | | used to increment each affected Address register. |
| Start | xx | For each of the 8 start conditions, a “0” denotes a “Don't |
| Conditions | | Care” while a “1” indicates the condition must be met |
| | | (e.g. condition is “True”) before the instruction is |
| | | executed. Note: some conditions cannot happen |
| | | simultaneously. For more information, see “Start |
| | | Conditions” discussion on page nn. |

### Immediate Data Operations

TABLE 88

| Spar | | | Device | | |
|---|---|---|---|---|---|
| e | Instruction | Dev Sel | Address | Data | Start Conditions |
| (31) | (30:27) | (26:24) | (23:16) | (15:8) | (7:0) |
| 0 | 1000- | nnn | aaaa aaaa | dddd dddd | na I Q W L R G B |
| | LDC | | | | |

LDC dSel, dAddr, data, conditions // data −−> regAddr

This instruction writes the immediate Data to the specified device register address (regAddr). The details of each of this instruction's fields may be found below.

TABLE 89

| Spar | | | | | |
|---|---|---|---|---|---|
| e | Instruction | Dev Sel | Device Address | Data | Start Conditions |
| (31) | (30:27) | (26:24) | (23:16) | (15:8) | (7:0) |
| 0 | 1001- | nnn | aaaa aaaa | dddd dddd | na g2 g1 wd i2 q2 i1 q1 |
| | SET | | | | |

SET dSel, dAddr, data, conditions // data | regAddr −−> regAddr

This instruction ORs the immediate Data with the specified device register address (regAddr), then writes the result to that same device register address.

Here is a breakdown of each of the fields for LDC and SET:

TABLE 90

| | Value | |
|---|---|---|
| Field | or | |
| Name | Range | Function |
| DevSel | 00x | Registers selected (see also CRISP Control & |
| | | Status registers, AUXCON) x = left or right |
| | | device |
| | 01x | AIC parallel interface selected (see also |
| | | CRISP Control & Status registers, AUXCON) x = |
| | | left or right device |
| | 100 | Registers selected (see also |
| | | CRISP Control & Status registers, AUXCON) |
| | | Both L & R devices are selected. |
| | 101 | AIC parallel interface selected (see also |
| | | CRISP Control & Status registers, AUXCON) |
| | | Both L & R devices are selected. |
| | 110 | Auxiliary device selected |
| | 111 | Color Rich ASIC selected (internal 8-bit |
| | | registers - see page nn) |
| Device | 0-0xFF | 8 bit address of device. (see also CRISP Control |
| Address | | & Status registers, AUXCON) |
| Data | 0-0xFF | 8 bit data to be used with device register. |
| | | For LDC, this value is written to the device |
| | | register. For SET, each bit that is a “1” |
| | | is set in the device register, while “0” bits |
| | | are left unchanged. |
| Start | xx | For each of the 8 start conditions, a “0” denotes |
| Conditions | | a “Don't Care” while a “1” indicates the |
| | | condition must be met (e.g. condition is “True”) |
| | | before the instruction is executed. Note: some |
| | | conditions cannot happen simultaneously. For |
| | | more information, see “Start Conditions” |
| | | discussion on page nn. |

### Immediate Data Operations (continued)

TABLE 91

| Spar | Instruc- | | Device | | |
|---|---|---|---|---|---|
| e | tion | Dev Sel | Address | Data | Start Conditions |
| (31) | (30:27) | (26:24) | (23:16) | (15:8) | (7:0) |
| 0 | 1010- | nnn | aaaa aaaa | dddd dddd | na g2 g1 wd i2 |
| | CLR | | | | q2 i1 q1 |

CLR dSel, dAddr, data, conditions // !data & regAddr −−> regAddr

This instruction inverts the immediate Data, ANDs the result with the specified device register address (regAddr), then writes the result to that same device register address.

The details of each of this instruction's fields may be found below.

TABLE 92

| Spar | | | | | |
|---|---|---|---|---|---|
| e | Instruction | Dev Sel | Device Address | Data | Start Conditions |
| (31) | (30:27) | (26:24) | (23:16) | (15:8) | (7:0) |
| 0 | 1011- | nnn | a aaaa aaaa | dddd dddd | na g2 g1 wd i2 q2 i1 q1 |
| | TST | | | | |

TST dSel, dAddr, data, conditions // data & regAddr −−> TCC (affects

This instruction ANDs the immediate Data with specified device register. When the results are 0x00 the “TCC” bit of the condition register is cleared (false), otherwise it is set (true). The specified device register is unchanged by this operation.

Here is a breakdown of each of the fields for CLR and TST:

TABLE 93

| | Value | |
|---|---|---|
| Field | or | |
| Name | Range | Function |
| DevSel | 00x | Registers selected (see also CRISP Control |
| | | & Status registers, AUXCON) x = left or right |
| | | device |
| | 01x | AIC parallel interface selected (see also CRISP |
| | | Control & Status registers, AUXCON) x = left |
| | | or right device |
| | 100 | Registers selected (see also CRISP Control & |
| | | Status registers, AUXCON) Both L & R devices |
| | | are selected. |
| | 101 | AIC parallel interface selected (see also CRISP |
| | | Control & Status registers, AUXCON) Both L & |
| | | R devices are selected. |
| | 110 | Auxiliary device selected |
| | 111 | Color Rich ASIC selected (internal 8-bit |
| | | registers - see page nn) |
| Device | 0-0xFF | 8 bit address of device registers. (see also CRISP |
| Address | | Control & Status registers, AUXCON) |
| Data | 0-0xFF | 8 bit data to be used with device register. For |
| | | CLR, each bit that is a “1” is cleared in |
| | | the device register, while “0” bits are left |
| | | unchanged. For TST, this value is ANDed with |
| | | the device register and the TCC bit is set if the |
| | | result is not zero, otherwise TCC is cleared. |
| Start | xx | For each of the 8 start conditions, a “0” denotes |
| Conditions | | a “Don't Care” while a “1” indicates the |
| | | condition must be met (e.g. condition is “True”) |
| | | before the instruction is executed. Note: some |
| | | conditions cannot happen simultaneously. For |
| | | more information, see “Start Conditions” |
| | | discussion on page nn. |

### Flow Control Operations

TABLE 94

| Spare | Instruction | WDR | Offset Address | Conditions |
|---|---|---|---|---|
| (31) | (30:27) | (26) | (26:8) | (7:0) |
| 0 | 1100 - | b | aa aaaa aaaa aaaa aaaa | tc g2 g1 wd |
| | BCL | | | i2 q2 i1 q1 |

BCL (Branch if Condition LOW) // if LOW: PC += Offset Address

The selected conditions are tested immediately against the source signals to determine if the branch is to be taken or not. If all conditions are not met, the branch is taken. Non-selected conditions are ignored, thus a BCL with no conditions would always branch. If the selected conditions are met, the instruction processing continues at the next subsequent instruction.

TABLE 95

| Spare | Instruction | WDR | Offset Address | Conditions |
|---|---|---|---|---|
| (31) | (30:27) | (26) | (26:8) | (7:0) |
| 0 | 1101 - | b | aa aaaa aaaa aaaa aaaa | tc g2 g1 wd |
| | BCH | | | i2 q2 i1 q1 |

BCH (Branch if Condition HIGH) // if HIGH: PC += Offset Address

The selected conditions are tested immediately against the source signals to determine if the branch is to be taken or not. If all conditions are met, the branch is taken. Non-selected conditions are ignored, thus a BCH with no conditions would always branch. If the selected conditions are not met, the instruction processing continues at the next subsequent instruction.

Here is a description for each of the fields of BCH and BCL:

TABLE 96

| | Value | |
|---|---|---|
| Field | or | |
| Name | Range | Function |
| WDR | b=0 | Watchdog is not reset on this operation |
| | b=1 | Watchdog is reset to last loaded full count, |
| | | WD status is cleared |
| Offset | 0x0000 | Positive offset, added to the |
| Address | 0 thru | Program Counter (PC) if the conditions of |
| | 0x1FFFF | the instruction are met. Since the instructions are |
| | | 32-bit word aligned, this value represents |
| | | the word, not byte, offset. Thus a 0x00000 would |
| | | increase the (post increment) PC not at all, while |
| | | 0x00002 would add 8 to the (post increment) PC... |
| | | skipping 2 instructions. |
| | 0x2000 | Negative offset, added to the Program Counter (PC) |
| | 0 thru | if the conditions of the instruction are met. |
| | 0x3FFFF | Since the instructions are 32-bit word aligned, |
| | | this value represents the word, not byte, offset. |
| | | Thus a 0x3FFFF would decrease the |
| | | (post increment) PC by 4, causing the Branch |
| | | instruction to loop until the conditions were invalid. |
| | | A value of 0x3FFF0 would adjust the PC to |
| | | point to the 15^{th} prior instruction. |
| Condi- | xx | For each of the 8 conditions, a “0” denotes a |
| tions | | “Don't Care” while a “1” indicates |
| | | the condition must be met if the Branch is to be |
| | | executed, otherwise the PC continues with the next |
| | | sequential instruction. Note: This is different |
| | | from “Start Conditions” used in other instructions |
| | | in that the condition test is immediate and only |
| | | happens once. For more information, see “Flow |
| | | Control Conditions” discussion on page nn. |

TABLE 97

| Spare | Instruction | WDR | Offset Address | Conditions |
|---|---|---|---|---|
| (31) | (30:27) | (26) | (26:8) | (7:0) |
| 0 | 1110 - HBL | b | aa aaaa aaaa aaaa aaaa | tc g2 g1 wd i2 |
| | | | | q2 i1 q1 |

HBL (Halt if Condition LOW) // if LOW: HALT, ELSE PC +=Offset
Address

The selected conditions are tested immediately against the source signals to determine if the branch is to be taken or not. If all conditions are not met, the instruction processing is Halted. Non-selected conditions are ignored, thus a HBL with no conditions would Halt instruction processing. If the selected conditions are met, the instruction processing continues at the offset address.

TABLE 98

| Spare | Instruction | WDR | Offset Address | Conditions |
|---|---|---|---|---|
| (31) | (30:27) | (26) | (26:8) | (7:0) |
| 0 | 1111 - HBH | b | aa aaaa aaaa aaaa aaaa | na g2 g1 wd i2 |
| | | | | q2 i1 q1 |

HBT (Halt if Condition HIGH) // if HIGH: HALT, ELSE PC +=Offset
Address

The selected conditions are tested immediately against the source signals to determine if the branch is to be taken or not. If all conditions are met, the instruction processing is Halted. Non-selected conditions are ignored, thus a HBH with no conditions would Halt instruction processing. If the selected conditions are not met, the instruction processing continues at the offset address.

Here is a description for each of the fields of HBH and HBL:

TABLE 99

| | Value | |
|---|---|---|
| Field | or | |
| Name | Range | Function |
| WDR | b=0 | Watchdog is not reset on this operation |
| | b=1 | Watchdog is reset to last loaded full count, WD |
| | | status is cleared |
| Offset | 0x0000 | Positive offset, added to the |
| Address | 0 thru | Program Counter (PC) if the |
| | 0x1FFFF | conditions of the instruction are met. Since the |
| | | instructions are 32-bit word aligned, |
| | | this value represents the word, |
| | | not byte, offset. Thus a 0x00000 would |
| | | increase the (post increment) PC not at all, while |
| | | 0x00002 would add 8 to the (post increment) PC... |
| | | skipping 2 instructions. |
| | 0x2000 | Negative offset, added to the Program Counter (PC) |
| | 0 thru | if the conditions of the instruction are met. Since the |
| | 0x3FFFF | instructions are 32-bit word aligned, |
| | | this value represents the word, |
| | | not byte, offset. Thus a 0x3FFFF would |
| | | decrease the (post increment) PC by 4, causing the |
| | | Branch instruction to loop until the conditions were |
| | | invalid. A value of 0x3FFF0 would adjust the PC to |
| | | point to the 15^{th} prior instruction. |
| Condi- | xx | For each of the 8 conditions, a “0” denotes a “Don't |
| tions | | Care” while a “1” indicates the |
| | | condition must if the Halt is to be |
| | | executed, otherwise the PC continues with the |
| | | instruction at PC+Offset Address. |
| | | Note: This is different from |
| | | “Start Conditions” used in other instructions in |
| | | that the condition test is immediate and |
| | | only happens once. For more |
| | | information, see “Flow Control |
| | | Conditions” discussion on page nn. |

### CRASIC External Addressing

### CRASIC Chip Select Asserted

TABLE 100

| A23 | A22 | A21 | A20 | A19 | A18 | Select | Data Bits | Output Addr. Lines |
|---|---|---|---|---|---|---|---|---|
| 0 | X | X | X | X | X | SDRAM | D31:D0 | A22:A2(8Mb) |
| 1 | 0 | 0 | 0 | X | X | SRAM[Right] | D31:D0 | A19=0,A18:A2 |
| 1 | 0 | 0 | 1 | X | X | SRAM[Left] | D31:D0 | A19=0,A18:A2 |
| 1 | 0 | 1 | X | X | X | SRAM[Both*] | D31:D0 | A19=0,A18:A2 |
| 1 | 1 | 0 | 0 | 0 | X | CRISP** | D31:D0 | A11:A2** |
| 1 | 1 | 0 | 0 | 1 | X | CRASIC Regs | D31:D0 | A5:A2 |
| 1 | 1 | 0 | 1 | 0 | X | Auxiliary Dev | D31:D0 | A19:A2(S12Kb) |
| 1 | 1 | 0 | 1 | 1 | X | Iˆ 2C | D31:D0 | ? |
| 1 | 1 | 1 | 0 | 0 | 0 | Regs[Right] | D7:D0 | A19=1,A11:A2 |
| 1 | 1 | 1 | 0 | 0 | 1 | Regs[Left] | D7:D0 | A19=1,A11:A2 |
| 1 | 1 | 1 | 0 | 1 | X | Regs[Both*] | D7:D0 | A19=1,A11:A2 |
| 1 | 1 | 1 | 1 | 0 | 0 | AIC Regs[Right] | D7:D0 | A11-A2 |
| 1 | 1 | 1 | 1 | 0 | 1 | AIC Regs[Left] | D7:D0 | A11-A2 |
| 1 | 1 | 1 | 1 | 1 | X | AIC Regs[Both*] | D7:D0 | A11-A2 |

*Write Only
**Not normally accessible to external processor. These register are READ ONLY while CRISP is in RUN mode (see CCR). They may be changed by the Host CPU only while CRISP is in HOLD mode.

### CRASIC Registers Selected (All registers are “Little Endian”)

TABLE 101

| A5 | A4 | A3 | A2 | Register | Data Bits | Remarks |
|---|---|---|---|---|---|---|
| 0 | 0 | 0 | 0 | DPTR | D23:D2 | Auto Incr Addr Ptr used with |
| | | | | | | IDAT |
| 0 | 0 | 0 | 1 | DAT | D31:D0 | Data R/W to Addr pointed to by |
| | | | | | | DPTR |
| 0 | 0 | 1 | 0 | CSEM | D31:D0 | CRISP Operations Semaphore |
| 0 | 0 | 1 | 1 | CCR | D2:D0 | Control Register |
| 0 | 1 | 0 | 0 | IRQEN | D7:D0 | Interrupt Enables Register |
| 0 | 1 | 0 | 1 | IRQSC | D7:D0 | Interrupt Status (read), Clear |
| | | | | | | (Write Is) |
| 0 | 1 | 1 | 0 | TMR | D15:D0 | WatchDog/Timer Clock Tick |
| 0 | 1 | 1 | 1 | SPC | D23:D2 | CRISP Program Counter Start |
| | | | | | | Address |
| 1 | X | X | X | <Spare> | — | Spare register space reserved for |
| | | | | | | future expansion. |

| | |
|---|---|
| DPTR and IDAT | The data pointer (DPTR) provides a R/W address |
| | for transfers to and from SDRAM via |
| | the DAT register. The DPTR is |
| | automatically incremented by 4 bytes subsequent |
| | to each transfer. |
| CSEM | General purpose semaphore register set/cleared |
| | by both CRISP and system processor |
| CCR | The Control register controls the activity state |
| | of the CRISP processor. |

TABLE 102

| Bit | Name | Function |
|---|---|---|
| 2 | STEP | Write of 1 executes a single Opcode, self clearing |
| | | upon completion. (HOLD is set = 1) |
| 1 | HOLD | 0=RUN (continue), 1=HOLD (halt) CRISP |
| | | process |
| 0 | START | Start CRISP at new address (held in CPC register) |

| | |
|---|---|
| IRQEN | Enables for interrupt sources |
| IRQSC | Status of IRQs, a write of 1 resets/clears interrupt source |
| TMR | Clock scaler for CRISP watchdog/timer. This value is |
| | transferred to an internal Counter. Each time the counter |
| | “rolls over”, one “tick” is applied to CRISPs |
| | watchdog/timer register. |
| SPC | This register provides the start address for CRISP |
| | programs when enabled by the CCR's |
| | START bit (see CCR, above). All CRISP instructions |
| | are 32 bits, so this start address will always |
| | fall on a 4-byte boundary (e.g. A1 |
| | and A0 will always = 0). |

### CRISP Control & Status (8-bit registers)

Please note: the following are addressable with LDC, SET, CLR, or TST instructions. A10:A5 may be used for future expansion addressing, and should generally be programmed as zeros; the hardware may or may not decode these address bits in the various implementations.

TABLE 103

| | A10: | | | | | Data | |
|---|---|---|---|---|---|---|---|
| A11: | A5 | A4 | A3 | A2 | Register | Bits | Remarks |
| 0 | X | 0 | 0 | 0 | DEVCON | D7:D0 | Device Control |
| 0 | X | 0 | 0 | 1 | AUXCON | D6:D0 | Auxiliary Control |
| 0 | X | 0 | 1 | 0 | LSTAT | D5:D0 | Line Statuses (read- |
| | | | | | | | only) |
| 0 | X | 0 | 1 | 1 | WDCNT | D7:D0 | WatchDog/Timer |
| | | | | | | | Count |
| 0 | X | 1 | 0 | 0 | SEM0 | D7:D0 | Semaphore Register 0 |
| 0 | X | 1 | 0 | 1 | SEM1 | D7:D0 | Semaphore Register 1 |
| 0 | X | 1 | 1 | 0 | SEM2 | D7:D0 | Semaphore Register 2 |
| 0 | X | 1 | 1 | 1 | SEM3 | D7:D0 | Semaphore Register 4 |

| | |
|---|---|
| DEVCON | The Device Control register controls power, |
| | reset and clocks for the Display(s). |
| | All 8 bits are also mirrored in a CRASIC |
| | accessible (see CRASIC External Registers, CCR). |

TABLE 104

| Bit | Name | Function |
|---|---|---|
| 7 | DBT_2 | Clock Divide By 2 for Microdisplay [Left] |
| 6 | CLK_2 | Clock Enable for Microdisplay[ Left] |
| 5 | RST_2 | Reset Control for Microdisplay [Left] |
| 4 | PWR_2 | Power Enable for Microdisplay [Left] |
| 3 | DBT_1 | Clock Divide By 2 for Microdisplay [Right] |
| 2 | CLK_1 | Clock Enable for Microdisplay [Right] |
| 1 | RST_1 | Reset Control for Microdisplay [Right |
| 0 | PWR_1 | Power Enable for Microdisplay [Right |

| | |
|---|---|
| AUXCON | The Auxiliary Control register controls power and reset for the |
| | AIC, 2 GPOs (for an additional device), and behavior of the |
| | Watch-Dog/Timer function. |

TABLE 105

| Bit | Name | Function |
|---|---|---|
| 5 | WDRUN | Watch-Dog/Timer Run |
| 4 | WDENBL | Watch-Dog Abort Enable Abort - time out causes |
| | | abort and sets WD IRQ to host, if enabled. When |
| | | this bit is false the Watch-Dog Status is mapped |
| | | to AUX cc, allowing WD as a general purpose |
| | | program timer |
| 3 | GPO_2 | General Purpose Output 2 (could control reset for |
| | | additional device) |
| 2 | GPO_1 | General Purpose Output 1 (could control power |
| | | for additional device) |
| 1 | AICRST | Reset Control for AIC - if dual Displays are used, |
| | | this signal may be used for both AICs |
| 0 | AICPWR | Power Enable for AIC - if dual Displays are used, |
| | | this signal may be used for both AICs. |

| | |
|---|---|
| LSTAT | The Line Status register is read only states of various external |
| | signals from the Display(s) and the CRASIC itself. |

TABLE 106

| Bit | Name | Function |
|---|---|---|
| 7 | GPI_2 | General Purpose Input 2 |
| 6 | GPI_1 | General Purpose Input 1 |
| 5 | WDTO | Watch-Dog Timer Timed Out (This signal may or |
| | | may not be assigned an external CRASIC pin. It |
| | | may be cleared by writing to the WDCNT |
| | | register.) |
| 4 | CIRQ | CRASIC Interrupt line level |
| 3 | OITO_2 | ITO line level [Left] |
| 2 | OIRQ_2 | Interrupt line level [Left] |
| 1 | OITO_1 | ITO line level [Right] |
| 0 | OIRQ_1 | Interrupt line level [Right] |

| | |
|---|---|
| WDCNT | The Watch-Dog/Timer count is an 8 bit register |
| | whose value is transferred to a count-down counter |
| | each time a CRISP instruction with WDR=True is executed, |
| | or when this register is written. |
| SEMx | Semaphore registers. SEM0 corresponds to D7:D0; SEM1 to |
| | D15:D8; SEM2 to D23:D16; SEM3 to D31:D24 of the CSEM |
| | register (see CRASIC External Registers. CSEM). |
| | Each bit may be read or written by either the |
| | Host Processor through CSEM, or CRISP |
| | through SEMx registers. |

### CRISP Process Registers (32-bit registers)

Please note: the following are NOT addressable with LDC, SET, CLR, or TST instructions. A10:A9 may be used for future expansion addressing, and should generally be programmed as zeros; the hardware may or may not decode these address bits in an implementation. The first 8 locations are addressable by the LDR and STR instructions.

TABLE 107

| | A10: | | | | | Data | |
|---|---|---|---|---|---|---|---|
| A11 | A9 | A8 | A7 | A6:A2 | Register | Bits | Remarks |
| 1 | X | 0 | 0 | X0000 | TSA | D23:D2 | Transfer Source Address |
| 1 | X | 0 | 0 | X0001 | TDA | D23:D2 | Transfer Destination Address |
| 1 | X | 0 | 0 | X0010 | TCNT | D21:D2 | Transfer Count |
| 1 | X | 0 | 0 | X0011 | CPC | D23:D2 | Current CRISP Program |
| | | | | | | | Counter |
| 1 | X | 0 | 0 | X01XX | <spare> | — | Spare register locations that |
| | | | | | | | may be loaded by the LDR |
| | | | | | | | instruction. |
| 1 | X | 0 | 0 | X1000 | OPR | D23:D2 | Opcode - NOTE: not loadable |
| | | | | | | | using LDR instruction. |
| 1 | X | 0 | 1 | Reg | BIAS[0:3] | D31:D0 | Dither Grid Bias Registers |
| | | | | Addr | | | (Actual organization to be |
| | | | | 1.0 | | | determined) |
| 1 | X | 1 | Reg | Reg | CLUT[0:6 | D31:D0 | 256 byte (64 × 4 bytes) Color |
| | | | Addr | Addr | 3] | | Look-Up TABLE. Data is |
| | | | 5 | 4:0 | | | arranged “Little Endian”, e.g. |
| | | | | | | | D7:D0 comprise the first byte; |
| | | | | | | | D31:D24 is the third byte. |

| | |
|---|---|
| TSA | Transfer Source Address. Pointer to source data to be used during |
| | execution of Data Transfer Opcodes. This may register may be |
| | loaded using the LDR instruction or externally addressed when |
| | CRISP is in HOLD mode. |
| TDA | Transfer Destination Address. This may register may be loaded |
| | using the LDR instruction or externally addressed when CRISP is |
| | in HOLD mode. |
| TCNT | Transfer Count. This value is the number of 32-bit words to be |
| | processed during execution of Data Transfer Opcodes. This may |
| | register may be loaded using the LDR instruction or externally |
| | addressed when CRISP is in HOLD mode. |
| CPC | This register holds the current program counter of a CRISP |
| | program. This may register may be loaded using the LDR |
| | instruction or externally addressed when CRISP is in HOLD |
| | mode. |
| OPR | While CRISP is running, this register is automatically loaded |
| | from the address pointed to by the CPC. When CRISP is in the |
| | HOLD state, this register may be written externally by the Host |
| | CPU with a CRISP Opeode and executed via the STEP function |
| | of the CCR (see CRASIC External Registers, CCR). |
| BIAS | See next section: CRISP Palettes and Dithering |
| CLUT | See next section: CRISP Palettes and Dithering |

### CRISP Palettes and Dithering

When processing 256 “mapped” colors the same source data is used for each color plain, but the values in the palette are reloaded for the color being processed. Changing the RAM-based copies of the palette (one each for Red, Green, and Blue) will result in color changes in the image, even though the source image data is unchanged.

When processing 24-bit color the same palette may be used, but the source data comes from separate (planerized) buffers for Red, Green, and Blue. Separate color palettes may be used to correct gamma for individual colors.

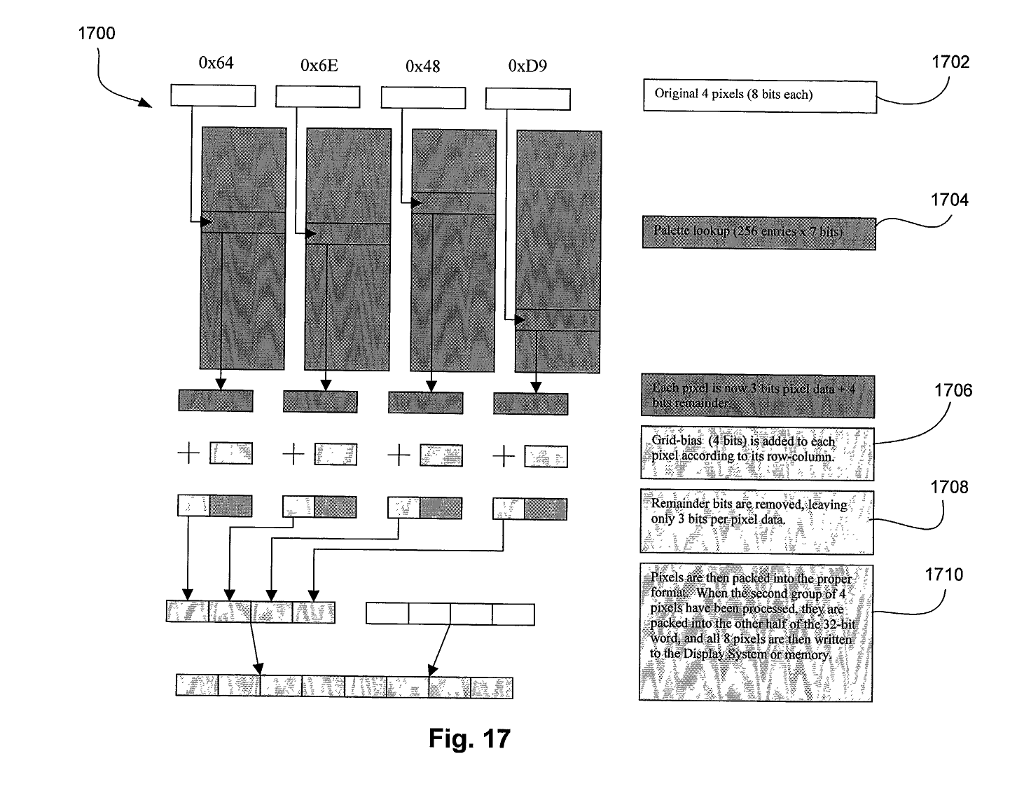

FIG. 17 shows the process 1700 to convert 8-bit pixel data into pixels in a format amenable to the Display System. In operation 1702, the original 4 pixels (8 bits each) are identified. A palette lookup (256 entries×7 bits) is performed in operation 1704. Each pixel is now 3 bits pixel data +4 bits remainder. In operation 1706, grid-bias (4 bits) is added to each pixel according to its row-column. Remainder bits are removed in operation 1708, leaving only 3 bits per pixel data. In operation 1710, the pixels are then packed into the format of the Display System. When the second group of 4 pixels have been processed, they are packed into the other half of the 32-bit word, and all 8 pixels are then written to the Display System or memory.

### Analog Controller

### Overview

Description

The Analog Controller (OAC) implements all power management functions This includes power efficient DC to DC conversions needed for driving the Liquid Crystal and LED for the Display System, and the programmability of electrical parameters. This ensures the most optimal settings regardless of the operating temperature and unit variation. The temperature sensor is on-chip and the compensation is done automatically by the internal state machine. An internal booster converter generates the voltages and currents necessary to bias three separate LEDs. The charge pump and the voltage regulator generate and regulate the Liquid Crystal ITO voltages. The voltage and current for each color are controlled individually for optimal performance and power savings. The chip also monitors the temperature and, as the temperature reading changes, reads the corresponding table values from the separate EEPROM. It also recalculates and programs the LED currents and LC ITO voltages through the parallel, or I²C, interface.

Features

Requires only single 3.3 V supply

Fully compatible to with Backplane ICs

Can drive both Liquid Crystal and three color LEDs with a few external passive components

Highly power efficient operation

Supports three color LED field sequential illumination

Supports high refresh rate (more than 100 Hz) as well as low refresh rate

Supports gray scale mode

Supports both binary and RMS mode operations to drive Liquid Crystal

On-chip voltage boosters for Liquid Crystal and LED drivers

Programs precision ITO voltages

Matching ITO inversion voltage automatically generated

Can program Liquid Crystal DC offset voltage

Single common LED anode pin supplies all three LEDs

Separate common anode voltages for individual LED can be set sequentially

Each LED intensity is controlled by sinking different currents at the split LED cathodes

Monitors the chip junction temperature with offset trim capability

Supports external thermistor option

Can automatically correct the temperature dependencies of Liquid Crystal and LED related parameters.

Parallel interface—compatible to Backplane parallel interface

### System Interface and Timing

Pin Assignment

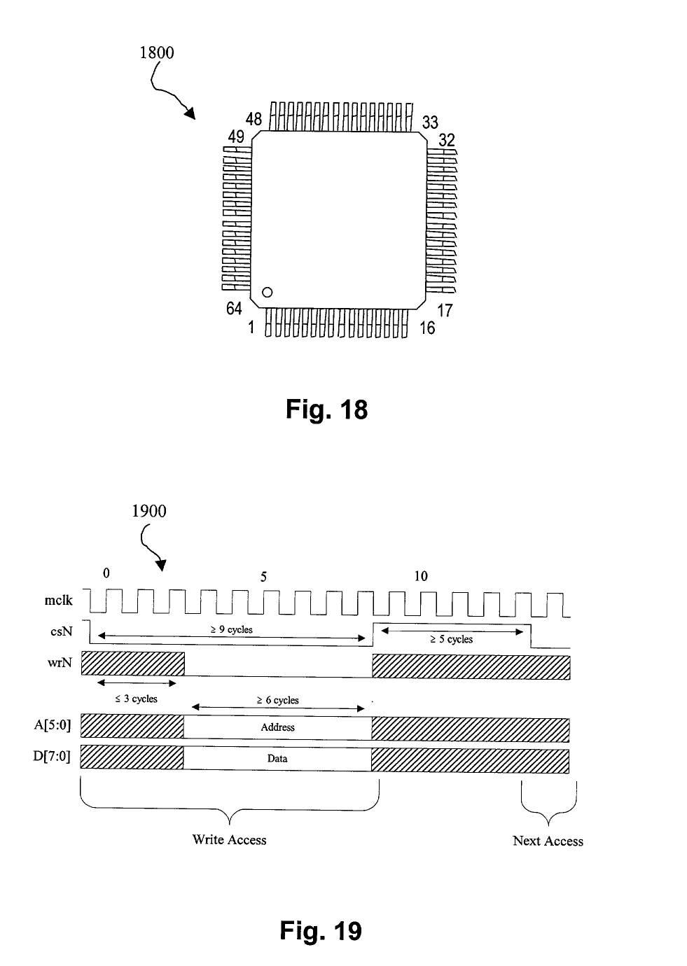

FIG. 18 is an illustration of an Analog Controller Chip 1800. The pinout for the chip is set forth in the table below.

TABLE 108
Pin Out by Pin Number

| | PAD | | PAD |
|---|---|---|---|
| PAD # | NAME | PAD DESCRIPTION | TYPE |
| 1 | csN | Chip select. An external host CPU, | Digital, In |
| | | Controller or Color Rich ASIC generates this signal. | |
| 2 | a[5] | OAC Register Address bit 5. Connect | Digital, In |
| | | together with a[9] of Display chip. | |
| 3 | a[4] | OAC Register Address bit 4. Connect | Digital, In |
| | | together with a[8] of Display chip. | |
| 4 | a[3] | OAC Register Address bit 3. Connect | Digital, In |
| | | together with a[7] of Display chip. | |
| 5 | a[2] | OAC Register Address bit 2. Connect | Digital, In |
| | | together with a[6] of Display chip. | |
| 6 | a[1] | OAC Register Address bit 1. Connect | Digital, In |
| | | together with a[5] of Display chip. | |
| 7 | a[0] | OAC Register Address bit 0. Connect | Digital, In |
| | | together with a[4] of Display chip. | |
| 8 | Vddd | Positive digital supply voltage. A regulated | Power Supply, |
| | | 3.3V system power is supplied from the | In |
| | | host system. 3.3V is provided through a | |
| | | supply pin of 80-pin connector. LED and | |
| | | Backplane chip also powered from the | |
| | | same source. | |
| 9 | vssd | Digital ground. All Logic circuits and | Power Supply, |
| | | digital pads are connected to this ground. | In |
| 10 | d[7] | MSB of data byte. These 8 bits of data | Digital, Bidir |
| | | lines are connected to the least significant 8 | |
| | | bits of data bus. | |
| 11 | d[6] | Bit 6 of data byte | Digital, Bidir |
| 12 | d[5] | Bit 5 of data byte | Digital, Bidir |
| 13 | d[4] | Bit 4 of data byte | Digital, Bidir |
| 14 | d[3] | Bit 3 of data byte | Digital, Bidir |
| 15 | d[2] | Bit 2 of data byte | Digital, Bidir |
| 16 | d[1] | Bit 1 of data byte | Digital, Bidir |
| 17 | d[0] | LSB of data byte | Digital, Bidir |
| 18 | | Reserved for the future use | |
| 19 | | Reserved for the future use | |
| 20 | | Reserved for the future use | |
| 21 | | Reserved for the future use | |
| 22 | | Reserved for the future use | |
| 23 | blue | Input signal from Display chip. This signal | Digital, In |
| | | will control on/off timing of Blue LED. | |
| 24 | red | Input signal from Display chip. This signal | Digital, In |
| | | will control on/off timing of Red LED. | |
| 25 | green | Input signal from Display chip. This signal | Digital, In |
| | | will control on/off timing of Green LED. | |
| 26 | led | LED ‘on’ indicator from Display chip. | Digital, Bidir |
| | | During test mode this pin outputs clkito | |
| 27 | | Test pin: vdacled | Analog, OUT |
| | | | Test Pin |
| 28 | comled | Voltage booster2 output. A low pass filter | Analog, Out |
| | | capacitor for the LED supply voltage | |
| | | booster is connected. Common anode of | |
| | | LED is connected to this pin. | |
| 29 | vsse | Ground pad for the LED driver circuitry. | Power Supply, |
| | | | In |
| 30 | lled | Connected to one end of inductor to the | Analog, Out |
| | | pch rectifier and nch switch. | |
| 31 | vdde | Positive supply voltage for the LED driver | Power Supply, |
| | | circuitry. A regulated 3.3V system power | In |
| | | is supplied from the host system. 3.3V is | |
| | | provided through the supply pin of 80-pin | |
| | | connector. | |
| 32 | rled | Red LED On switch. This pad is connected | Analog, In |
| | | to the cathode of terminal red LED. | |
| 33 | gled | Green LED On switch. This pad is | Analog, In |
| | | connected to the cathode of terminal green | |
| | | LED. | |
| 34 | bled | Blue LED On switch. This pad is | Analog, In |
| | | connected to the cathode of terminal blue | |
| | | LED. | |
| 35 | | Test pin: idacled. Reflecting the voltage | Analog, OUT |
| | | across the internal current monitoring | Test Pin |
| | | resistor. | |
| 36 | vssa | Analog ground. This ground is connected | Power Supply, |
| | | only to the charge pump, A/D & D/A, | In |
| | | operational amplifiers and filters, POR, | |
| | | voltage reference and regulators. | |
| 37 | vdda | Power supply pin to the analog circuitry. | Power Supply, |
| | | Analogous to vssa. | In |
| 38 | resetN | Reset input pin. This signal is ‘or’ed with | Digital, In |
| | | internal POR signal. Once reset, the chip | Active Low |
| | | will go through the boot-up procedure | |
| | | including down-loading of default | |
| | | parameters from EEPROM | |
| 39 | porstN | Power On Reset. This signal goes to the | Digital, Out, |
| | | Microdisplay (or Display chip) and other | Active Low |
| | | chips in the system, and resets all internal | |
| | | circuitry. | |
| 40 | rref | Precision reference current generator | Analog, In |
| | | resistor. A resistor with 1% tolerance and | |
| | | low temperature coefficient must be used. | |
| 41 | | Test pin:vbg. Bandgap voltage. | Analog, OUT |
| | | | Test Pin |
| 42 | | Reserved for future use | |
| 43 | vito | ITO voltage output pin. Liquid Crystal ITO | Analog, Out |
| | | electrode is connected to this pin. This | |
| | | voltage changes from Vtrip to Vtrin as the | |
| | | digital input the ‘ito’ pin switches from ‘1’ | |
| | | to ‘0’ or vice versa. The voltage levels are | |
| | | programmed in the register. | |
| 44 | | Test pin: dacos | Analog, OUT |
| | | | Test Pin |
| 45 | ito | Digital input signal from Display chip. | Digital, In |
| | | Synchronized with the pixel voltage | |
| | | polarity and indicating the polarity of ‘vito’ | |
| | | pin. | |
| 46 | | Test pin: dacres | Analog, OUT |
| | | | Test Pin |
| 47 | | Test pin: dacvito | Analog, OUT |
| | | | Test Pin |
| 48 | tsense | External temperature sensor input. Test pin | Analog, In |
| | | used as an internal sensor monitoring. | |
| 49 | | Reserved for future use | |
| 50 | vdblp | Double booster output. A holding capacitor | Analog, Out |
| | | is connected (plus voltage). | |
| 51 | cpp1 | Voltage double booster capacitor terminal | Analog, Out |
| | | (positive) for plus Vito generation. | |
| 52 | cpn1 | Voltage double booster capacitor terminal | Analog, Out |
| | | (negative) for plus Vito generation. | |
| 53 | cmp1 | Voltage double booster capacitor terminal | Analog, Out |
| | | (negative) for minus Vito generation. | |
| 54 | vdbln | Negative double booster output. A holding | Analog, Out |
| | | capacitor is connected (minus voltage). | |
| | | This is generated from Vdblp. | |
| 55 | cmn1 | Voltage double booster capacitor terminal | Analog, Out |
| | | (positive) for minus Vito generation. This | |
| | | voltage is generated from the positive | |
| | | boosted voltage. | |
| 56 | cpn2 | Voltage triple booster capacitor terminal | Analog, Out |
| | | (positive) for plus Vito generation. | |
| 57 | cpp2 | Voltage triple booster capacitor terminal | Analog, Out |
| | | (negative) for plus Vito generation. | |
| 58 | vtrip | Triple booster output. A holding capacitor | Analog, Out |
| | | is connected (plus voltage). | |
| 59 | mclk | Master clock from the host CPU or | Digital , In |
| | | controller. This clock will be divided into a | |
| | | slower clock by 2ⁿ where n is in the Input | |
| | | Clock Divider register. | |
| 60 | i²cmst | Serial communication master mode. | Digital, In |
| | | Setting this to ‘1’ will put OAC into a | |
| | | master mode for the EEPROM serial | |
| | | communication. Otherwise, the system | |
| | | CPU will be the master. | |
| 61 | | Reserved for future use | |
| 62 | scl | I²C interface serial interface clock. | Digital, Bidir |
| | | Frequency is up to 100K. | |
| 63 | sda | I²C interface serial interface data. | DIgital, Bidir |
| | | Frequency is up to 100K. | |
| 64 | wrN | Register write | Digital, In |
| | | | Active Low |

Pin Description

TABLE 109
Pin Description

| Name | Direction | Type | Description |
|---|---|---|---|
| A[5:0] | Input | Digital | System address. |
| csN | Input | Digital | System chip select. Active low. |
| D[7:0] | Bi- | Digital | System data. |
| | directional | | |
| mclk | Input | Digital | System clock (master clock). |
| rstN | Input | Digital | System reset. Active low. |
| wrN | Input | Digital | System write. Active low. Drive |
| | | | high to indicate a read. |
| bled | Output | Analog | Red LED control. |
| blue | Input | Digital | Blue timing indicator from |
| | | | Backplane IC. |
| comled | Output | Analog | Common LED control. |
| gled | Output | Analog | Green LED control. |
| green | Input | Digital | Green timing indicator from |
| | | | Backplane IC. |
| ito | Input | Digital | ITO Timing indicator from |
| | | | Backplane IC. |
| led | Bi- | Digital | Normally, LED timing indicator |
| | directional | | from Backplane IC. Becomes the |
| | | | charge pump clock diagnostic |
| | | | output when the cp_clk_test bit |
| | | | (0x7: 0) = 1. |
| lled | Output | Analog | LED Inductor control. |
| mled | Input | Analog | LED Monitor input. |
| red | Input | Digital | Red timing indicator from |
| | | | Backplane IC. |
| rled | Output | Analog | Red LED control. |
| vito | Output | Analog | ITO Voltage output. |

System Bus

The Bus has a parallel address, data, and control signal organization. The OAC and the Backplane IC receive separate chip selects. While several other signals are shared, the interface to the Backplane IC is intended to operate at much higher data rates. The Backplane IC also has a more complicated protocol.

The table above includes only those pins of the OAC belonging to the parallel interface, along with the timing signals from the Backplane IC, the ITO voltage, and LED current pins. Refer to the System Interface and Timing section for a complete listing of the OAC pins.

A[6:0] is used for register addresses when A[7] is high and ignored otherwise.

### Bus Protocol

Bus Handshake

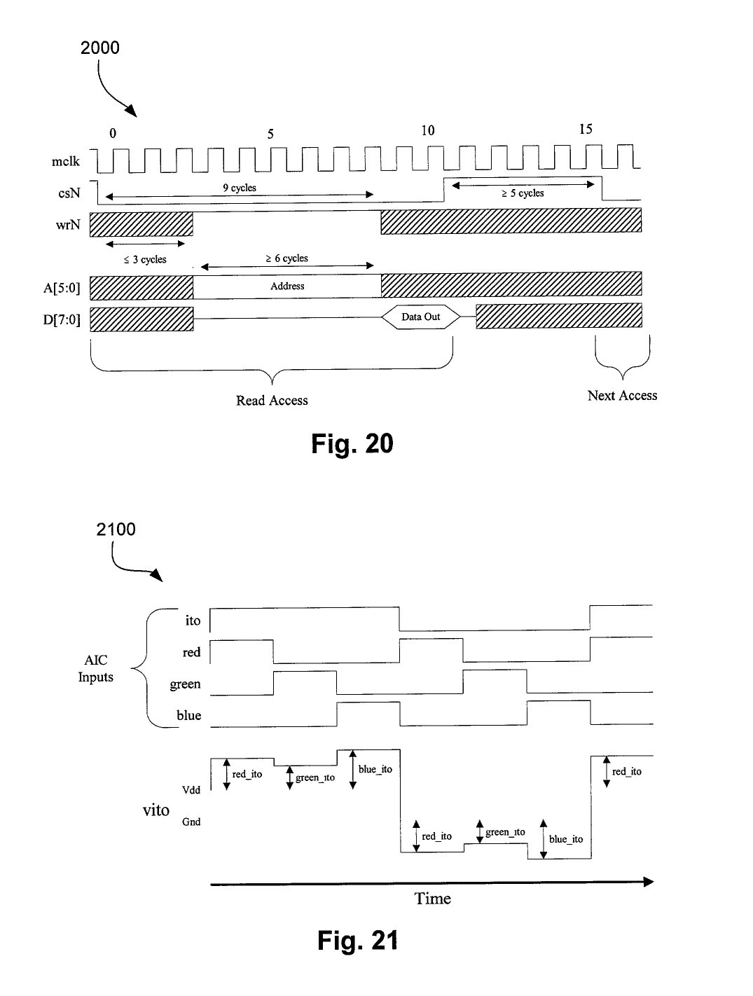

FIG. 19 illustrates a transaction waveform 1900 during parallel write timing. FIG. 20 illustrates a transaction waveform 2000 during parallel read timing. Read and write accesses from the host system to the OAC consist of driving the chip select csN low, setting the address bus A[5:0] for the duration of the access, and driving or floating the data and write signals appropriately. The chip select signal must be pulled high a minimum of 5 cycles between accesses.

Write accesses must last for a minimum of 9 clock cycles. Any access of shorter duration may lead to an indefinite setting of the configuration registers. There is no maximum access duration.

Read accesses must last for a minimum of 9 clock cycles before valid data is returned. The read data will remain valid until the chip select is deactivated.

ITO Voltage

FIG. 21 depicts an ITO voltage generation waveform 2100. The voltage output to the common counter electrode of the LCM is a function of the polarity of the ito signal from the Backplane IC, and the color of the current field. This is determined by the red, green, and blue signals from the Backplane IC. The magnitudes of the ITO voltage relative to the power rails are the programmable parameters red_ito, green_ito, and blue_ito.

LED Currents

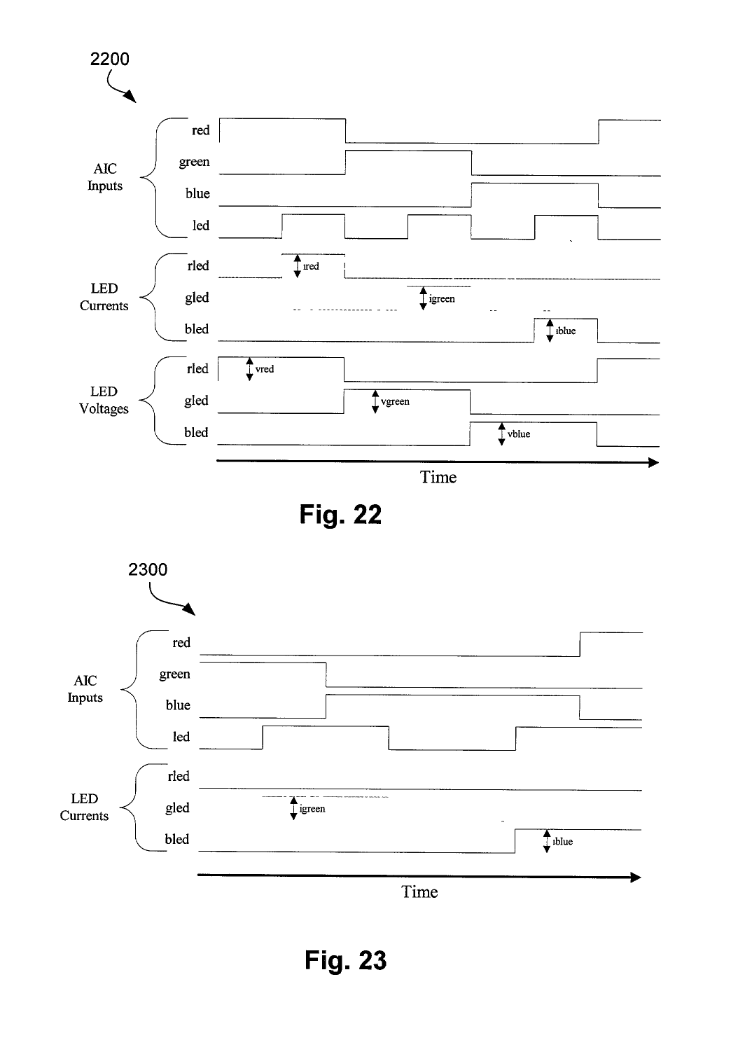

FIG. 22 depicts an LED current generation waveform 2200. The currents driven to the individual LED's are, in general, a function of the polarity of the led signal from the Backplane IC, and the color of the current field. The magnitudes of the currents through, and voltages across, the red, green, and blue LED's are the programmable parameters ired, igreen, iblue, vred, vgreen, and vblue, respectively.

ITO and LED Timing

FIG. 23 illustrates an LED timing waveform 2300 where ito_rst=0. The timing for the generation of the ITO voltage and the LED currents is determined by the ito, led, red, green, and blue signals from the Backplane IC. Led always falls coincident with the fall of red, green, or blue. A special case arises when led falls later, which is possible through the programming of the flash_delay registers in the Backplane IC.

The ITO reset pulse enable bit ito_rst, determines how the overlap of the led signal onto the next color field is interpreted. When ito_rst is off the driving of the LED corresponding to the original color field, it is prolonged until the overlap ends. The green LED is driven well into the blue field and the blue LED into the red field.

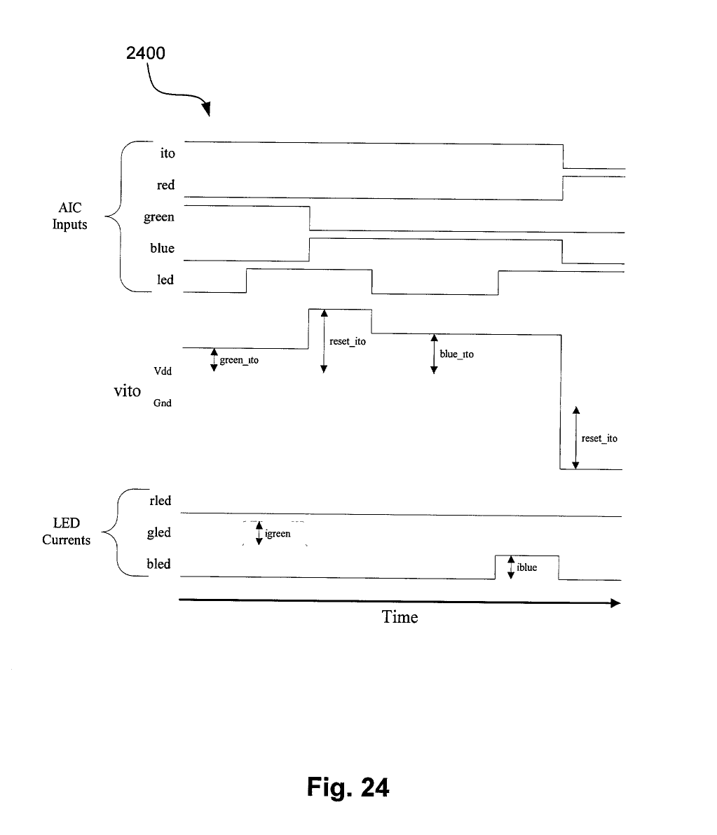

FIG. 24 depicts a waveform 2400 for ITO and LED Timing with ito_rst =1. When the ito_rst bit is on, the driving of the current LED is not prolonged, but instead a special ITO voltage is generated. This voltage is called a zap, or reset voltage, and has a magnitude given by the programmable parameter reset_ito.

### Analog Controller Configuration

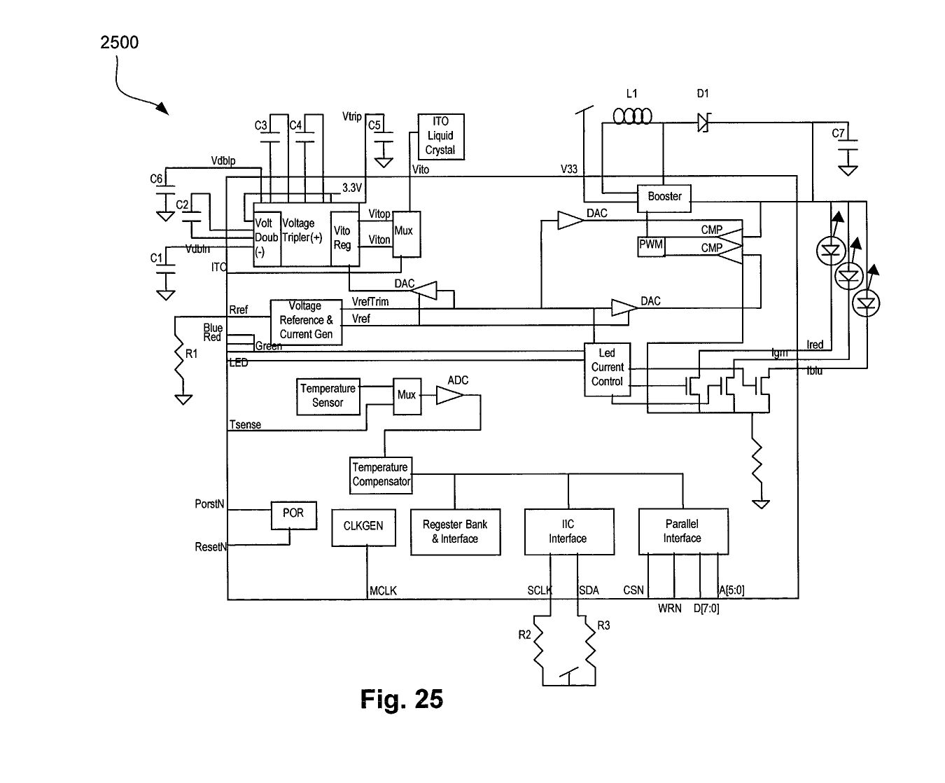

FIG. 25 is a block diagram of an analog controller 2500 according to an embodiment of the present invention.

Configuration Registers

On the parallel bus the OAC configuration registers are accessed according to the value of A[5:0]. For address compatibility with the mapping for the Backplane Integrated Circuit (Backplane IC) configuration registers, it is assumed that A[5:0] of the OAC is connected to A[9:4] of the Backplane IC.

On the I²C bus, the OAC configuration registers are accessed according to the value of the word address.

All 8 bits are not always defined for a particular configuration register. Where a bit is undefined, it should be considered reserved, and a ‘0’ should be written to it for compatibility with future versions of the chips. Reading an undefined bit always returns a ‘0’.

Not all addresses within a configuration register space map into a defined configuration register. Such addresses should be considered reserved. Only values of ‘00’ should be written to reserved register addresses, to maintain compatibility with future versions of the chips. Reading a reserved register always returns ‘00’.

All registers below are read/write accessible except where noted. All address values are given in hexadecimal. The Init column indicates the values of the respective variables at reset.

Configuration Register Address Map

TABLE 110
Configuration Register Summary

| Address Range | Register Group | Description |
|---|---|---|
| 0x00-0x07 | System Interface | Chip Revision, EEProm, |
| | | POR status and power |
| | | down, Bandgap voltage |
| | | trim, clock divider for |
| | | charge pump and led |
| | | booster clocks, Backplane |
| | | chip status |
| 0x0C-0x0F | Temperature Control | Temperature sensor control, |
| | | temperature sensor offset |
| | | adjust, temperature monitor. |
| 0x10-0x17 | ITO Control | ITO voltage offset, red |
| | | green blue ito voltages, |
| | | reset voltage. |
| 0x18-0x1E | LED Control | LED current set, led anode |
| | | voltage set, and led power |
| | | control. |

Chip Revision Register (0x0)

To determine feature set and compatibility, the host CPU reads the Chip Revision register. This register can be overwritten internally at power-up when the OAC reads the 12C EEPROM. This register will change to reflect the first byte of read from the EEPROM.

System Registers (0x01−0x07)

EEPROM ID (0x01)

This byte, the EEPROM ID register, can also indicate the manufacturer and the size of EEPROM used.

Chip Power Control (0x02)

TABLE 111

| Bit | Reference | Description |
|---|---|---|
| 2 | sporstN | Software power-on reset for the |
| | | Backplane IC. The porstN output |
| | | pin is pulled low whenever this bit |
| | | is low, or the OAC detects a |
| | | powering up condition. |
| 1 | led_pdwnN | Power down of the analog circuitry |
| | | that generates the LED currents |
| | | (rled, gled, and bled). Does not |
| | | affect the generation of power-on |
| | | reset (porstN). Active low. |
| 0 | pdwnN | Power down of the analog circuitry |
| | | that generates the ITO voltage |
| | | (vito) and the LED currents |
| | | (rled, gled, and bled). Does not |
| | | affect the generation of |
| | | power-on reset (porstN). |
| | | Active low. |

Reference Voltage Trim (0x03)

Bits 5-0 of the Vbg register are a value to trim the output voltage of internal bandgap circuitry.

Charge Pump Clock Divider (0x04 & 0x05 [3:0])

Bits 7-0 of the Charge Pump Clock Divider register are a divisor value to scale the input clock to generate OAC internal clock references for the charge pump. Assuming OAC runs from the same 66 Mhz clock as the Backplane chip, for example, a value of 3 fh would provide a 1.476 Mhz internal clock. Nominally the divided value should be as close as possible to 25 KHz.

LED Booster Clock Divider (0x05 [7:4] & 0x06)

Bits 7-0 of the LED Booster Clock Divider register are a divisor value to scale the input clock to generate OAC internal clock references for the LED voltage booster. This clock is used for the internal PWM circuitry. Assuming OAC runs from the same 66 Mhz clock as an Backplane chip, for example, and a value of 3fh would provide a 1.476 Mhz internal clock.

Backplane Chip Status (0x08)

The Display System reports the state of all inputs from the Backplane chip. The purpose of this register is primarily for diagnostic, calibration, and production QA testing of assembled modules.

TABLE 112

| Bit | Reference | Description |
|---|---|---|
| 4 | itop | ITO input pin state. |
| 3 | led | LED input pin State. |
| 2 | red | Red LED input pin state. |
| 1 | green | Green LED input pin state. |
| 0 | blue | Blue LED input pin state. |

Temperature Sensor configuration (0x0C)

TABLE 113

| Bit | Reference | Description |
|---|---|---|
| 7 | temp_test | Temperature test enable via |
| | | pin tsense. For diagnostics |
| | | only: temp_test should |
| | | normally be left low. |
| 6 | ets | External temperature sensor |
| | | enable via pin tsense. |
| 5 | lut_enable | Enables use of an external |
| | | look-up table based on the |
| | | sampled temperature. |
| 4 | temp_enable | Enables temperature |
| | | sampling. Set to ‘0’ whenever |
| | | temp_interval is to be changed |
| | | and then reset to ‘1’ |
| | | afterwards. |
| 3:0 | temp_interval | Temperature sampling interval. |
| | | Enter ‘0’ for every |
| | | 32 cycles, ‘1’ for every |
| | | (2²² + 32) cycles, ‘2’ |
| | | for every (2 * 2²² + 32 |
| | | cycles), etc. |

Temperature Sensor Offset (0x0D)

Bits 7-0 of the Temperature Sensor Offset register sets and adjusts the base of the temperature readings. Ideally, the lowest sensed temperature will read as FFh, and the highest as 00h.

Temperature Value (0x0E) & Sample (0x0F)

The Temperature Sample register reports the temperature at the OAC chip, or external sensor, depending on the System Configuration register setting. The value can be used to fine tune ITO voltages and LED currents going to the LCM. Temperature Sample reports the average of eight most samples.

ITO Mode Control (0x1)

TABLE 114

| Bit | Reference | Description |
|---|---|---|
| 1 | itorst | ITO reset pulse enable. |
| | | Setting this bit will enable |
| | | the generation of ITO reset |
| | | (zap) voltages. The reset pulse |
| | | will position the LC into a |
| | | fully saturated state before |
| | | settling into a certain |
| | | RMS state. |

ITO Reset (Zap) Voltage (0x12)

Bits 7-0 of the ITO Reset (Zap) Voltage register sets the level for ITO between fields when “Reset Mode” is true (see ITO Mode Register). The range for ITO Zap Voltage is 0 through 5.7 volts above VDD and below GND.

ITO Offset Voltage 1—Viton trim (gain_balance)(0x13)

Bits 7-0 of the ITO Baseline Voltage register sets the offset voltage for red, green, and blue ITO voltages. This register trims the mismatch between the resistors used to generate Viton. The trim range for Viton is +/−2% of Viton below GND. 00h will produce the highest offset voltage, and FFh will be the lowest offset voltage.

ITO Offset Voltage 2—Vcenter trim (dc_bias) (0x14)

Bits 7-0 of the ITO Baseline Voltage register sets the offset voltage for red, green, and blue ITO voltages. This register trims the mismatch between the resistors used to generate Vcenter, that is the middle point between Vdd and GND. The trim range for Viton is +/−22% of Viton below GND. This register, in conjunction with Register 06, can generate an arbitrary offset voltage on Viton. 00h will produce the highest offset voltage, and FFh will be the lowest offset voltage.

ITO Voltage—Red (0x15)

Bits 7-0 of the ITO Red Set register sets the ITO voltage during a red field. The range for ITO Red set is from 3.3V to Vito max. While ITO is positive, Vito is switched to the positive ITO voltage. While ITO is negative, Vito is switched to the Vito negative. Vito negative is also generated by the value set by this register. The range for the Vito negative is from GND to -(Vito−3.3V).

ITO Voltage—Green (0x16)

Bits 7-0 of the ITO Green Set register sets the ITO voltage during a Green field. The range for ITO Red set is from 3.3V to Vito max. While ITO is positive, Vito is switched to the positive ITO voltage. While ITO is negative, Vito is switched to the Vito negative. Vito negative is also generated by the value set by this register. The range for the Vito negative is from GND to -(Vito−3.3V).

ITO Voltage—Blue (0x17)

Bits 7-0 of the ITO Blue Set register sets the ITO voltage during a Blue field. The range for ITO Red set is from 3.3V to Vito max. While ITO is positive, Vito is switched to the positive ITO voltage. While ITO is negative, Vito is switched to the Vito negative. Vito negative is also generated by the value set by this register. The range for the Vito negative is from GND to -(Vito−3.3V).

Red LED Current (0x18 [5:0])

Bits 5-0 of the Red LED Current register sets the amount of current drawn through the red LED while “flashing” a red field. The range for Red LED Current is 0 through 120 mA, each increment representing approximately 2 mA.

Green LED Current (0x19 [3:0] & 0x18 [7:6])

The 6 bit Green LED Current register sets the amount of current drawn through the green LED while “flashing” a green field. The range for Green LED Current is 0 through 120 mA, each increment representing approximately 2 mA.

Blue LED Current (0x19 [3:0] & 0x1A [1:0])

The 6 bit Blue LED Current register sets the amount of current drawn through the blue LED while “flashing” a blue field. The range for Blue LED Current is 0 through 120 mA, each increment representing approximately 2 mA.

Red LED Common Anode Voltage (0x1A [6:2])

The 5 bit Red LED Voltage register sets the common anode voltage while color inputs from the Backplane chip activates from one color to the next. Only one color is enabled with field sequential display. At this time the LED signal from the Backplane chip is disabled. The purpose of this is to settle the common anode voltage before the LEDs are activated and start drawing current.

Green LED Common Anode Voltage (0x1B [3:0] & 0x1A [7])

The 5 bit Green LED Voltage register sets the common anode voltage while color inputs from the Backplane chip activates from one color to the next. Only one color is enabled with field sequential display. At this time the LED signal from the Backplane chip is disabled. The purpose of this is to settle the common anode voltage before the LEDs are activated and start drawing current.

Blue LED Common Anode Voltage (0x1B [7:4] & 0x1C [0])

The 5 bit Blue LED Voltage register sets the common anode voltage while color inputs from the Backplane chip activates from one color to the next. Only one color is enabled with field sequential display. At this time the LED signal from the Backplane chip is disabled. The purpose of this is to settle the common anode voltage before the LEDs are activated and start drawing current.

### SUMMARY

TABLE 115
Configuration Register Summary

| Address Range | Register Group | Description |
|---|---|---|
| 0x00-0x07 | System Interface | Chip Revision, EEProm, |
| | | POR status and power |
| | | down, Bandgap voltage |
| | | trim, clock divider |
| | | for charge pump and |
| | | led booster clocks, |
| | | Backplane chip status |
| 0x0C-0x0F | Temperature Control | Temperature sensor control, |
| | | temperature sensor offset |
| | | adjust, temperature monitor. |
| 0x10-0x17 | ITO Control | ITO voltage offset, red, |
| | | green, blue ito voltages, |
| | | reset voltage. |
| 0x18-0x1C | LED Control | LED current set, led anode |
| | | voltage set, and led power |
| | | control. |

### Detailed Description

TABLE 116

| Addr | Bits | Init | Name | Description |
|---|---|---|---|---|
| 0x00 | 7:0 | 2 | Chip_ID | Chip identification |
| | | | | (read only). Returns |
| | | | | 0x01, 0x02, etc., to |
| | | | | indicate the version |
| | | | | number of the chip. |
| 0x01 | 7:0 | 0 | ROM_ID | Serial EEPROM |
| | | | | identification. |
| | | | | Following a config- |
| | | | | uration load from |
| | | | | serial EEPROM, |
| | | | | returns 0x01, 0x02, |
| | | | | etc., to indicate |
| | | | | the version number |
| | | | | of the ROM. |
| 0x02 | 2 | 1 | sporstN | Software power-on |
| | | | | reset for the |
| | | | | Backplane IC. |
| | | | | The porstN output |
| | | | | pin is pulled low |
| | | | | whenever this bit |
| | | | | is low, or the OAC |
| | | | | detects a powering |
| | | | | up condition. |
| | 1 | 1 | led_pdwnN | Power down of the |
| | | | | analog circuitry |
| | | | | that generates |
| | | | | the LED currents |
| | | | | (rled, gled, and |
| | | | | bled). Does not |
| | | | | affect the gener- |
| | | | | ation of power-on |
| | | | | reset (porstN). |
| | | | | Active low. |
| | 0 | 1 | pdwnN | Power down of the |
| | | | | analog circuitry |
| | | | | that generates the |
| | | | | ITO voltage (vito) |
| | | | | and the LED |
| | | | | currents (rled, |
| | | | | gled, and bled). |
| | | | | Does not affect |
| | | | | the generation |
| | | | | of power-on reset |
| | | | | (porstN). Active |
| | | | | low. |
| 0x03 | 5:0 | 0 | band_gap | Band gap trimming |
| | | | | voltage. |
| 0x04 | 7:0 | ff | div_cp[7:0] | Lower eight bits |
| | | | | of divider used to |
| | | | | generate the charge |
| | | | | pump clock from |
| | | | | the system clock. |
| | | | | Least significant |
| | | | | bit, div_cp[0], |
| | | | | is read only and |
| | | | | always returns ‘1’. |
| | | | | Default value produces |
| | | | | a □ 2048 clock. |
| | | | | Charge pump clock is |
| | | | | idled whenever pdwnN |
| | | | | is low. |
| 0x05 | 7:4 | f | Div_led[3:0] | Lower four bits |
| | | | | of divider used to |
| | | | | generate the LED |
| | | | | clock from the |
| | | | | system clock. |
| | | | | Least significant |
| | | | | bit, div_led[0], |
| | | | | is read only and |
| | | | | always returns ‘1’. |
| | | | | Default value |
| | | | | produces a □ 64 |
| | | | | clock. LED Clock |
| | | | | is idled whenever |
| | | | | led_pdwnN or pdwnN |
| | | | | is low. |
| | 3:0 | 7 | div_cp[11:8] | Upper four bits of |
| | | | | charge pump clock |
| | | | | divider. |
| 0x06 | 7:0 | 03 | div_led[11:4] | Upper eight bits of |
| | | | | LED clock divider. |
| 0x07 | 0 | 0 | cp_clk_test | Charge pump clock |
| | | | | test enable. When |
| | | | | ‘1’, routes internal |
| | | | | charge pump clock out |
| | | | | through the led |
| | | | | pin. For diagnostics |
| | | | | only: cp_clk_test |
| | | | | should normally be |
| | | | | left low, in which |
| | | | | case led performs |
| | | | | as an input from |
| | | | | the Backplane IC. |
| 0x08 | | | | Backplane IC |
| | | | | status register. |
| | | | | Status of incoming |
| | | | | control bits from |
| | | | | the Backplane IC. |
| | | | | Read only. |
| | 4 | — | ito | Input ito pin value. |
| | 3 | — | led | Input led pin value. |
| | 2 | — | red | Input red pin value. |
| | 1 | — | green | Input green |
| | | | | pin value. |
| | 0 | — | blue | Input blue pin value. |
| 0x09 | | | | DAC Test register. |
| | | | | For diagnostics |
| | | | | only. |
| | 4 | 0 | vled_test | LED Voltage. When |
| | | | | enabled, output |
| | | | | at pin led_test. |
| | 3 | 0 | iled_test | LED Current. When |
| | | | | enabled, output |
| | | | | at pin led_test. |
| | 2 | 0 | vito_test | ITO Voltage. When |
| | | | | enabled, output |
| | | | | at pin led_test. |
| | 1 | 0 | gain_test | Internal resistor |
| | | | | balance adjustment |
| | | | | for vito. When |
| | | | | enabled, output at |
| | | | | pin ito_test. |
| | 0 | 1 | bias_test | DC Bias voltage |
| | | | | adjustment for |
| | | | | vito. When enabled, |
| | | | | output at pin |
| | | | | ito_test. |
| 0x0c | 7 | 0 | temp_test | Temperature test |
| | | | | enable via pin |
| | | | | tsense. For diag- |
| | | | | nostics only: |
| | | | | temp_test should |
| | | | | normally be left |
| | | | | low. |
| | 6 | 0 | ets | External temperature |
| | | | | sensor enable via |
| | | | | pin tsense. |
| | 5 | 1 | lut_enable | Enables use of an |
| | | | | external look-up |
| | | | | table based on the |
| | | | | sampled temperature. |
| | 4 | 1 | temp_enable | Enables temperature |
| | | | | sampling. Set to ‘0’ |
| | | | | whenever temp_interval |
| | | | | is to be changed and |
| | | | | then reset to ‘1’ |
| | | | | afterwards. |
| | 3:0 | 8 | temp_interval | Temperature sampling |
| | | | | interval. Enter ‘0’ |
| | | | | for every 32 cycles, |
| | | | | ‘1’ for every |
| | | | | (2²² + 32) cycles, |
| | | | | ‘2’ for every |
| | | | | (2 * 2²² + 32 |
| | | | | cycles), etc. |
| 0x0d | 7:0 | 80 | temp_offset | Temperature |
| | | | | offset. |
| 0x0e | 5:0 | — | temp_val | Temperature value. |
| | | | | Average of eight |
| | | | | most recent samples. |
| | | | | Read only. |
| 0x0f | 5:0 | — | temp_samp | Temperature sample. |
| | | | | Most recent temp- |
| | | | | erature reading. |
| | | | | Read only. |
| 0x01 | 1 | 0 | ito_rst | ITO Reset pulse |
| 0 | | | | enable. A ‘1’ |
| | | | | on this bit enables |
| | | | | the generation of |
| | | | | an ITO reset voltage |
| | | | | on the continuance |
| | | | | of the led signal |
| | | | | into a new field. |
| | | | | A ‘0’ disables |
| | | | | the generation of the |
| | | | | reset voltage, and |
| | | | | allows the continuance |
| | | | | of the led signal |
| | | | | into a new field to |
| | | | | be interpreted as |
| | | | | keeping the previous |
| | | | | field's LED on. |
| 0x12 | 7:0 | 00 | reset_ito | ITO Voltage during |
| | | | | a reset interval. |
| | | | | Analogous to |
| | | | | red_ito. |
| 0x13 | 7:0 | 80 | vito_gain_balance | Internal resistor |
| | | | (riton) | balance adjustment. |
| 0x14 | 7:0 | 80 | vito_dc_bias | DC Bias voltage |
| | | | (rvcenter) | adjustment. |
| 0x15 | 7:0 | 00 | Red_ito | ITO Voltage during |
| | | | | a red field. Value |
| | | | | during a positive |
| | | | | ITO field is relative |
| | | | | to the power supply |
| | | | | VDD. Value during a |
| | | | | negative ITO field is |
| | | | | relative to ground. |
| 0x16 | 7:0 | 00 | green_ito | ITO Voltage during |
| | | | | a green field. |
| | | | | Analogous to red_ito. |
| 0x17 | 7:0 | 00 | blue_ito | ITO Voltage during |
| | | | | a blue field. |
| | | | | Analogous to red_ito. |
| 0x18 | 7:6 | 0 | igreen[1:0] | Lower two bits of |
| | | | | current drawn by |
| | | | | the green LED during |
| | | | | the flash region of |
| | | | | the green field. |
| | 5:0 | 00 | Ired[5:0] | Current drawn by |
| | | | | the red LED during |
| | | | | the flash region |
| | | | | of the red field. |
| 0x19 | 7:4 | 0 | iblue[3:0] | Lower four bits |
| | | | | of current drawn |
| | | | | by the blue LED |
| | | | | during the flash |
| | | | | region of the |
| | | | | blue field. |
| | 3:0 | 0 | igreen[5:2] | Upper four bits |
| | | | | of current drawn |
| | | | | by the green |
| | | | | LED during the |
| | | | | flash region of |
| | | | | the green field. |
| 0x1A | 7 | 0 | vgreen[0] | Lower bit of |
| | | | | voltage applied at |
| | | | | the green LED during |
| | | | | the flash region of |
| | | | | the green field. |
| | 6:2 | 00 | vred | Voltage applied |
| | | | | at the red LED |
| | | | | during the flash |
| | | | | region of the |
| | | | | red field. |
| | 1:0 | 0 | iblue[5:4] | Upper two bits |
| | | | | of current drawn by |
| | | | | the blue LED during |
| | | | | the flash region |
| | | | | of the blue field. |
| 0x1B | 7:4 | 0 | vblue[3:0] | Lower four bits |
| | | | | of voltage applied |
| | | | | at the blue LED |
| | | | | during the flash |
| | | | | region of the |
| | | | | green field. |
| | 3:0 | 0 | vgreen[4:1] | Upper four bits of |
| | | | | voltage applied |
| | | | | at the green LED |
| | | | | during the flash |
| | | | | region of the |
| | | | | green field. |
| 0x1C | 0 | 1 | vblue[4] | Upper bit of |
| | | | | voltage applied at |
| | | | | the blue LED during |
| | | | | the flash region of |
| | | | | the green field. |
| 0x20 | | | | I²C Slave device 0 |
| | | | | configuration |
| | | | | register 1. |
| | 7:4 | A | dev_addr[0] | Slave address for |
| | | | | device 0. Reset |
| | | | | value is correct for |
| | | | | serial EEPROM. |
| | 3:1 | 0 | word_addr[0] | Upper 3 bits of word |
| | | | [10:8] | address of the next |
| | | | | byte access for |
| | | | | device 0. In con- |
| | | | | junction with the |
| | | | | lower 8 bits |
| | | | | (0x21:7-0), |
| | | | | automatically |
| | | | | increments after |
| | | | | each access. |
| | 0 | 0 | rwN[0] | I²C r/wN Bit |
| | | | | for device 0: deter- |
| | | | | mined by the operation |
| | | | | (0x30:1-0). Always |
| | | | | returns ‘0’ on a |
| | | | | read. |
| 0x21 | | | | I²C Slave device 0 |
| | | | | configuration |
| | | | | register 2. |
| | 7:0 | 0 | word_addr | Lower 8 bits of word |
| | | | [0][7:0] | address of the next |
| | | | | byte access for |
| | | | | device 0. In |
| | | | | conjunction with |
| | | | | the upper 3 bits |
| | | | | (0x20:3-1), auto- |
| | | | | matically increments |
| | | | | after each access. |
| 0x22 | | | | I²C Slave device 0 |
| | | | | configuration |
| | | | | register 3. |
| | 7 | 0 | err[0] | Device 0 error. |
| | | | | A ‘1’ indicates |
| | | | | the occurrence of |
| | | | | an error during a |
| | | | | write or read access. |
| | 6 | 0 | present[0] | Device 0 present. |
| | | | | Automatically set or |
| | | | | reset by the |
| | | | | I²C bus |
| | | | | initialization |
| | | | | operation. A ‘1’ |
| | | | | indicates the device |
| | | | | was detected. |
| | 5:0 | 0 | time_out[0] | Maximum number of |
| | | | | tries before timing |
| | | | | out on a write to |
| | | | | device 0. A try fails |
| | | | | on a negative ac- |
| | | | | knowledge to the |
| | | | | transmission of the |
| | | | | slave address. |
| 0x24 | | | | I²C Slave device |
| | | | | 1 configuration |
| | | | | register 1. |
| | 7:4 | 8 | dev_addr[1] | Slave address for |
| | | | | device 1. Reset |
| | | | | value is correct for |
| | | | | the Backplane IC. |
| | 3:1 | 0 | word_addr | Upper 3 bits of word |
| | | | [1][10:8] | address of the next |
| | | | | byte access for |
| | | | | device 1. |
| | 0 | 0 | rwN[1] | I²C r/wN Bit for |
| | | | | device 1. |
| 0x25-26 | | | | I²C Slave device 1 |
| | | | | configuration |
| | | | | registers 2-3. |
| | | | | Analogous to device 0 |
| | | | | configuration |
| | | | | registers 2-3 |
| | | | | (0x21-22). |
| 0x30 | 4 | 0 | op_ndev | Number of the |
| | | | | device to undergo |
| | | | | the I²C operation. |
| | 3 | 0 | Op_err | I²C operation |
| | | | | err. A ‘1’ on |
| | | | | this bit indicates an |
| | | | | error was detected. |
| | 2 | 0 | Op_req | I²C operation |
| | | | | request. A ‘1’ on |
| | | | | this bit requests an |
| | | | | I²C operation |
| | | | | to start. The bit is |
| | | | | automatically cleared |
| | | | | at the conclusion |
| | | | | of the operation. |
| | 1:0 | 0 | op_mode | Mode of operation. |
| 0x31 | 7:0 | 0 | data | Data. The contents |
| | | | | are written to the |
| | | | | I²C bus on a write |
| | | | | operation. The |
| | | | | contents are updated |
| | | | | with read data on the |
| | | | | conclusion of a |
| | | | | successful I²C |
| | | | | read operation. |
| 0x32 | 6 | 0 | dma_err | I²C error |
| | | | | during DMA access. |
| | | | | A ‘1’ on this bit |
| | | | | indicates an error was |
| | | | | detected during an |
| | | | | I²C boot or |
| | | | | LUT access. |
| | 5 | 0 | dma_req | I²C DMA access |
| | | | | request. A ‘1’ on this |
| | | | | bit requests a DMA |
| | | | | access to start. The |
| | | | | bit is automatically |
| | | | | cleared at the |
| | | | | conclusion of the |
| | | | | access. |
| | 4:0 | 1B | dma_siz | I²C DMA access size. |
| | | | | Enter ‘0’ for 1 |
| | | | | byte, ‘1’ for 2 |
| | | | | bytes, etc. |
| 0x33 | 4:0 | 0 | dma_addr | I²C DMA access |
| | | | [4:0] | starting address. |
| 0x34 | 7:5 | 7 | tlow | Lower 3 bits of |
| | | | [2:0] | clock low time. Enter |
| | | | | ‘0’ for 1 cycle, |
| | | | | ‘1’ for 2 cycles, |
| | | | | etc. Reset value is |
| | | | | correct for 3.3 V, |
| | | | | 66 kHz I²C |
| | | | | operation. |
| | 4:0 | 10 | tset | Data set up time. |
| | | | | Enter ‘0’ for |
| | | | | 1 cycle, ‘1’ for |
| | | | | 2 cycles, etc. Reset |
| | | | | value is correct |
| | | | | for 3.3 V, 66 kHz |
| | | | | I²C operation. |
| 0x35 | 7:6 | 3 | thigh | Lower 2 bits of |
| | | | [1:0] | clock high time. Enter |
| | | | | ‘0’ for 1 cycle, |
| | | | | ‘1’ for 2 cycles, etc. |
| | | | | Reset value is correct |
| | | | | for 3.3 V, 66 kHz |
| | | | | I²C operation. |
| | 5:0 | 27 | tlow | Upper 6 bits of |
| | | | [8:3] | clock low time |
| | | | | for device 0. |
| 0x36 | 7 | 1 | tread | Lower bit of read |
| | | | [0] | time. Enter ‘0’ |
| | | | | for 1 cycle, ‘1’ |
| | | | | for 2 cycles, etc. |
| | | | | Reset value is correct |
| | | | | for 3.3 V, 66 kHz |
| | | | | I²C operation |
| | 6:0 | 43 | thigh | Upper 7 bits of clock |
| | | | [8:2] | high time for device 0. |
| 0x37 | 0 | 9F | tread | Upper 8 bits of |
| | | | [8:1] | read time for |
| | | | | device 0. |
| 0x38 | 0 | 1 | filter | Enables one-clock |
| | | | | buffering of incoming |
| | | | | I²C signals |
| | | | | to filter out noise. |
| 0x3C | 7:4 | 7 | device_address | Device address |
| | | | | for the OAC. |
| | 3:1 | 0 | word_addr | Upper 3 bits of word |
| | | | [10:8] | address of the next |
| | | | | byte access. In |
| | | | | conjunction with the |
| | | | | lower 8 bits |
| | | | | (0x3D:7-0), auto- |
| | | | | matically increments |
| | | | | after each access. |
| | | | | Read only. |
| | 0 | 0 | rwN | I²C r/wN Bit. |
| | | | | Writing to it has no |
| | | | | effect. Always |
| | | | | returns ‘1’ |
| | | | | on a read. |
| 0x3D | 7:0 | 0 | word_addr | Lower 8 bits of |
| | | | [7:0] | word address of |
| | | | | the next byte |
| | | | | access. In con- |
| | | | | junction with |
| | | | | the upper 3 bits |
| | | | | (0x3C:3-1), |
| | | | | automatically |
| | | | | increments after |
| | | | | each access. |
| | | | | Read only. |
| 0x3E | 7:0 | E9 | tbta[7:0] | Lower 8 bits of |
| | | | | bus turn around |
| | | | | time. Enter ‘0’ |
| | | | | for 1 cycle, ‘1’ |
| | | | | for 2 cycles, etc. |
| | | | | Reset value is correct |
| | | | | for 3.3 V, 66 kHz |
| | | | | I²C operation. |
| 0x3F | 0 | 0 | tbta[8] | Upper bit of bus |
| | | | | turn around time. |

### Additional Functions

### Pin Out

The following table lists the pin out for the OAC pins used for additional functions. There are a total of 6 pins. The led pin is also listed in this table.

TABLE 117
Additional Function Pins

| Name | Direction | Type | Description |
|---|---|---|---|
| ito_test | Output | Analog | Diagnostic output for |
| | | | ITO-related DAC's. |
| led | Bi- | Digital | Normally, LED timing |
| | directional | | indicator from Backplane IC. |
| | | | Becomes the charge pump |
| | | | clock diagnostic output |
| | | | when the cp_clk_test bit |
| | | | (0x7:0) = 1. |
| led_test | Output | Analog | Diagnostic output for |
| | | | LED-related DAC's. |
| porstN | Output | Digital | Power-on reset output. |
| rref | Input | Analog | Generates the reference current. |
| | | | Nominally set to 100 KΩ |
| tsense | Bi- | Analog | External temperature sensor |
| | directional | | input and temperature |
| | | | diagnostic output. |

Temperature Sensor

Owing to the properties of the liquid crystal itself, a number of the programmable parameters have a strong dependence on temperature. For this reason, a temperature sensor is included. It is accessible to the host system as a read-only configuration register. The parameters that are temperature-sensitive are listed in the following table.

TABLE 118

| vito_dc_bias | red_ito | green_ito | blue_ito |
|---|---|---|---|
| ired | igreen | iblue | |
| vred | vgreen | vblue | |

With the exception of vito_dc_bias, the other parameters have been introduced above.
Note that reset_ito is not a relevant function of temperature.

TABLE 119

| | Bit Number | | | | | | | |
|---|---|---|---|---|---|---|---|---|
| Address | 7 | 6 | 5 | 4 | 3 | 2 | 1 | 0 |

| 0×14 | vito_dc_bias | |
|---|---|---|
| 0×15 | red_ito | |
| 0×16 | green_ito | |
| 0×17 | blue_ito | |
| 0×18 | igreen[1:0] | Ired[5:0] |

| | | |
|---|---|---|
| 0×19 | iblue[3:0] | igreen[5:2] |

| | | | |
|---|---|---|---|
| 0×1a | vgrn[0] | Vred[5:0] | iblue[5:4] |

| | | |
|---|---|---|
| 0×1b | vblue[4:1] | vgreen[4:1] |

| | |
|---|---|
| 0×1c | Vblue |
| | [0] |

### LUT Entry Mapping

### Power-On Reset

On power-up, or on the detection of a voltage spike during normal operation, on-board circuitry implements a prolonged reset, lasting approximately 100,000 cycles. This starts from the rising edge of the voltage on the system power bus. In normal operation, without any power glitch, the negative activation of the reset pin rstN generates an internal reset that is released on the deactivation of rstN.

A power-on reset signal porstN is output from the OAC for use by the system, especially the Backplane IC.

### Diagnostics

TABLE 120
Diagnostic Configuration

| Addr | Bits | Init | Name | Description |
|---|---|---|---|---|
| 0×07 | 0 | 0 | cp_clk_test | Charge pump clock test enable. When |
| | | | | ‘1’, routes internal charge |
| | | | | pump clock |
| | | | | out through the led pin. For |
| | | | | diagnostics only: cp_clk_test should |
| | | | | normally be left low, in which case |
| | | | | led performs as an input from the |
| | | | | Backplane IC. |
| 0×08 | | | | Backplane IC status register. |
| | | | | Status of |
| | | | | incoming control bits from the |
| | | | | Backplane IC. Read only. |
| | 4 | — | ito | Input ito pin value. |
| | 3 | — | led | Input led pin value. |
| | 2 | — | red | Input red pin value. |
| | 1 | — | green | Input green pin value. |
| | 0 | — | blue | Input blue pin value. |
| 0×09 | | | | DAC Test register. For diagnostics |
| | | | | only. |
| | 4 | 0 | vled_test | LED Voltage. When enabled, output |
| | | | | at pin led_test. |
| | 3 | 0 | iled_test | LED Current. When enabled, output |
| | | | | at pin led_test. |
| | 2 | 0 | vito_test | ITO Voltage. |
| | | | | When enabled, output at |
| | | | | pin led_test. |
| | 1 | 0 | gain_test | Internal resistor balance adjustment |
| | | | | for vito. When enabled, output at pin |
| | | | | ito_test. |
| | 0 | 1 | bias_test | DC Bias voltage adjustment for vito. |
| | | | | When enabled, output at pin ito_test. |
| 0×0c | 7 | 0 | temp_test | Temperature test enable via pin |
| | | | | tsense. For diagnostics only: |
| | | | | temp_test should normally be left |
| | | | | low. |
| | 6 | 0 | ets | External temperature sensor enable |
| | | | | via pin tsense. |
| 0×0f | 5:0 | — | temp_samp | Temperature sample. Most recent |
| | | | | temperature reading. Read only. |

TABLE 121
Temperature Sensor Diagnostics

| ets | temp_test | Description |
|---|---|---|
| 0 | 0 | Normal mode: internal sensor. |
| 0 | 1 | Diagnostics only: internal sensor voltage output to |
| | | pin tsense. |
| 1 | 0 | External sensor enabled via input pin tsense. |
| 1 | 1 | Diagnostics only: internal temperature DAC |
| | | voltage output to pin tsense. |

### Electrical Characteristics

General Specifications

TABLE 122

| Parameter | Symbol | Conditions | Min | Typ | Max | Units |
|---|---|---|---|---|---|---|
| Absolute Maximum | | | | | 5.5 | V |
| Supply Voltage | | | | | | |
| Supply Voltage | Vd33 | | 3.0 | 3.3 | 3.6 | V |
| Range (from host | | | | | | |
| system) | | | | | | |
| Operating Voltage | V33 | | 3.0 | 3.3 | 3.6 | V |
| Power dissipation | | Internal | | | 10 | mW |
| Supply Current (Idle) | | only | | | 10 | μA |
| Operating | | | −10 | 25 | 60 | ° C. |
| Temperature | | | | | | |
| Storage Temperature | | | −20 | 25 | −80 | ° C. |
| Latch Up | | | 200 | | | mA |
| ESD | | See note 1 | 150 | | | V |
| | | | 0 | | | |

Note:
Measured using the human body model per MIL-STD-883.

### DC Characteristics

TABLE 123

| | | Condi- | | | | |
|---|---|---|---|---|---|---|
| Parameter | Symbol | tion | Min | Typ | Max | Units |
| Input Low | V_{IL} | | 0 | | 0.3 × V_{DD} | V |
| Level | | | | | | |
| Input High | V_{IH} | | 0.7 × V_{DD} | | | V |
| Level | | | | | | |
| Output Low | V_{OL} | | | | 0.4 × V_{DD} | V |
| Level | | | | | | |
| Output High | V_{OH} | | 0.8 × V_{DD} | | | V |
| Level | | | | | | |
| POR Threshold | | | 0.6 | | 1.0 | V |
| POR | | | | TBD | | V |
| Hysteresys | | | | | | |
| POR Pulse | | | | 1.5 | | msec |
| Width | | | | | | |

### Bandgap Voltage Reference

TABLE 124

| Parameter | Symbol | Condition | Min | Typ | Max | Units |
|---|---|---|---|---|---|---|
| Reference | Vref | Cref = 0.1 | | | | V |
| Voltage | | □F | | | | |
| Before trim | | @25° C. | 1.13 | 1.215 | 1.300 | |
| After trim | | | 0 | 1.215 | 1.225 | |
| | | | 1.20 | | | |
| | | | 5 | | | |
| Output | | | | 1 | | KΩ |
| Impedance | | | | | | |
| PSRR | | @1 KHz | 70 | | | dB |
| Rref (current | | | −1% | 100 | +1% | KΩ |
| generator) | | | | | | |
| Output Voltage | | From −10° C. | −100 | | 100 | ppm/ |
| Temperature | | to 60° C. | | | | ° C. |
| Coefficient | | | | | | |

Note:
All current sources are referenced to reference current generated by the band-gap voltage generator, and the external precision resistor (Rref).

### Master Clock Frequency

TABLE 125

| Parameter | Symbol | Conditions | Min | Type | Max | Units |
|---|---|---|---|---|---|---|
| Master Clock | MCLK | | 1 | | 66 | MHz |
| Frequency | | | | | | |
| Master Clock | | | −0.01 | | 0.01 | % |
| Frequency tolerance | | | | | | |
| Master Clock Duty | | | −10 | 50 | 10 | % |
| Cycle | | | | | | |
| Master Clock Phase | | | | | 5 | % |
| Jitter | | | | | | |
| Charge Pump Clock | | | | 25 | | KHz |
| (Driven from Master | | | | | | |
| Clock internally) | | | | | | |
| LED Booster Clock | | | | 100 | | KHz |
| Frequency (Driven | | | | | | |
| from Master Clock | | | | | | |
| internally) | | | | | | |

ITO voltage

TABLE 126

| Parameter | Symbol | Conditions | Min | Type | Max | Units |
|---|---|---|---|---|---|---|
| Positive ITO Voltage | Vitop | @25° C., | 3.6 | | 9.0 | V |
| | | Vdd = 3.3V | | | | |
| Negative ITO Voltage | Viton | | −5.7 | | −0.3 | V |
| ITO voltage program | | Positive ITO | 3.6 | | 9.0 | V |
| range | | | | | | |
| # of programming bits | | | | 8 | | bits |
| Vito tolerance | | | −30 | | +30 | mV |
| Vito ripple | Vitor | ITO load = | | | 5 | mV |
| | | 10 μA | | | | |
| Vito positive and | | (Vitop − | | 1 | 5 | mV |
| negative voltage | | V_{d3.3}) vs. | | | | |
| mismatch | | \|Viton\| | | | | |
| Vito positive and | Vitoos | (Vitop − | −300 | | 300 | mV |
| negative DC voltage | | V_{d3.3}/2) + | | | | |
| offset range | | Viton | | | | |
| | | (Vito DC | | | | |
| | | offset | | | | |
| | | enabled) | | | | |
| # of prograniming bits | Vitoos | | | 8 | | bits |
| for offset voltage | | | | | | |
| generation | | | | | | |
| # of programming bits | Vitoos | Adjust | | 8 | | bits |
| for V_{CENTER} (V_{d33}/2) | | V_{center} | | | | |
| trim (done in factory) | | using the | | | | |
| | | same register | | | | |
| | | as Vitoos | | | | |
| | | (between | | | | |
| | | V_{d33} and | | | | |
| | | gnd) to | | | | |
| | | create 0V | | | | |
| | | Vitoos | | | | |
| # of programming bits | Vrmatch | | | 8 | | bits |
| for | | | | | | |
| resistor mismatch | | | | | | |
| cancellation (factory | | | | | | |
| trim) | | | | | | |
| Vito Temperature | | | | | 200 | ppm/ |
| coefficient | | | | | | ° C. |

### LEDs

RED LED

TABLE 127
Absolute Maximum Rating

| Parameter | Symbol | Conditions | Min | Typ | Max | Units |
|---|---|---|---|---|---|---|
| Continuous Forward | If_r | | | | 50 | mA |
| Current | | | | | | |
| Peak Forward Current | Ifp_r | Pulse | | | 200 | mA |
| | | width ≦ | | | | |
| | | 10 mS, | | | | |
| | | Duty | | | | |
| | | cycle = | | | | |
| | | 10% | | | | |
| Power dissipation | | | | | 120 | mW |
| Operating | | | −10 | 25 | 80 | ° C. |
| Temperature | | | | | | |
| Storage Temperature | | | −30 | | 85 | ° C. |
| Reverse Breakdown | V_{RR}_{_{—}}ᵣ | @I_{R} = | | | 5 | V |
| Voltage | | 100 μA | | | | |

TABLE 128
Electrical Parameters

| Parameter | Symbol | Conditions | Min | Typ | Max | Units |
|---|---|---|---|---|---|---|
| Red LED Forward | V_{FR} | @I_{F} = 31 mA | | 2.47 | | V |
| Voltage | | @I_{F} = 20 mA(25 | | 1.9 | 2.4 | |
| | | ° C.), | | | 2.7 | |
| | | (−10° C.) | | | | |
| Capacitance | C_{LR} | @V_{F} = 0, | | 45 | | pF |
| | | f = 1 MHz | | | | |
| Forward voltage | | From 0.5 mA | 1.6 | | 3.0 | |
| range over operating | | to 120 mA | | | | |
| current | | (from −10 to | | | | |
| | | 70° C.) | | | | |
| Full scale Output | Vfs_r | | | 6 | | V |
| voltage (Anode | | | | | | |
| voltage DAC) | | | | | | |
| Zero-Scale Output | Vzs_r | | 0 | | | V |
| voltage (Anode | | | | | | |
| voltage DAC) | | | | | | |
| Differential | | | −½ | | ½ | LSB |
| Nonlinearity (Anode | | | | | | |
| voltage DAC) | | | | | | |
| Maximum | | | | 5 | | Bits |
| Resolution for | | | | | | |
| voltage control | | | | | | |
| (Anode voltage | | | | | | |
| DAC) | | | | | | |
| Monotonicity (Anode | | | | 5 | | Bits |
| voltage DAC) | | | | | | |
| Full scale Output | Ifs_r | | | 120 | | mA |
| Current (LED | | | | | | |
| Current DAC) | | | | | | |
| Zero-Scale Output | Izs_r | | 0 | | | mA |
| current (LED Current | | | | | | |
| DAC) | | | | | | |
| Differential | | | −½ | | ½ | LSB |
| Nonlinearity (LED | | | | | | |
| Current DAC) | | | | | | |
| Maximum | | | | 6 | | Bits |
| Resolution for | | | | | | |
| current control (LED | | | | | | |
| Current DAC) | | | | | | |
| Monotonicity (LED | | | | 6 | | Bits |
| Current DAC) | | | | | | |

BLUE LED

TABLE 129
Absolute Maximum Rating

| Parameter | Symbol | Conditions | Min | Typ | Max | Units |
|---|---|---|---|---|---|---|
| Continuous | If_b | | | | 30 | mA |
| Forward | | | | | | |
| Current | | | | | | |
| Peak Forward | Ifp_b | Pulse width ≦ | | | 100 | mA |
| Current | | 10 mS, Duty | | | | |
| | | cycle = 10% | | | | |
| Power | | | | | 120 | mW |
| dissapation | | | | | | |
| Operating | | | −20 | 25 | 80 | ° C. |
| Temperature | | | | | | |
| Storage | | | −30 | | 85 | ° C. |
| Temperature | | | | | | |
| Reverse | V_{RR}_{_{—}}_{b} | @I_{R} = 100 μA | | | 5 | V |
| Breakdown | | | | | | |
| Voltage | | | | | | |

TABLE 130
Electrical Parameters

| Parameter | Symbol | Conditions | Min | Typ | Max | Units |
|---|---|---|---|---|---|---|
| Blue LED | V_{FB} | @ I_{F}=62 mA(m | | 3.50 | | V |
| Forward | | | | | | |
| Voltage | | easured) | | | | |
| | | @ I_{F}=20 mA(Sp | | 3.6 | 4.0 | |
| | | ec'ed @ 25° C.), | | | | |
| | | (−10° C.) | | | 4.2 | |
| Capacitance | C_{LR} | @V_{F}=0, | | 45 | | pF |
| | | f=1 MHz | | | | |
| Forward | | From 0.5 mA | 2.8 | | 5.0 | |
| voltage | | | | | | |
| range over | | to 100 mA | | | | |
| operating | | | | | | |
| current | | (from −10 to | | | | |
| | | 70 ° C.) | | | | |
| Full scale | Vfs_b | | | 6 | | V |
| Output | | | | | | |
| voltage | | | | | | |
| (Anode | | | | | | |
| voltage | | | | | | |
| DAC) | | | | | | |
| Zero-Scale | Vzs_b | | 0 | | | V |
| Output | | | | | | |
| voltage | | | | | | |
| (Anode | | | | | | |
| voltage | | | | | | |
| DAC) | | | | | | |
| Differential | | | −½ | | ½ | LSB |
| Nonlinearity | | | | | | |
| (Anode | | | | | | |
| voltage | | | | | | |
| DAC) | | | | | | |
| Maximum | | | | 5 | | Bits |
| Resolution | | | | | | |
| for voltage | | | | | | |
| control | | | | | | |
| (Anode | | | | | | |
| voltage | | | | | | |
| DAC) | | | | | | |
| Monotonic- | | | | | | |
| ity | | | 5 | | Bits | |
| Anode | | | | | | |
| voltage | | | | | | |
| DAC) | | | | | | |
| Full scale | Ifs_b | | | 120 | | mA |
| Output | | | | | | |
| Current | | | | | | |
| (LED | | | | | | |
| Current | | | | | | |
| DAC) | | | | | | |
| Zero-Scale | Izs_b | | 0 | | | mA |
| Output | | | | | | |
| current (LED | | | | | | |
| Current | | | | | | |
| DAC) | | | | | | |
| Differential | | | −½ | | ½ | LSB |
| Nonlinearity | | | | | | |
| (LED | | | | | | |
| Current | | | | | | |
| DAC) | | | | | | |
| Maximum | | | | 6 | | Bits |
| Resolution | | | | | | |
| for current | | | | | | |
| control (LED | | | | | | |
| Current | | | | | | |
| DAC) | | | | | | |
| Monotonic- | | | | 6 | | Bits |
| ity (LED | | | | | | |
| Current | | | | | | |
| DAC) | | | | | | |

GREEN LED

TABLE 131
Absolute Maximum Rating

| Parameter | Symbol | Conditions | Min | Typ | Max | Units |
|---|---|---|---|---|---|---|
| Continuous | If_g | | | | 30 | mA |
| Forward | | | | | | |
| Current | | | | | | |
| Peak Forward | Ifp_g | Pulse width ≦ | | | 100 | mA |
| Current | | | | | | |
| | | 10 mS, Duty | | | | |
| | | cycle=10% | | | | |
| Power dissipation | | | | 120 | | mW |
| Operating | | | −20 | 25 | 80 | ° C. |
| Temperature | | | | | | |
| Storage | −30 | | 85 | ° C. | | |
| Temperature | | | | | | |
| Reverse | V_{RR}_{_{—}}_{g} | @ I_{R}=100 μA | 5 | V | | |
| Breakdown | | | | | | |
| Voltage | | | | | | |

TABLE 132
Electrical Parameters

| Parameter | Symbol | Conditions | Min | Type | Max | Units |
|---|---|---|---|---|---|---|
| Green LED | Vfgm | @ If = | | 3.74 | | V |
| forward | | 34 mA(meas | | 3.5 | 4.0 | |
| Voltage | | ured) | | | | |
| | | @ I_{F}=20 mA | | | 4.2 | |
| | | (From data | | | | |
| | | sheet | | | | |
| | | @ 25° C.), | | | | |
| | | (−10° C.) | | | | |
| Capacitance | C_{LR} | @ V_{F}=0, | | 45 | | pF |
| | | f=1 MHz | | | | |
| Forward | | From 0.5 mA | 2.7 | | 5.0 | |
| voltage | | to 120 mA | | | | |
| range over | | (from −10 to | | | | |
| operating | | 70° C.) | | | | |
| current | | | | | | |
| Full scale | Vfs_g | | | 6 | | V |
| Output voltage | | | | | | |
| (Anode voltage | | | | | | |
| DAC) | | | | | | |
| Zero-Scale | Vzs_g | | 0 | | | V |
| Output voltage | | | | | | |
| (Anode voltage | | | | | | |
| DAC) | | | | | | |
| Differential | | | −½ | | ½ | LSB |
| Nonlinearity | | | | | | |
| (Anode voltage | | | | | | |
| DAC) | | | | | | |
| Maximum | | | | 5 | | Bits |
| Resolution | | | | | | |
| voltage control | | | | | | |
| (Anode voltage | | | | | | |
| DAC) | | | | | | |
| Monotonicity | | | | 5 | | Bits |
| (Anode voltage | | | | | | |
| DAC) | | | | | | |
| Full scale | Ifs_g | | | 120 | | mA |
| Output Current | | | | | | |
| (LED Current | | | | | | |
| DAC) | | | | | | |
| Zero-Scale | Izs_g | | 0 | | | mA |
| Output current | | | | | | |
| (LED Current | | | | | | |
| DAC) | | | | | | |
| Differential | | | −½ | | ½ | LSB |
| Nonlinearity | | | | | | |
| (LED Current | | | | | | |
| DAC) | | | | | | |
| Maximum | | | | 6 | | Bits |
| Resolution for | | | | | | |
| current control | | | | | | |
| (LED Current | | | | | | |
| DAC) | | | | | | |
| Monotonicity | | | | 6 | | Bits |
| (LED Current | | | | | | |
| DAC) | | | | | | |

Temperature Sensor

TABLE 133
LED

| Parameter | Symbol | Conditions | Min | Typ | Max | Units |
|---|---|---|---|---|---|---|
| Analog output | V_{TS} | −10° C.≦Tₒₚ≦60° C. | | 2 | | mV/° C. |
| sensitivity | | | | | | |
| Analog Output | V_{TOUT} | T_{A}=25° C. | | 600 | | mV |
| voltage | | | | | | |
| A/D Sampling | fₜₑₘₚ | | −0.1% | 1 | +0.1% | KHz |
| Frequency | | | | | | |
| Resolution | | | | 6 | | Bits |
| Offset | | @ 25° C. | −70 | | 70 | mV |
| Offset Trim Range | | | −140 mV | | 140 | mV |
| Offset Trim | | | | 2 | | mV |
| Resolution | | | | | | |
| A/D Nonlinearity | | | −1/2 | | ½ | LSB |
| Monotonicity | | | | 6 | | Bits |

### Mechanical Package Information

The OAC is preferably assembled in a very low profile, surface mount plastic, 64-pin TQFP package. It can also be bumped with solder or gold, and then flip-chipped on a flexible Mylar or Kepton film. Soldering, welding, or gluing with conductive epoxy (for bumped dies) makes the connections. No bonding wires are used.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A microdisplay system, comprising:
(a) headwear adapted for wearing on a head of a user;
(b) a display coupled to the headwear; and
(c) at least one corrective lens coupled to the headwear and positioned between the display panel and the head of the user.

2. The system as recited in claim 1, wherein the at least one corrective lens carries a refractive correction of the user.

3. The system as recited in claim 1, wherein a surrounding visual environment is visible to the user, wherein the at least one corrective lens provides simultaneous refractive correction for the display and the surrounding visual environment.

4. The system as recited in claim 1, wherein the display is imaged at a distance from the eyes for enabling use of a refractive correction power of the user for a distance greater than the actual distance between the user and the display.

5. The system as recited in claim 1, wherein the at least one corrective lens provides different refractive corrections for viewing the display and for viewing the surrounding visual environment.

6. The system as recited in claim 1, wherein the at least one corrective lens is detachably coupled to the headwear.

7. The system as recited in claim 1, wherein two corrective lenses are provided, wherein the corrective lenses are separated such that the lenses substantially match the individual separation of the eyes of the user.

8. The system as recited in claim 1, wherein the at least one corrective lens corrects at least one of myopia, hyperopia, astigmatism, presbyopia, accommodative disfunction, and oculomotor imbalances.

9. The system as recited in claim 1, wherein two corrective lenses are provided, wherein the corrective lenses provide disparity-driven depth perception.

10. The system as recited in claim 1, wherein the at least one corrective lens has at least one prescribed optical property selected from the group consisting of:
spherical refractive power, cylindrical refractive power, near addition power, and prism refractive power.

11. The system as recited in claim 1, wherein the display has a vertical extent of less than 40 mm.

12. A corrective lens device for coupling to a microdisplay adapted for wearing near eyes of a user, comprising:
(a) a pair of corrective lenses being spaced laterally, the corrective lenses each having an optical corrective prescription of the user; and
(b) a mounting portion operably coupled to the lenses for attaching the lenses to the microdisplay.

13. The corrective lens device as recited in claim 12, wherein a surrounding visual environment is visible to the user, wherein the corrective lenses provide simultaneous refractive correction for the display and the surrounding visual environment.

14. The corrective lens device as recited in claim 12, wherein the corrective lenses provide different refractive corrections for viewing the display and for viewing the surrounding visual environment.

15. The corrective lens device as recited in claim 12, wherein the lateral spacing of the corrective lenses matches the individual separation of the eyes of the user.

16. The corrective lens device as recited in claim 1, wherein the corrective lenses correct at least one of myopia, hyperopia, astigmatism, presbyopia, accommodative disfunction, and oculomotor imbalances.

17. The corrective lens device as recited in claim 1, wherein the corrective lenses provide disparity-driven depth perception.

18. The corrective lens device as recited in claim 1, wherein the corrective lenses each have at least one prescribed optical property selected from the group consisting of: spherical refractive power, cylindrical refractive power, near addition power, and prism refractive power.
